(19) United States
(12) Patent Application Publication
(10) Pub. No.: US 2026/0260974 A1
(43) Pub. Date: Sep. 3, 2026

(54) PACKAGING FILM FOR POWER STORAGE DEVICES, AND POWER STORAGE DEVICE

(71) Applicant: DAI NIPPON PRINTING CO., LTD., Tokyo (JP)

(72) Inventors: Makoto AMANO, Tokyo (JP); Masahiro TATSUZAWA, Tokyo (JP); Hirotoshi SAKAMOTO, Tokyo (JP); Atsushi SAITOU, Tokyo (JP); Takanori YAMASHITA, Tokyo (JP)

(73) Assignee: DAI NIPPON PRINTING CO., LTD., Tokyo (JP)

(21) Appl. No.: 18/716,003

(22) PCT Filed: Dec. 7, 2022
(86) PCT No.: PCT/JP2022/045168

§ 371 Date: Jun. 3, 2024

(30) Foreign Application Priority Data
Dec. 7, 2021 (JP) 2021-198728
Dec. 27, 2021 (JP) 2021-213322
Dec. 27, 2021 (JP) 2021-213405
Dec. 27, 2021 (JP) 2021-213423
Dec. 27, 2021 (JP) 2021-213427
Dec. 27, 2021 (JP) 2021-213495

(51) Int. Cl. H01M 50/126; B32B 7/12; B32B 15/08; H01M 50/119; H01M 50/121

(52) U.S. Cl. CPC H01M 50/126; B32B 7/12; B32B 15/08; H01M 50/119; H01M 50/121; B32B 2307/31; B32B 2307/724; B32B 2457/10

(57) ABSTRACT

A packaging film for power storage devices, the packaging film including at least a thermally fusible resin layer, wherein the CO₂ permeation amount in an environment at the temperature of 30° C. is 100 cc·100 μm/m²/24 hr/atm or more.

### TECHNICAL FIELD

The present disclosure relates to a packaging film for electrical storage devices and an electrical storage device.

### BACKGROUND ART

Various types of electrical storage devices have been developed heretofore, and in every electrical storage device, an exterior material is an essential member for sealing electrical storage device elements such as an electrode and an electrolyte. Metallic exterior materials have been often used heretofore as packaging films for electrical storage devices.

On the other hand, in recent years, electrical storage devices have been required to be diversified in shape and to be thinned and lightened with improvement of performance of electric cars, hybrid electric cars, personal computers, cameras, mobile phones and so on. However, metallic packaging films for electrical storage devices that have often been heretofore used have the disadvantage that it is difficult to keep up with diversification in shape, and there is a limit on weight reduction.

Thus, in recent years, a film-shaped laminate with a base material layer, a metal layer, and a heat-sealable resin layer laminated in this order has been proposed as a packaging film for electrical storage devices which is easily processed into diversified shapes and is capable of achieving thickness reduction and weight reduction (see, for example, PTL 1).

In such a packaging film for electrical storage devices, generally, a concave portion is formed by cold molding, electrical storage device elements such as an electrode and an electrolytic solution are disposed in a space formed by the concave portion, and heat-sealable resin layers are heat-sealed to obtain an electrical storage device with electrical storage device elements housed in the packaging film for electrical storage devices.

### CITATION LIST

### Patent Literature

PTL 1: Japanese Patent Laid-open Publication No. 2008-287971

### SUMMARY OF INVENTION

### Technical Problem

(First aspect) In a manufacturing process of an electrical storage device, in general, an electrical storage device element is housed in a packaging film for electrical storage devices, and then temporarily sealed, and an initial charge-discharge step, an aging step and the like are carried out. In these steps, gas such as CO₂ is known to be generated from the electrical storage device element. In the present circumstances, for providing a space for holding gas inside a temporarily sealed packaging (formed from a packaging film for electrical storage devices) and releasing gas to the outside by removing the space together with the gas held therein, a packaging film for electrical storage devices, whose size is larger than that needed for an electrical storage device obtained as an end product (for example, equal to or larger than twice a size needed for sealing the electrical storage device element), is used for manufacturing the electrical storage device.

The inventors of the present disclosure have taken up the challenge of providing new value by imparting CO₂ permeability to a packaging film for electrical storage devices.

A main object of a first aspect of the present disclosure is to provide a packaging film for electrical storage devices which has predetermined CO₂ permeability.

### (Second Aspect)

A metal terminal protrudes from a heat-sealed portion of a packaging film for electrical storage devices, and an electrical storage device element sealed by the packaging film for electrical storage devices is electrically connected to the outside by the metal terminal electrically connected to an electrode of the electrical storage device element. That is, of the portion where the packaging film for electrical storage devices is heat-sealed, a portion where the metal terminal is present is heat-sealed to the metal terminal is sandwiched between heat-sealable resin layers. Since the metal terminal and the heat-sealable resin layer are formed of different materials, adhesion is likely to decrease at an interface between the metal terminal and the heat-sealable resin layer.

In addition, since a metal layer is not provided in the packaging film for electrical storage devices, there is an advantage that the packaging film can be thinner and lighter.

The inventors of the present disclosure have taken up the challenge of imparting new value to a packaging film for electrical storage devices by combining the advantage of being bondable to metal and the advantage that a metal layer is not provided.

A main object of a second aspect of the present disclosure is to provide a packaging film for electrical storage devices which is bondable to metal and does not include a metal layer formed of metal.

### Third Embodiment

In a manufacturing process of an electrical storage device, in general, an electrical storage device element is housed in a packaging film for electrical storage devices, and then temporarily sealed by sealing a peripheral edge of the packaging film for electrical storage devices. Thereafter, an initial charge/discharge step, an aging step and the like are carried out. The packaging film for electrical storage devices in the secondary battery has a shielding property because it includes a metal layer. For this reason, when the electrical storage device element is sealed by the packaging film for electrical storage devices, it is not possible to confirm whether the peripheral edge of the packaging film for electrical storage devices is appropriately sealed or not. Therefore, the electrical storage device cannot be suitably manufactured.

An object of a third aspect of the present disclosure is to provide a method for manufacturing an electrical storage device, which is capable of suitably manufacturing an electrical storage device, and an electrical storage device manufactured by the manufacturing method.

### (Fourth Aspect)

In a manufacturing process of an electrical storage device, in general, an electrical storage device element is housed in a packaging film for electrical storage devices, and then temporarily sealed by sealing a peripheral edge of the packaging film for electrical storage devices. Thereafter, an initial charge/discharge step, an aging step and the like are carried out. In these steps, gas such as CO₂ is known to be generated from the electrical storage device element. In the present circumstances, for providing a space for holding gas inside a temporarily sealed packaging (formed from a packaging film for electrical storage devices) and releasing gas to the outside by removing the space together with the gas held therein, a packaging film for electrical storage devices, whose size is larger than that needed for an electrical storage device obtained as an end product (for example, equal to or larger than twice a size needed for sealing the electrical storage device element), is used for manufacturing the electrical storage device. Therefore, the manufacturing process of the electrical storage device is complicated.

An object of a fourth aspect of the present disclosure is to provide a method for manufacturing an electrical storage device, which is capable of easily manufacturing an electrical storage device, and an electrical storage device manufactured by the manufacturing method.

### (Fifth Aspect)

It is preferable that an electrical storage device has a high value-added function in addition to functions that an electrical storage devices typically has.

An object of a fifth exemplary embodiment of the present disclosure is to provide an electrical storage device having a high value-added function.

### Solution to Problem

### (First Aspect)

The first aspect of the present disclosure provides an invention of an aspect described below.

A packaging film for electrical storage devices, including at least a heat-sealable resin layer, in which
a CO₂ transmission rate in an environment at a temperature of 30° C. is 100 cc·100 μm/m²/24 hr/atm or more.

### (Second Aspect)

The second aspect of the present disclosure provides an invention of an aspect described below.

A packaging film for electrical storage devices, including at least a heat-sealable resin layer, in which
the packaging film for electrical storage devices is bondable to metal, and
the packaging film for electrical storage devices does not include a metal layer formed of metal.

### Third Embodiment

The method for manufacturing an electrical storage device according to a first mode of the third aspect of the present disclosure is a method for manufacturing an electrical storage device, the electrical storage device including an electrical storage device element, and an inner packaging housing the electrical storage device element, the inner packaging including a transparent packaging film for electrical storage devices, the method including an inner side packaging step of wrapping the electrical storage device element with the packaging film for electrical storage devices, and an inner side sealing step of sealing the packaging film for electrical storage devices so as to seal the electrical storage device element with packaging film for electrical storage devices after the inner side packaging step.

The method for manufacturing an electrical storage device according to a second mode of the third aspect of the present disclosure is the method for manufacturing the electrical storage device according to the first mode, in which the packaging film for electrical storage devices further has gas permeability, the method further including a degassing step of releasing gas generated from the electrical storage device element through the packaging film for electrical storage devices after the inner side sealing step.

The method for manufacturing an electrical storage device according to a third mode of the third aspect of the present disclosure is the method for manufacturing the electrical storage device according to the second mode, in which in the inner side packaging step, the electrical storage device element is wrapped with the packaging film for electrical storage devices which is substantially identical in size to the inner packaging of a finished product of the electrical storage device.

The electrical storage device according to a fourth mode of the third aspect of the present disclosure includes an electrical storage device element, an inner packaging housing the electrical storage device element, and an outer packaging housing the inner packaging in which the electrical storage device element is housed, the inner packaging including a transparent packaging film for electrical storage devices.

The electrical storage device according to a fifth mode of the third aspect of the present disclosure is the electrical storage device according to the fourth mode, further including a metal terminal electrically connected to the electrical storage device element, and a tab film disposed between the inner packaging and the metal terminal, in which the outer packaging is joined to the inner packaging, the inner packaging and the metal terminal are joined to each other with the tab film interposed therebetween, and at least a part of an outer edge of the inner packaging is exposed from the outer packaging.

The electrical storage device according to a sixth mode of the third aspect of the present disclosure is the electrical storage device according to the fourth mode, further including a metal terminal electrically connected to the electrical storage device element, and tab films disposed between the inner packaging and outer packaging and the metal terminal, in which the inner packaging and the outer packaging are joined to the metal terminal with the tab film interposed therebetween, and a whole of the inner packaging is covered with the outer packaging.

The electrical storage device according to a seventh mode of the third aspect of the present disclosure is the electrical storage device according to the fourth mode, further including a metal terminal electrically connected to the electrical storage device element, in which the inner packaging and the metal terminal are joined to each other, and at least a part of an outer edge of the inner packaging is exposed from the outer packaging.

The electrical storage device according to an eighth mode of the third aspect of the present disclosure is the electrical storage device according to the fourth mode, further including a metal terminal electrically connected to the electrical storage device element, in which the inner packaging and the outer packaging are joined to the metal terminal, and a whole of the inner packaging is covered with the outer packaging.

The electrical storage device according to a ninth mode of the third aspect of the present disclosure is the electrical storage device according to any one of the third to eighth modes, in which the packaging film for electrical storage devices further has gas permeability.

### (Fourth Aspect)

The method for manufacturing an electrical storage device according to a first mode of the fourth aspect of the present disclosure is a method for manufacturing an electrical storage device, the electrical storage device including an electrical storage device element, and an inner packaging housing the electrical storage device element, the inner packaging including a gas-permeable packaging film for electrical storage devices, the method including an inner side packaging step of wrapping the electrical storage device element with the packaging film for electrical storage devices, an inner side sealing step of sealing the packaging film for electrical storage devices so as to seal the electrical storage device element with packaging film for electrical storage devices after the inner side packaging step, and a degassing step of releasing gas generated from the electrical storage device element through the packaging film for electrical storage devices after the inner side sealing step.

The method for manufacturing an electrical storage device according to a second mode of the fourth aspect of the present disclosure is the method for manufacturing the electrical storage device according to the first mode, in which in the inner side packaging step, the electrical storage device element is wrapped with the packaging film for electrical storage devices which is substantially identical in size to the inner packaging of a finished product of the electrical storage device.

The electrical storage device according to a third mode of the fourth aspect of the present disclosure includes an electrical storage device element, an inner packaging housing the electrical storage device element, and an outer packaging housing the inner packaging in which the electrical storage device element is housed, the inner packaging including a gas-permeable packaging film for electrical storage devices.

The electrical storage device according to a fourth mode of the fourth aspect of the present disclosure is the electrical storage device according to the third mode, further including a metal terminal electrically connected to the electrical storage device element, and a tab film disposed between the inner packaging and the metal terminal, in which the outer packaging is joined to the inner packaging, the inner packaging and the metal terminal are joined to each other with the tab film interposed therebetween, and at least a part of an outer edge of the inner packaging is exposed from the outer packaging.

The electrical storage device according to a fifth mode of the fourth aspect of the present disclosure is the electrical storage device according to the third mode, further including a metal terminal electrically connected to the electrical storage device element, and tab films disposed between the inner packaging and outer packaging and the metal terminal, in which the inner packaging and the outer packaging are joined to the metal terminal with the tab film interposed therebetween, and a whole of the inner packaging is covered with the outer packaging.

The electrical storage device according to a sixth mode of the fourth aspect of the present disclosure is the electrical storage device according to the third mode, further including a metal terminal electrically connected to the electrical storage device element, in which the inner packaging and the metal terminal are joined to each other, and at least a part of an outer edge of the inner packaging is exposed from the outer packaging.

The electrical storage device according to a seventh mode of the fourth aspect of the present disclosure is the electrical storage device according to any one of the third to sixth modes, in which the packaging film for electrical storage devices further has transparency.

### (Fifth Aspect)

The electrical storage device according to a first mode of the fifth aspect of the present disclosure includes an electrical storage device element, an inner packaging housing the electrical storage device element, an outer packaging housing the inner packaging in which the electrical storage device element is housed, and a functional body disposed between the inner packaging and the outer packaging, the functional body having shock absorbency.

The electrical storage device according to a second mode of the fifth aspect of the present disclosure includes an electrical storage device element, an inner packaging housing the electrical storage device element, an outer packaging housing the inner packaging in which the electrical storage device element is housed, and a functional body disposed between the inner packaging and the outer packaging, the functional body having flame retardancy.

The electrical storage device according to a third mode of the fifth aspect of the present disclosure includes an electrical storage device element, an inner packaging housing the electrical storage device element, an outer packaging housing the inner packaging in which the electrical storage device element is housed, and a functional body disposed between the inner packaging and the outer packaging, the functional body having a cooling property.

The electrical storage device according to a fourth mode of the fifth aspect of the present disclosure includes an electrical storage device element, an inner packaging housing the electrical storage device element, an outer packaging housing the inner packaging in which the electrical storage device element is housed, and a functional body disposed between the inner packaging and the outer packaging, the functional body having a fire-extinguishing property.

The electrical storage device according to a fifth mode of the fifth aspect of the present disclosure includes an electrical storage device element, an inner packaging housing the electrical storage device element, an outer packaging housing the inner packaging in which the electrical storage device element is housed, in which at least one of the inner packaging and the outer packaging has at least one of impact absorbency, flame retardancy, a cooling property and a fire-extinguishing property.

The electrical storage device according to a sixth mode of the fifth aspect of the present disclosure is the electrical storage device according to any one of the first to fifth modes, the inner packaging having at least one of transparency and gas permeability.

The electrical storage device according to a seventh mode of the fifth aspect of the present disclosure is the electrical storage device according to any one of the first to sixth modes, further including a metal terminal electrically connected to the electrical storage device element, and a tab film disposed between the inner packaging and the metal terminal, in which the outer packaging is joined to the inner packaging, the inner packaging and the metal terminal are joined to each other with the tab film interposed therebetween, and at least a part of an outer edge of the inner packaging is exposed from the outer packaging.

The electrical storage device according to an eighth mode of the fifth aspect of the present disclosure is the electrical storage device according to any one of the first to sixth modes, further including a metal terminal electrically connected to the electrical storage device element, and tab films disposed between the inner packaging and outer packaging and the metal terminal, in which the inner packaging and the outer packaging are joined to the metal terminal with the tab film interposed therebetween, and a whole of the inner packaging is covered with the outer packaging.

The electrical storage device according to a ninth mode of the fifth aspect of the present disclosure is the electrical storage device according to any one of the first to sixth modes, further including a metal terminal electrically connected to the electrical storage device element, in which the inner packaging and the metal terminal are joined to each other, and at least a part of an outer edge of the inner packaging is exposed from the outer packaging.

The electrical storage device according to a tenth mode of the fifth aspect of the present disclosure is the electrical storage device according to any one of the first to sixth modes, further including a metal terminal electrically connected to the electrical storage device element, in which the inner packaging and the outer packaging are joined to the metal terminal, and a whole of the inner packaging is covered with the outer packaging.

### Advantageous Effects of Invention

According to the first aspect of the present disclosure, it is possible to provide a packaging film for electrical storage devices which has predetermined CO₂ permeability. In addition, the packaging film for electrical storage devices according to the first aspect of the present disclosure can be suitably used as a packaging film for directly packaging an electrical storage device element. For example, in an electrical storage device with an electrical storage device element housed in a double-structured packaging including an inner packaging and an outer packaging, the packaging film for electrical storage devices according to the first aspect of the present disclosure can be suitably used for formation of the inner packaging. For example, when the packaging film for electrical storage devices according to the first aspect of the present disclosure is provided as an inner packaging, and housed in an outer packaging after the electrical storage device element is sealed in the inner packaging and an initial charge-discharge step and an aging step are carried out, gas (in particular, CO₂) generated from the electrical storage device element can be suitably released to the outside during these steps. Therefore, it is not necessary that as in the case of use of a conventional exterior material for electrical storage devices which includes a barrier layer, a space for holding gas be provided inside a temporarily sealed packaging film for electrical storage devices, and a packaging film for electrical storage devices, whose size is larger than that needed for an electrical storage device obtained as an end product (for example, equal to or larger than twice a size needed for sealing the electrical storage device element) be used for releasing the gas by removing the space together with the gas held therein.

Further, according to the first aspect of the present disclosure, it is also possible to provide an electrical storage device in which the packaging film for electrical storage devices is used.

According to the second aspect of the present disclosure, it is possible to provide a packaging film for electrical storage devices which is bondable to metal and does not include a metal layer formed of metal. The packaging film for electrical storage devices according to the second aspect of the present disclosure is bondable to metal, and thus can be bonded to, for example, a metal terminal. Specifically, the electrical storage device element can be sealed with the metal terminal sandwiched between heat-sealable resin layers. In addition, the packaging film for electrical storage devices can be light and thin because it does not include a metal layer formed of metal. For example, according to the second aspect of the present disclosure, the packaging housing the electrical storage device has a double structure with an inner packaging and an outer packaging, where the packaging film for electrical storage devices of the present disclosure can be suitably used as the inner packaging. Further, according to the present disclosure, it is also possible to provide an electrical storage device in which the packaging film for electrical storage devices is used.

The method for manufacturing an electrical storage device and the electrical storage device according to the third aspect of the present disclosure enable an electrical storage device to be suitably manufactured.

The method for manufacturing an electrical storage device and the electrical storage device according to the fourth aspect of the present disclosure enable an electrical storage device to be easily manufactured.

The electrical storage device according to the fifth aspect of the present disclosure has high value-added function.

### BRIEF DESCRIPTION OF DRAWINGS

FIG. 1 is a schematic diagram showing an example of a cross-sectional structure of a packaging film for electrical storage devices according to the present disclosure.

FIG. 2 is a schematic diagram showing an example of a cross-sectional structure of a packaging film for electrical storage devices according to the present disclosure.

FIG. 3 is a schematic diagram showing an example of a cross-sectional structure of a packaging film for electrical storage devices according to the present disclosure.

FIG. 4 is a schematic diagram showing an example of a cross-sectional structure of a packaging film for electrical storage devices according to the present disclosure.

FIG. 5 is a schematic diagram for illustrating a method for housing an electrical storage device element in a packaging including packaging film for electrical storage devices according to the present disclosure.

FIG. 6 is a schematic diagram showing an example of a cross-sectional structure of an electrical storage device of the present disclosure.

FIG. 7 is a schematic diagram showing an example of a cross-sectional structure of an electrical storage device of the present disclosure.

FIG. 8 is a plan view of the electrical storage device according to embodiments A1, B1 and C1 of first and second aspects, and third, fourth and fifth aspects.

FIG. 9 is a sectional view taken along line D2-D2 in FIG. 8 for embodiments A1 and B1 of first and second aspects, and third and fourth aspects.

FIG. 10 is a flowchart showing an example of a method for manufacturing an electrical storage device for embodiments A1 and B1 of first and second aspects, and third and fourth aspects in FIG. 8.

FIG. 11 is a diagram for an inner side packaging step in FIG. 10, which is also applied to Embodiment C1 of first and second aspects, and third, fourth and fifth aspects.

FIG. 12 is a diagram for a first inner side sealing step in FIG. 10, which is also applied to Embodiment C1 of first and second aspects, and third, fourth and fifth aspects.

FIG. 13 is a diagram for a second inner side sealing step in FIG. 10, which is also applied to Embodiment C1 of first and second aspects, and third, fourth and fifth aspects.

FIG. 14 is a flowchart showing an example of a method for manufacturing an electrical storage device for embodiments A2 and B2 of first and second aspects, and third and fourth aspects.

FIG. 15 is a diagram for an inner side packaging step in FIG. 14, which is also applied to Embodiment C2 of first and second aspects, and third, fourth and fifth aspects.

FIG. 16 is a diagram for a first inner side sealing step in FIG. 14, which is also applied to Embodiment C2 of first and second aspects, and third, fourth and fifth aspects.

FIG. 17 is a diagram for a second inner side sealing step in FIG. 14, which is also applied to Embodiment C2 of first and second aspects, and third, fourth and fifth aspects.

FIG. 18 is a diagram for an inner side sealing step in FIG. 14, which is also applied to Embodiment C2 of first and second aspects, and third, fourth and fifth aspects.

FIG. 19 is a sectional view of a terminal sealed portion of the electrical storage device according to embodiments A2 and B2 of first and second aspects, and third and fourth aspects.

FIG. 20 is a sectional view of a terminal sealed portion of the electrical storage device according to embodiments A3 and B3 of first and second aspects, and third and fourth aspects.

FIG. 21 is a sectional view of a terminal sealed portion of the electrical storage device according to embodiments A3 and B3 of first and second aspects, and third and fourth aspects.

FIG. 22 is a sectional view taken along line D2-D2 in FIG. 8 for Embodiment C1 of first and second aspects, and the fifth aspect.

FIG. 23 is a flowchart showing an example of a method for manufacturing an electrical storage device for Embodiment C1 of first and second aspects, and the fifth aspect in FIG. 8.

FIG. 24 is a flowchart showing an example of a method for manufacturing an electrical storage device for Embodiment C2 of first and second aspects, and the fifth aspect.

FIG. 25 is a sectional view of a terminal sealed portion of the electrical storage device according to Embodiment C2 of first and second aspects, and the fifth aspect.

FIG. 26 is a sectional view of a terminal sealed portion of the electrical storage device according to Embodiment C3 of first and second aspects, and the fifth aspect.

FIG. 27 is a sectional view of a terminal sealed portion of the electrical storage device according to Embodiment C3 of first and second aspects, and the fifth aspect.

### DESCRIPTION OF EMBODIMENTS

A packaging film for electrical storage devices according to the first aspect of the present disclosure is a packaging film for electrical storage devices including at least a heat-sealable resin layer, in which a CO₂ transmission rate in an environment at a temperature of 30° C. is 100 cc·100 μm/m²/24 hr/atm or more.

A packaging film for electrical storage devices according to the second aspect of the present disclosure is a packaging film for electrical storage devices including at least a heat-sealable resin layer, in which the packaging film for electrical storage devices is bondable to metal, and does not include a metal layer formed of metal.

Hereinafter, the packaging film for electrical storage devices according to the present disclosure will be described in detail. In the present disclosure, a numerical range indicated by the term “A to B” means “A or more” and “B or less”. For example, the expression of “2 to 15 mm” means 2 mm or more and 15 mm or less. In numerical ranges serially described in the present disclosure, an upper limit value or a lower limit value described for a numerical range may be replaced by an upper limit value or a lower limit value of one of other serially described numerical ranges. Upper limit values, upper and lower limit values, or lower limit values, which are described for different ranges, may be combined to form a numerical range. In numerical ranges described in the present disclosure, an upper limit value or a lower limit value described for a numerical range may be replaced by a value shown in an example.

In the present disclosure, the term “shielding layer” means a layer that blocks light transmission, and when the packaging film for electrical storage devices according to the present disclosure has the shielding layer, contents (for example, an electrical storage device element) of the electrical storage device are made hardly visible by the shielding layer. The term “metal layer” means a layer formed of metal, and examples thereof include a metal foil and a metal sheet. The thickness of the metal foil is, for example, about 10 to 200 μm, and the thickness of the metal sheet is, for example, about 200 μm to several millimeters.

In the description of the present disclosure, for matters specific to first to fifth aspects of the present disclosure, aspects for which the matters are described are specified, and for matters common to the aspects, relevant aspects are not particularly specified, and a comprehensive description is given as matters related to the present disclosure. First, contents common to the entirety of the present disclosure, and contents concerning the first and second aspects of the present disclosure are described. Subsequently, contents concerning the third to fifth aspects are described.

### 1. Laminated Structure and Physical Properties of Packaging Film for Electrical Storage Devices

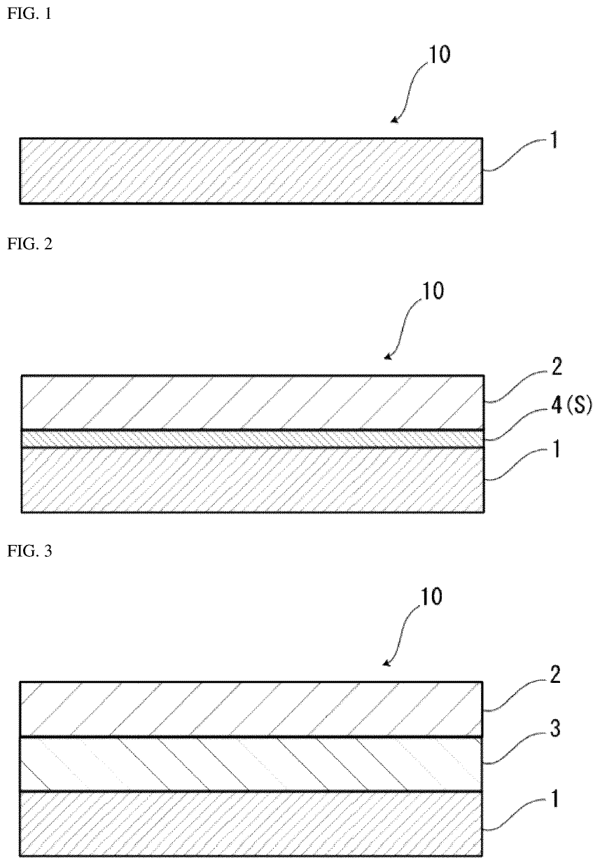

As shown in, for example, FIGS. 1 to 4, a packaging film 10 for electrical storage devices according to the present disclosure includes at least a heat-sealable resin layer 1. In construction of an electrical storage device using the packaging film 10 for electrical storage devices and an electrical storage device element, the electrical storage device element is put in a space formed by heat-sealing the peripheral portions of heat-sealable resin layers 1 of the packaging film 10 for electrical storage devices which face each other.

The packaging film 10 for electrical storage devices may include only the heat-sealable resin layer 1 as shown in FIG. 1. When the packaging film 10 for electrical storage devices includes only the heat-sealable resin layer 1, it is preferable that at least one surface of the heat-sealable resin layer 1 is bondable to metal.

In addition, it is preferable that the packaging film 10 for electrical storage devices according to the present disclosure includes a laminate including at least a resin layer 2 and the heat-sealable resin layer 1 as shown in FIGS. 2 to 4. In such a packaging film 10 for electrical storage devices, the resin layer 2 is on the outer side, and the heat-sealable resin layer 1 is on the inner side (innermost layer). When the packaging film 10 for electrical storage devices includes a laminate including the resin layer 2 and the heat-sealable resin layer 1, it is preferable that bondability to metal is imparted to at least one of an outer surface of the resin layer 2 and an inner surface of the heat-sealable resin layer 1.

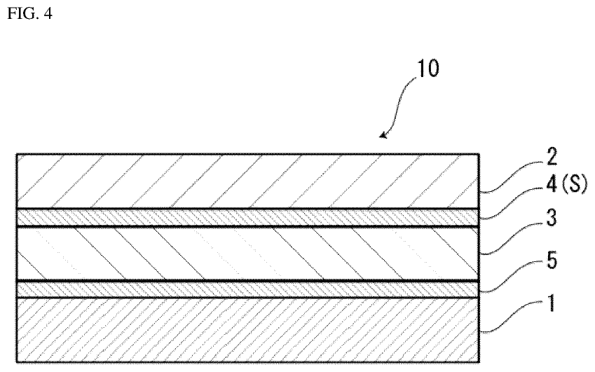

Further, it is preferable that the packaging film 10 for electrical storage devices according to the present disclosure includes a laminate including at least the resin layer 2, a base material 3 and the heat-sealable resin layer 1 as shown in FIGS. 3 and 4. In such a packaging film 10 for electrical storage devices, the resin layer 2 is on the outer side, the heat-sealable resin layer 1 is on the inner side (innermost layer), and the base material 3 is located between the resin layer 2 and the heat-sealable resin layer 1. Even when the packaging film 10 for electrical storage devices includes a laminate including the resin layer 2, the base material 3 and the heat-sealable resin layer 1, it is preferable that bondability to metal is imparted to at least one of an outer surface of the resin layer 2 and an inner surface of the heat-sealable resin layer 1.

As shown in FIGS. 2 and 4, adhesive agent layers 4 and 5 can be provided between the resin layer 2 and the base material 3 or the heat-sealable resin layer 1, and between the heat-sealable resin layer 1 and the base material 3 or the resin layer 2, respectively.

In the packaging film 10 for electrical storage devices according to the first aspect of the present disclosure, a CO₂ transmission rate in an environment at a temperature of 30° C. is 100 cc·100 μm/m²/24 hr/atm or more, preferably about 200 cc·100 μm/m²/24 hr/atm or more, more preferably about 300 cc·100 μm/m²/24 hr/atm or more, still more preferably about 500 cc·100 μm/m²/24 hr/atm or more. The CO₂ transmission rate of the packaging film 10 for electrical storage devices according to the first aspect of the present disclosure is, for example, about 2000 cc·100 μm/m²/24 hr/atm or less, preferably about 1000 cc·100 μm/m²/24 hr/atm or less, more preferably about 800 cc·100 μm/m²/24 hr/atm or less, and preferably in the range of about 100 to 2,000 cc·100 μm/m²/24 hr/atm, about 100 to 1,000 cc·100 μm/m²/24 hr/atm, about 100 to 800 cc·100 μm/m²/24 hr/atm, about 200 to 2,000 cc·100 μm/m²/24 hr/atm, about 200 to 1,000 cc·100 μm/m²/24 hr/atm, about 200 to 800 cc·100 μm/m²/24 hr/atm, about 300 to 2,000 cc·100 μm/m²/24 hr/atm, about 300 to 1,000 cc·100 μm/m²/24 hr/atm, about 300 to 800 cc·100 μm/m²/24 hr/atm, about 500 to 2,000 cc·100 μm/m²/24 hr/atm, about 500 to 1,000 cc·100 μm/m²/24 hr/atm, or 500 to 800 cc·100 μm/m²/24 hr/atm. The CO₂ transmission rate of the packaging film for electrical storage devices is as follows.

### <Measurement of CO₂ Transmission Rate>

CO₂ passing through a φ60 mm part of the packaging film 10 for electrical storage devices is quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate.

When a shielding property is imparted to the packaging film 10 for electrical storage devices according to the present disclosure, it is only required that at least one layer in the packaging film 10 for electrical storage devices be a shielding layer S having a shielding property. For example, FIG. 4 shows a configuration in which an adhesive agent layer 4 bonding the resin layer 2 and the base material 3 is the shielding layer S. In the present disclosure, any layer in the packaging film 10 for electrical storage devices can be the shielding layer S.

A surface coating layer or the like may be further provided on the outside of the resin layer 2 (on a side opposite to the heat-sealable resin layer 1 side) if necessary (not shown).

The thickness of the laminate forming the packaging film 10 for electrical storage devices is not particularly limited, and is, for example, 190 μm or less, preferably about 180 μm or less, or about 170 μm or less, from the viewpoint of cost reduction, energy density improvement, and the like. The thickness of the laminate forming the packaging film 10 for electrical storage devices is preferably about 35 μm or more, about 45 μm or more, or about 60 μm or more, from the viewpoint of maintaining the function of a packaging film for electrical storage devices to protect of an electrical storage device element. The laminate forming the packaging film 10 for electrical storage devices is preferably in the range of, for example, about 35 to 190 μm, about 35 to 180 μm, about 35 to 170 μm, about 45 to 190 μm, about 45 to 180 μm, about 45 to 170 μm, about 60 to 190 μm, about 60 to 180 μm, and about 60 to 170 μm, particularly preferably about 45 to 170 μm.

In the packaging film 10 for electrical storage devices, the ratio of the total thickness of the resin layer 2, the adhesive agent layer 4, the base material 3, the adhesive agent layer 5 and the heat-sealable resin layer 1 to the thickness (total thickness) of the laminate forming the packaging film 10 for electrical storage devices is preferably 90% or more, more preferably 95% or more, still more preferably 98% or more. As a specific example, when the packaging film 10 for electrical storage devices according to the present disclosure includes the resin layer 2, the adhesive agent layer 4, the base material 3, the adhesive agent layer 5 and the heat-sealable resin layer 1, the ratio of the total thickness of these layers to the thickness (total thickness) of the laminate forming the packaging film 10 for electrical storage devices is preferably 90% or more, more preferably 95% or more, still more preferably 98% or more. In addition, when the packaging film 10 for electrical storage devices according to the present disclosure is a laminate including the resin layer 2, the adhesive agent layer 4 and the heat-sealable resin layer 1, the ratio of the total thickness of these layers to the thickness (total thickness) of the laminate forming the packaging film 10 for electrical storage devices may be, for example, 80% or more, preferably 90% or more, more preferably 95% or more, still more preferably 98% or more.

The laminate forming the packaging film 10 for electrical storage devices according to the present disclosure can have a total light transmittance of, for example, 20% or less, 15% or less, 10% or less, 8% or less as measured in accordance with the provisions of JIS K7361-1: 1997. The laminate forming the packaging film 10 for electrical storage devices according to the present disclosure can have a total light transmittance of, for example, 80% or more, 85% or more, or 90% or more as measured in accordance with the provisions of JIS K7361-1: 1997. The shielding property that can be exhibited by the packaging film 10 for electrical storage devices is enhanced as the total light transmittance decreases. On the other hand, the light permeability that can be exhibited by the packaging film 10 for electrical storage devices is enhanced as the total light transmittance increases. The lower limit value of the total light transmittance is 0%, and the upper limit of the total light transmittance is 100%. For the total light transmittance of the packaging film for electrical storage devices, the transmittance in a visible light region (400 to 700 nm) is measured with a commercially available spectrophotometer (for example, Ultraviolet-Visible-Near Infrared Spectrophotometer V-670 manufactured by JASCO Corporation) by a measurement method specified in JIS K7361-1: 1997, and the average value thereof is taken as a total light transmittance. For measurement conditions, a halogen lamp is used as a light source, the UV/Vis bandwidth is 5.0 nm, the scanning rate is 1,000 nm/min, the response is set to Medium, and the data capture interval is 1.0 nm.

The packaging film 10 for electrical storage devices can be colored black. When the packaging film 10 for electrical storage devices is colored black, the packaging film 10 for electrical storage devices has a high shielding property and a high forge-proof effect. In addition, in a manufacturing process of the electrical storage device, it is possible to identify a location by a sensor with higher accuracy, and it is possible to more accurately convey the packaging film 10 for electrical storage devices and seal the electrical storage device element, and the like. Further, the electrical storage device and other electrical components can be all colored black to impart a high-grade feeling as a product.

In the packaging film 10 for electrical storage devices according to the second aspect of the present disclosure, a CO₂ transmission rate in an environment at a temperature of 30° C. is preferably 100 cc·100 μm/m²/24 hr/atm or more, more preferably about 200 cc·100 μm/m²/24 hr/atm or more, still more preferably about 300 cc·100 μm/m²/24 hr/atm or more, even more preferably about 500 cc·100 μm/m²/24 hr/atm or more. The CO₂ transmission rate of the packaging film 10 for electrical storage devices according to the second aspect of the present disclosure is, for example, about 2,000 cc·100 μm/m²/24 hr/atm or less, preferably about 1000 cc·100 μm/m²/24 hr/atm or less, more preferably about 800 cc·100 μm/m²/24 hr/atm or less, and preferably in the range of about 100 to 2,000 cc·100 μm/m²/24 hr/atm, about 100 to 1,000 cc·100 μm/m²/24 hr/atm, about 100 to 800 cc·100 μm/m²/24 hr/atm, about 200 to 2,000 cc·100 μm/m²/24 hr/atm, about 200 to 1,000 cc·100 μm/m²/24 hr/atm, about 200 to 800 cc·100 μm/m²/24 hr/atm, about 300 to 2,000 cc·100 μm/m²/24 hr/atm, about 300 to 1,000 cc·100 μm/m²/24 hr/atm, about 300 to 800 cc·100 μm/m²/24 hr/atm, about 500 to 2,000 cc·100 μm/m²/24 hr/atm, about 500 to 1,000 cc·100 μm/m²/24 hr/atm, or 500 to 800 cc·100 μm/m²/24 hr/atm. The CO₂ transmission rate of the packaging film for electrical storage devices is as follows.

### <Measurement of CO₂ Transmission Rate>

CO₂ passing through a φ60 mm part of the packaging film 10 for electrical storage devices is quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate.

### 2. Layers Forming Packaging Film for Electrical Storage Devices

### [Heat-Sealable Resin Layer 1]

In the packaging film 10 for electrical storage devices according to the present disclosure, the heat-sealable resin layer 1 is a layer (sealant layer) which corresponds to an innermost layer and performs a function of hermetically sealing the electrical storage device element by heat-sealing the heat-sealable resin layer during construction of the electrical storage device.

The packaging film 10 for electrical storage devices according to the first aspect of the present disclosure may be bondable or may be not bondable to metal, but is preferably bondable to metal. For example, when the packaging film 10 for electrical storage devices according to the first aspect includes only the heat-sealable resin layer 1, it is preferable that at least one surface of the heat-sealable resin layer 1 is bondable to metal. When the packaging film 10 for electrical storage devices according to the first aspect includes a laminate including the resin layer 2 and the heat-sealable resin layer 1, it is preferable that bondability to metal is imparted to at least one of an outer surface of the resin layer 2 and an inner surface of the heat-sealable resin layer 1. Even when the packaging film 10 for electrical storage devices according to the first aspect includes a laminate including the resin layer 2, the base material 3 and the heat-sealable resin layer 1, it is only required that bondability to metal be imparted to at least one of an outer surface of the resin layer 2 and an inner surface of the heat-sealable resin layer 1.

When the shielding layer S is provided in the packaging film 10 for electrical storage devices according to the first aspect of the present disclosure, it is preferable that the heat-sealable resin layer 1 of the packaging film 10 for electrical storage devices is transparent, and the heat-sealable resin layer 1 is used by being laminated to the shielding layer S formed of a layer different from the heat-sealable resin layer 1, but the shielding layer S may be formed by blending the above-mentioned colorant or the like in the heat-sealable resin layer 1.

When the packaging film 10 for electrical storage devices according to the second aspect of the present disclosure includes only the heat-sealable resin layer 1, at least one surface of the heat-sealable resin layer 1 is bondable to metal. When the packaging film 10 for electrical storage devices according to the second aspect includes a laminate including the resin layer 2 and the heat-sealable resin layer 1, it is only required that bondability to metal be imparted to at least one of an outer surface of the resin layer 2 and an inner surface of the heat-sealable resin layer 1. Even when the packaging film 10 for electrical storage devices according to the second aspect includes a laminate including the resin layer 2, the base material 3 and the heat-sealable resin layer 1, it is preferable that bondability to metal is imparted to at least one of an outer surface of the resin layer 2 and an inner surface of the heat-sealable resin layer 1.

When the shielding layer S is provided in the packaging film 10 for electrical storage devices according to the second aspect of the present disclosure, it is preferable that the heat-sealable resin layer 1 is transparent, and is used by being laminated to the shielding layer S formed of a layer different from the heat-sealable resin layer 1, but the shielding layer S may be formed by blending the above-mentioned colorant or the like in the heat-sealable resin layer 1.

The resin for forming the heat-sealable resin layer 1 in the first aspect is not particularly limited as long as it enables heat sealing, and the CO₂ transmission rate of the packaging film 10 for electrical storage devices is 100 cc·100 μm/m²/24 hr/atm or more, but a resin containing a polyolefin backbone such as a polyolefin or an acid-modified polyolefin is preferable. The polyolefin is preferable because it not only has heat sealability, but also is very high in the CO₂ transmission rate.

The resin for forming the heat-sealable resin layer 1 in the second aspect is not particularly limited as long as it can be heat-sealed, a resin containing a polyolefin backbone such as a polyolefin or an acid-modified polyolefin is preferable.

The resin forming the heat-sealable resin layer 1 can be confirmed to contain a polyolefin backbone by an analysis method such as infrared spectroscopy or gas chromatography-mass spectrometry. It is preferable that a peak derived from maleic anhydride is detected when the resin forming the heat-sealable resin layer 1 is analyzed by infrared spectroscopy. For example, when a maleic anhydride-modified polyolefin is measured by infrared spectroscopy, peaks derived from maleic anhydride are detected near wavenumbers of 1760 cm⁻¹ and 1780 cm⁻¹. When the heat-sealable resin layer 1 is a layer formed of a maleic anhydride-modified polyolefin, a peak derived from maleic anhydride is detected when measurement is performed by infrared spectroscopy. However, if the degree of acid modification is low, the peaks may be too small to be detected. In that case, the peaks can be analyzed by nuclear magnetic resonance spectroscopy.

Specific examples of the polyolefin include polyethylenes such as low-density polyethylene, medium-density polyethylene, high-density polyethylene and linear low-density polyethylene; ethylene-α-olefin copolymers; polypropylene such as homopolypropylene, block copolymers of polypropylene (e.g., block copolymers of propylene and ethylene) and random copolymers of polypropylene (e.g., random copolymers of propylene and ethylene); propylene-α-olefin copolymers; and terpolymers of ethylene-butene-propylene. Of these, polypropylene is preferable. The polyolefin resin in the case of a copolymer may be a block copolymer or a random copolymer. These polyolefin-based resins may be used alone, or may be used in combination of two or more thereof.

The polyolefin may be a cyclic polyolefin. The cyclic polyolefin is a copolymer of an olefin and a cyclic monomer, and examples of the olefin as a constituent monomer of the cyclic polyolefin include ethylene, propylene, 4-methyl-1-pentene, styrene, butadiene and isoprene. Examples of the cyclic monomer as a constituent monomer of the cyclic polyolefin include cyclic alkenes such as norbornene; cyclic dienes such as cyclopentadiene, dicyclopentadiene, cyclohexadiene and norbornadiene. Among these polyolefins, cyclic alkenes are preferable, and norbornene is more preferable.

The polyolefin may be an acid-modified polyolefin. The acid-modified polyolefin is a polymer with the polyolefin modified by subjecting the polyolefin to block polymerization or graft polymerization with an acid component. As the polyolefin to be acid-modified, the above-mentioned polyolefins, copolymers obtained by copolymerizing polar molecules such as acrylic acid or methacrylic acid with the above-mentioned polyolefins, polymers such as crosslinked polyolefins, or the like can also be used. Examples of the acid component to be used for acid modification include carboxylic acids such as maleic acid, acrylic acid, itaconic acid, crotonic acid, maleic anhydride and itaconic anhydride, and anhydrides thereof.

The acid-modified polyolefin may be an acid-modified cyclic polyolefin. The acid-modified cyclic polyolefin is a polymer obtained by copolymerizing a part of monomers forming the cyclic polyolefin in place of an acid component, or block-polymerizing or graft-polymerizing an acid component with the cyclic polyolefin. The cyclic polyolefin to be modified with an acid is the same as described above. The acid component to be used for acid modification is the same as the acid component used for modification of the polyolefin.

Examples of preferred acid-modified polyolefins include polyolefins modified with a carboxylic acid or an anhydride thereof, polypropylene modified with a carboxylic acid or an anhydride thereof, maleic anhydride-modified polyolefins, and maleic anhydride-modified polypropylene.

The heat-sealable resin layer 1 may be formed from one resin alone, or may be formed from a blend polymer obtained by combining two or more resins. Further, the heat-sealable resin layer 1 may be composed of only one layer, or may be composed of two or more layers with the same resin component or different resin components.

When at least a part of the inner surface of the packaging film 10 for electrical storage devices is bonded to metal (for example, a metal terminal) or the like, the inner surface of the heat-sealable resin layer 1 is bondable to metal. For imparting metal bondability to the inner surface of the heat-sealable resin layer 1, for example, the inner surface of the heat-sealable resin layer 1 is preferably formed of an acid-modified polyolefin (acid-modified polypropylene, acid-modified polyethylene or the like). The above-described polyolefin which is not acid-modified is not bondable to metal, and therefore is not suitable as a resin for forming the inner surface of the heat-sealable resin layer 1 when metal bondability is imparted to the inner surface of the heat-sealable resin layer 1.

The heat-sealable resin layer 1 may contain a slipping agent etc. if necessary. When the heat-sealable resin layer 1 contains a slipping agent, the moldability of the packaging film for electrical storage devices can be improved. The slipping agent is not particularly limited, and a known slipping agent can be used. The slipping agents may be used alone, or may be used in combination of two or more thereof.

The slipping agent is not particularly limited, and is preferably an amide-based slipping agent. Specific examples of the slipping agent include those exemplified for the resin layer 2. The slipping agents may be used alone, or may be used in combination of two or more thereof. By combining two or more slipping agents, adhesion of the slipping agent to a die can be suppressed due to, for example, interaction between the slipping agents to suitably improve the ease of continuous production of the electrical storage device when the packaging film 10 for electrical storage devices is cold-molded with the die. The same applies to a case where a slipping agent is used for the resin layer 2 as described later.

When a slipping agent is present on the surface of the heat-sealable resin layer 1, the amount of the slipping agent present is not particularly limited, and is preferably about 10 to 50 mg/m², more preferably about 15 to 40 mg/m² from the viewpoint of improving the moldability of the packaging film for electrical storage devices.

The slipping agent present on the surface of the heat-sealable resin layer 1 may be one obtained by exuding the slipping agent contained in the resin forming the heat-sealable resin layer 1, or one obtained by applying a slipping agent to the surface of the heat-sealable resin layer 1.

The thickness of the heat-sealable resin layer 1 is not particularly limited as long as the heat-sealable resin layers are heat-sealed to each other to perform a function of sealing the electrical storage device element, and the thickness is, for example, about 150 μm or less, preferably about 85 μm or less, more preferably about 15 to 85 μm, still more preferably about 35 to 85 μm.

### [Resin Layer 2]

In the present disclosure, the resin layer 2 is a layer provided for the purpose of, for example, exhibiting a function as a base material of the packaging film for electrical storage devices. When the packaging film 10 for electrical storage devices includes the resin layer 2, the resin layer 2 is located on the outer side of the packaging film for electrical storage devices.

The material for forming the resin layer 2 in the first aspect is not particularly limited as long as it has at least insulation quality, and the CO₂ transmission rate of the packaging film 10 for electrical storage devices is 100 cc·100 μm/m²/24 hr/atm or more. The resin layer 2 in the first aspect can be formed using, for example, a resin, and the resin may contain additives described later. When the shielding layer S is provided in the packaging film 10 for electrical storage devices according to the first aspect of the present disclosure, it is preferable that the resin layer 2 is transparent, and is used by being laminated to the shielding layer S formed of a layer different from the resin layer 2, but the shielding layer S may be formed by blending a colorant described later or the like in the resin layer 2.

The material for forming the resin layer 2 in the second aspect is not particularly limited as long as it has at least insulation quality. The resin layer 2 in the second aspect can be formed using, for example, a resin, and the resin may contain additives described later. It is preferable that the resin layer 2 in the second aspect is transparent, and is used by being laminated to the shielding layer S formed of a layer different from the resin layer 2, but the shielding layer S may be formed by blending a colorant described later or the like in the resin layer 2.

In the present disclosure, the resin layer 2 may be, for example, a resin film formed of a resin, or may be formed by applying a resin. The resin film may be an unstretched film or a stretched film. Examples of the stretched film include uniaxially stretched films and biaxially stretched films, and biaxially stretched films are preferable. Examples of the stretching method for forming a biaxially stretched film include a sequential biaxial stretching method, an inflation method, and a simultaneous biaxial stretching method. Examples of the method for applying a resin include a roll coating method, a gravure coating method and an extrusion coating method.

In the present disclosure, examples of the resin for forming the resin layer 2 include resins such as polyester, polyamide, polyolefin, epoxy resin, acrylic resin, fluororesin, polyurethane, silicone resin and phenol resin, and modified products of these resins. The resin for forming the resin layer 2 may be a copolymer of these resins or a modified product of the copolymer. A mixture of these resins may be used.

Of these, polyester, polyamide and polyolefin are preferable as the resin for forming the resin layer 2 in the present disclosure.

Specific examples of the polyester include polyethylene terephthalate, polybutylene terephthalate, polyethylene naphthalate, polybutylene naphthalate, polyethylene isophthalate, and copolyesters. Examples of the copolyester include copolyesters having ethylene terephthalate as a main repeating unit. Specific examples thereof include copolymer polyesters that are polymerized with ethylene isophthalate and include ethylene terephthalate as a main repeating unit (hereinafter, abbreviated as follows after polyethylene(terephthalate/isophthalate)), polyethylene(terephthalate/adipate), polyethylene(terephthalate/sodium sulfoisophthalate), polyethylene(terephthalate/sodium isophthalate), polyethylene (terephthalate/phenyl-dicarboxylate) and polyethylene(terephthalate/decane dicarboxylate). These polyesters may be used alone, or may be used in combination of two or more thereof.

Specific examples of the polyamide include polyamides such as aliphatic polyamides such as nylon 6, nylon 66, nylon 610, nylon 12, nylon 46, and copolymers of nylon 6 and nylon 66; hexamethylenediamine-isophthalic acid-terephthalic acid copolymerization polyamides containing a structural unit derived from terephthalic acid and/or isophthalic acid, such as nylon 6I, nylon 6T, nylon 6IT and nylon 6I6T (I denotes isophthalic acid and T denotes terephthalic acid), and polyamides containing aromatics, such as polyamide MXD6 (polymethaxylylene adipamide); alicyclic polyamides such as polyamide PACM6 (polybis(4-aminocyclohexyl)methaneadipamide; polyamides copolymerized with a lactam component or an isocyanate component such as 4,4′-diphenylmethane-diisocyanate, and polyester amide copolymers and polyether ester amide copolymers as copolymers of a copolymerization polyamide and a polyester or a polyalkylene ether glycol; and copolymers thereof. These polyamides may be used alone, or may be used in combination of two or more thereof.

The polyolefin is preferably a resin containing a polyolefin backbone such as a polyolefin or an acid-modified polyolefin. Polyolefin is preferable from the viewpoint of imparting heat sealability to the outer surface of the resin layer 2. Specific examples of the polyolefin are the same as the polyolefins exemplified for the heat-sealable resin layer 1.

In the present disclosure, the resin layer 2 contains preferably at least one of a polyester film, a polyamide film, a polyolefin film and an acid-modified polyolefin film, more preferably at least one of a stretched polyester film, a stretched polyamide film, a stretched polyolefin film and a stretched acid-modified polyolefin film, still more preferably at least one of a stretched polyethylene terephthalate film, a stretched polybutylene terephthalate film, a stretched nylon film, a stretched polypropylene film and a stretched acid-modified polypropylene film, even more preferably at least one of a biaxially stretched polyethylene terephthalate film, a biaxially stretched polybutylene terephthalate film, a biaxially stretched nylon film, a biaxially stretched polypropylene film and a biaxially stretched acid-modified polypropylene film.

In the present disclosure, when at least a part of the outer surface of the packaging film 10 for electrical storage devices is bonded to metal or the like, the resin layer 2 is an outermost layer, and the outer surface of the resin layer 2 is bondable to metal. For imparting metal bondability to the outer surface of the resin layer 2, for example, the outer surface of the resin layer 2 is preferably formed of an acid-modified polyolefin (acid-modified polypropylene, acid-modified polyethylene or the like). As described for the heat-sealable resin layer 4, the above-described polyolefin which is not acid-modified is not bondable to metal, and therefore is not suitable as a resin for forming the outer surface of the resin layer 2 when metal bondability is imparted to the outer surface of the resin layer 2. As described above, when bondability to metal is imparted to the outer surface of the base material layer 1 as described above, the packaging film 10 for electrical storage devices can be used as an inner packaging to suitably bond the outer surface of the packaging film 10 for electrical storage devices to an outer packaging formed of metal (for example, a metal foil, a metal can or the like).

In the present disclosure, the resin layer 2 may be a single layer, or may include two or more layers. When the resin layer 2 includes two or more layers, the resin layer 2 may be a laminate obtained by laminating resin films with an adhesive or an adhesion promoter, or a resin film laminate obtained by co-extruding resins to form two or more layers. The resin film laminate obtained by co-extruding resins to form two or more layers may be used as the resin layer 2 in an unstretched state, or may be uniaxially stretched or biaxially stretched and used as the resin layer 2.

Specific examples of the resin film laminate with two or more layers in the resin layer 2 in the present disclosure include laminates of a polyester film and a nylon film, nylon film laminates with two or more layers, and polyester film laminates with two or more layers. Laminates of a stretched nylon film and a stretched polyester film, stretched nylon film laminates with two or more layers, and stretched polyester film laminates with two or more layers are preferable. For example, when the resin layer 2 is a resin film laminate with two layers, the base material layer 1 is preferably a laminate of a polyester resin film and a polyester resin film, a laminate of a polyamide resin film and a polyamide resin film, or a laminate of a polyester resin film and a polyamide resin film, more preferably a laminate of a polyethylene terephthalate film and a polyethylene terephthalate film, a laminate of a nylon film and a nylon film, or a laminate of a polyethylene terephthalate film and a nylon film. Since the polyester resin is hardly discolored even in the case where for example, an electrolytic solution is deposited on the surface, it is preferable that the polyester resin film is located at the outermost layer of the resin layer 2 when the resin layer 2 is a resin film laminate with two or more layers.

From the viewpoint of imparting heat sealability to the outer surface of the resin layer 2 of the present disclosure, a laminate of polyolefin and polyester, a laminate of polyolefin and polyolefin, and a laminate of polyolefin and polyamide are preferable as specific examples of the laminate of two or more resin films. For example, the laminate of polyolefin and polyester is preferably a laminate of a polypropylene film and a polyethylene terephthalate film, a laminate of a polypropylene film and a polyethylene naphthalate film, a laminate of a polypropylene film and a polybutylene terephthalate film, a laminate of an acid-modified polypropylene film and a polyethylene terephthalate film, a laminate of an acid-modified polypropylene film and a polyethylene naphthalate film, or a laminate of an acid-modified polypropylene film and a polybutylene terephthalate film. For example, the laminate of polyolefins is preferably a laminate of polypropylenes, a laminate of acid-modified polypropylenes, or a laminate of acid-modified polypropylene and polypropylene. The laminate of polyolefin and polyamide is preferably a laminate of polypropylene and nylon, or a laminate of acid-modified polypropylene and nylon.

In the present disclosure, when the resin layer 2 is a resin film laminate with two or more layers, the two or more resin films may be laminated with an adhesive or an adhesion promoter interposed therebetween. Specific examples of the preferred adhesive and adhesion promoter include the same adhesives and adhesion promoters as those exemplified, respectively, for adhesive agent layers 4 and 5 described later. The method for laminating a resin film having two or more layers is not particularly limited, and a known method can be employed. Examples thereof include a dry lamination method, a sand lamination method, an extrusion lamination method and a thermal lamination method, and a dry lamination method is preferable. When the resin film is laminated by a dry lamination method, it is preferable to use a polyurethane adhesive as the adhesive. Here, the thickness of the adhesive is, for example, about 2 to 5 μm. In addition, the lamination may be performed with an anchor coat layer formed on the resin film. Examples of the anchor coat layer include the same adhesives as those exemplified for adhesive agent layers 4 and 5 described later. Here, the thickness of the anchor coat layer is, for example, about 0.01 to 1.0 μm. An anchor coat layer can be used as adhesive agent layers 4 and 5.

In the present disclosure, additives such as a slipping agent, a flame retardant, an antiblocking agent, an antioxidant, a light stabilizer, a tackifier and an antistatic agent may be present on at least one of the surface of the base material layer 1 and/or inside the resin layer 2. The additives may be used alone, or may be used in combination of two or more thereof.

In the present disclosure, it is preferable that a slipping agent is present on the surface of the resin layer 2 from the viewpoint of enhancing the moldability of the packaging film for electrical storage devices. The slipping agent is not particularly limited, and is preferably an amide-based slipping agent. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide. Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N′-dioleyladipic acid amide, and N,N′-dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N′-distearylisophthalic acid amide. The slipping agents may be used alone, or may be used in combination of two or more thereof.

In the present disclosure, when the slipping agent is present on the surface of the resin layer 2, the amount of the slipping agent present is not particularly limited, and is preferably about 3 mg/m² or more, more preferably about 4 to 15 mg/m², still more preferably about 5 to 14 mg/m².

In the present disclosure, the slipping agent present on the surface of the resin layer 2 may be one obtained by exuding the slipping agent contained in the resin forming the resin layer 2, or one obtained by applying a slipping agent to the surface of the resin layer 2.

In the present disclosure, the thickness of the resin layer 2 is not particularly limited, and is, for example, about 3 to 50 μm, preferably about 10 to 35 μm. When the resin layer 2 is a resin film laminate with two or more layers, the thickness of the resin film forming each layer is preferably about 2 to 25 μm.

### [Base Material 3]

In the packaging film 10 for electrical storage devices according to the present disclosure, the base material 3 functions as a support. When the packaging film 10 for electrical storage devices includes the resin layer 2, the base material 3 and the heat-sealable resin layer 1, the resin layer 2 is on the outer side, the heat-sealable resin layer 1 is on the inner side (innermost layer), and the base material 3 is located between the resin layer 2 and the heat-sealable resin layer 1.

In the packaging film 10 for electrical storage devices according to the present disclosure, a colorant or the like can be blended in the base material 3 to obtain the shielding layer S.

The material for forming the base material 3 in the present disclosure is not particularly limited as long as it has an insulation quality. Examples of the material for forming the base material 3 include polyolefin-based resins, polyamide-based resins, polyester-based resins, epoxy resins, acrylic resins, fluororesins, silicone resins, phenol resins, silicon resins, polyurethane resins, polyether imide, polycarbonate, and mixtures and copolymers thereof. Among them, polyolefin-based resins are particularly preferable. That is, the material forming the base material 3 is preferably a resin containing a polyolefin backbone such as a polyolefin or an acid-modified polyolefin. The resin forming the base material 3 can be confirmed to contain a polyolefin backbone by an analysis method such as infrared spectroscopy or gas chromatography mass spectrometry.

Specific examples of the polyester include polyethylene terephthalate, polybutylene terephthalate, polyethylene naphthalate, polybutylene naphthalate, polyethylene isophthalate, copolymerization polyesters with ethylene terephthalate as a main repeating unit, and copolymerization polyesters with a butylene terephthalate as a main repeating unit. Specific examples of the copolymerization polyester including ethylene terephthalate as a main repeating unit include copolymer polyesters that are polymerized with ethylene isophthalate and include ethylene terephthalate as a main repeating unit (hereinafter, abbreviated as follows after polyethylene(terephthalate/isophthalate)), polyethylene(terephthalate/isophthalate), polyethylene(terephthalate/adipate), polyethylene(terephthalate/sodium sulfoisophthalate), polyethylene(terephthalate/sodium isophthalate), polyethylene (terephthalate/phenyl-dicarboxylate) and polyethylene(terephthalate/decane dicarboxylate). Specific examples of the copolymerization polyester with butylene terephthalate as a main repeating unit include copolymer polyesters that are polymerized with butylene isophthalate and include butylene terephthalate as a main repeating unit (hereinafter, abbreviated as follows after polybutylene(terephthalate/isophthalate)), polybutylene(terephthalate/adipate), polybutylene(terephthalate/sebacate), polybutylene(terephthalate/decane dicarboxylate) and polybutylene naphthalate. These polyesters may be used alone, or may be used in combination of two or more thereof.

Specific examples of the polyolefin include polyethylene such as low-density polyethylene, medium-density polyethylene, high-density polyethylene and linear low-density polyethylene; crystalline or noncrystalline polypropylene such as homopolypropylene, block copolymers of polypropylene (e.g., block copolymers of propylene and ethylene) and random copolymers of polypropylene (e.g., random copolymers of propylene and ethylene); terpolymers of ethylene-butene-propylene; and the like. Among these polyolefins, polyethylenes and polypropylene are preferred, with polypropylene being more preferred. In addition, it is preferable that the base material 3 contains homopolypropylene, it is more preferable that the base material 3 is formed of homopolypropylene and it is still more preferable that the base material 3 is an unstretched homopolypropylene film because excellent electrolytic solution resistance is obtained.

Specific examples of the polyamide include aliphatic polyamides such as nylon 6, nylon 66, nylon 610, nylon 12, nylon 46, and copolymers of nylon 6 and nylon 66; hexamethylenediamine-isophthalic acid-terephthalic acid copolymerization polyamides containing a structural unit derived from terephthalic acid and/or isophthalic acid, such as nylon 6I, nylon 6T, nylon 6IT and nylon 6I6T (I denotes isophthalic acid and T denotes terephthalic acid), and polyamides containing aromatics, such as polymethaxylylene adipamide (MXD6); cycloaliphatic polyamides such as polyaminomethyl cyclohexyl adipamide (PACM 6); polyamides copolymerized with a lactam component or an isocyanate component such as 4,4′-diphenylmethane-diisocyanate, and polyester amide copolymers and polyether ester amide copolymers as copolymers of a copolymerization polyamide and a polyester or a polyalkylene ether glycol; and copolymers thereof. These polyamides may be used alone, or may be used in combination of two or more thereof.

In addition, the base material 3 in the present disclosure may be formed of a nonwoven fabric formed of any of the resins described above. When the base material 3 is a nonwoven fabric, it is preferable that the base material 3 is formed of the above-described polyolefin-based resin, polyamide resin or the like.

The base material 3 in the present disclosure may be a single layer, or may have multiple layers.

When the base material 3 in the present disclosure is composed of a resin film, a surface of the base material 3 may be subjected to known easy-adhesive means such as corona discharge treatment, ozone treatment or plasma treatment if necessary.

From the viewpoint of more suitably exhibiting the effect of the present disclosure, the thickness of the base material 3 is preferably 80 μm or less, more preferably 60 μm or less, still more preferably about 50 μm or less, still more preferably about 40 μm or less. In addition, the thickness of the base material 3 is preferably about 5 μm or more, more preferably about 8 μm or more, still more preferably about 10 μm or more. The thickness of the base material 3 is preferably in the range of 5 to 80 μm, about 5 to 60 μm, about 5 to 50 μm, about 5 to 40 μm, about 8 to 80 μm, about 8 to 60 μm, about 8 to 50 μm, about 8 to 40 μm, about 10 to 80 μm, about 10 to 60 μm, about 10 to 50 μm, or about 10 to 40 μm.

### [Adhesive Agent Layers 4 and 5]

In the packaging film 10 for electrical storage devices according to the present disclosure, the adhesive agent layers 4 and 5 are provided, respectively, between the resin layer 2 and the base material 3 or the heat-sealable resin layer 1 and between the heat-sealable resin layer 1 and the base material 3 or the resin layer 2 if necessary for the purpose of improving bondability between the layers. The adhesive agent layer 4 bonds the resin layer 2 and the base material 3 or the heat-sealable resin layer 1. The adhesive agent layer 5 bonds the heat-sealable resin layer 1 and the resin layer 2 or the base material 3. The anchor coat layer can also be used as adhesive agent layers 4 and 5.

In the packaging film 10 for electrical storage devices, a colorant or the like can be blended in the adhesive agent layers 4 and 5 to obtain the shielding layer S. For example, when a colorant is blended in an adhesive for forming the adhesive agent layer 4, so that a shielding layer is formed by single coating, it is not necessary to separately provide a shielding layer at a location other than that of the adhesive agent layer 4. Thus, for example, as compared to a case where a colored layer is separately provided as a shielding layer, the number of steps is reduced to improve production efficiency and reduce the risk of ingress of contaminants. In addition, if a colored layer is provided between the resin layer 2 and the adhesive agent layer 4, interfacial strength between the resin layer 2 and the colored layer and between the colored layer and the adhesive agent layer 4 may decrease. For this reason, it is preferable to blend a colorant in the adhesive agent layer 4 from the viewpoint of long-term use.

The adhesive agent layers 4 and 5 are formed of an adhesive or an adhesion promoter that can be bonded to the resin layer 2 or the heat-sealable resin layer 1. The adhesive used for forming the adhesive agent layers 4 and 5 is not limited, and may be any of a chemical reaction type, a solvent volatilization type, a heat melting type, a heat pressing type, and the like. The adhesive agent may be a two-liquid curable adhesive (two-liquid adhesive), a one-liquid curable adhesive (one-liquid adhesive), or a resin that does not involve curing reaction. The adhesive agent layers 4 and 5 may be a single layer or have multiple layers.

Specific examples of the adhesive component contained in the adhesive include polyester such as polyethylene terephthalate, polybutylene terephthalate, polyethylene naphthalate, polybutylene naphthalate, polyethylene isophthalate and copolyester; polyether; polyurethane; epoxy resins; phenol resins; polyamides such as nylon 6, nylon 66, nylon 12 and copolymerized polyamide; polyolefin-based resins such as polyolefins, cyclic polyolefins, acid-modified polyolefins and acid-modified cyclic polyolefins; cellulose; (meth)acrylic resins; polyimide; polycarbonate; amino resins such as urea resins and melamine resins; rubbers such as chloroprene rubber, nitrile rubber and styrene-butadiene rubber; and silicone resins. These adhesive components may be used alone, or may be used in combination of two or more thereof. Of these adhesive components, polyurethane-based adhesives are preferable. In addition, the adhesive strength of these resins used as adhesive components can be increased by using an appropriate curing agent in combination. As the curing agent, appropriate one is selected from polyisocyanate, a polyfunctional epoxy resin, an oxazoline group-containing polymer, a polyamine resin, an acid anhydride and the like according to the functional group of the adhesive component.

Examples of the polyurethane adhesive include polyurethane adhesives containing a first component containing a polyol compound and a second component containing an isocyanate compound. The polyurethane adhesive is preferably a two-liquid curable polyurethane adhesive having polyol such as polyester polyol, polyether polyol or acrylic polyol as a first component, and aromatic or aliphatic polyisocyanate as a second component. Examples of the polyurethane adhesive include polyurethane adhesives containing an isocyanate compound and a polyurethane compound obtained by reacting a polyol compound with an isocyanate compound in advance. Examples of the polyurethane adhesive include polyurethane adhesives containing a polyol compound and a polyurethane compound obtained by reacting a polyol compound with an isocyanate compound in advance. Examples of the polyurethane adhesive include polyurethane adhesives obtained by reacting a polyol compound with an isocyanate compound to form a polyurethane compound in advance, and reacting the polyurethane compound with moisture in the air or the like. It is preferable that polyester polyol having a hydroxyl group in the side chain in addition to a hydroxyl group at the end of the repeating unit is used as the polyol compound. Examples of the second component include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g., a trimer) as the polyisocyanate compound. Examples of the multimer include adducts, biurets, and nurates. Since the adhesive agent layers 4 and 5 is formed of a polyurethane adhesive, excellent electrolytic solution resistance is imparted to the packaging film for electrical storage devices, so that peeling of the resin layer 2 is suppressed even if the electrolytic solution is deposited on the side surface.

In addition, the adhesion promoter for use in formation of the adhesive agent layers 4 and 5 is not limited. As the adhesion promoter, for example, a well known adhesion promoter can be used such as an isocyanate-based adhesion promoter, a polyethyleneimine-based adhesion promoter, a polyester-based adhesion promoter, a polyurethane-based adhesion promoter or a polybutadiene-based adhesion promoter, and results of experiments have shown that one composed of an isocyanate component selected from a triisocyanate monomer and polymeric MDI is excellent in lamination strength and undergoes little decrease in lamination strength after immersion in an electrolytic solution. In particular, use of an adhesion promoter formed of triphenylmethane-4,4′,4″-triisocyanate which is a triisocyanate monomer or polymethylene polyphenyl polyisocyanate which is polymeric MDI (NCO content: about 30% and viscosity: 200 to 700 mPa·s) has produced the best result. Tris(p-isocyanatephenyl)thiophosphate which is also a triisocyanate monomer, or a two-liquid curable adhesion promoter containing a polyethyleneimine-based resin as a main component and polycarbodiimide as a crosslinking agent has produced a good result. The adhesive agent layers 4 and 5 with an adhesion promoter can be formed by performing coating/drying using a well known coating method such as bar coating method, a roll coating method or a gravure coating method. The amount of coating is 20 to 100 mg/m², preferably 40 to 60 mg/m² in the case of an adhesion promoter composed of triisocyanate, 40 to 150 mg/m², preferably 60 to 100 mg/m² in the case of an adhesion promoter composed of polymeric MDI, and 5 to 50 mg/m², preferably 10 to 30 mg/m² in the case of a two-liquid curable adhesion promoter containing polyethyleneimine as a main component and polycarbodiimide as a crosslinking agent. The triisocyanate monomer is a monomer having three isocyanate groups per molecule, and the polymeric MDI is a mixture of MDI and an MDI oligomer obtained by polymeric MDI, and is represented by the following formula (1).

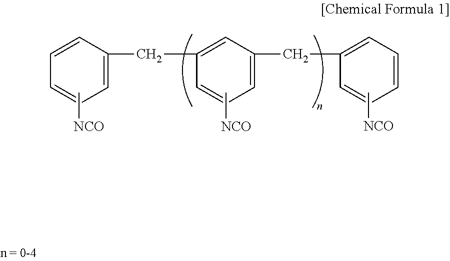

Other components may be added to the adhesive agent layers 4 and 5 as long as bondability is not inhibited, and the adhesive agent layers 4 and 5 may contain a colorant, a thermoplastic elastomer, a tackifier, a filler, and the like. When the adhesive agent layers 4 and 5 contain a colorant, the packaging film for electrical storage devices can be colored. When the adhesive agent layers 4 and 5 are colored to the extent that a shielding property can be imparted to the packaging film for electrical storage devices, the adhesive agent layers 4 and 5 can be used as the shielding layer S. As the colorant, known colorants such as pigments and dyes can be used. The colorants may be used alone, or may be used in combination of two or more thereof.

The type of pigment is not particularly limited as long as the bondability of the adhesive agent layers 4 and 5 is not impaired. Examples of the organic pigment include azo-based pigments, phthalocyanine-based pigments, quinacridone-based pigments, anthraquinone-based pigments, dioxazine-based pigments, indigothioindigo-based pigments, perinone-perylene-based pigments, isoindolenine-based pigments and benzimidazolone-based pigments. Examples of the inorganic pigment include carbon black-based pigments, titanium oxide-based pigments, cadmium-based pigments, lead-based pigments, chromium-based pigments, iron-based pigments and copper-based pigments and also fine powder of mica (mica) and fish scale foil.

Of the colorants, black colorants are preferable for the packaging film for electrical storage devices to have a black-colored appearance, for example. Of the black colorants, carbon black is preferable. When the packaging film 10 for electrical storage devices is colored black using a black colorant, the packaging film 10 for electrical storage devices has a high shielding property and a high forge-proof effect. In addition, in a manufacturing process of the electrical storage device, it is possible to identify a location by a sensor with higher accuracy, and it is possible to more accurately convey the packaging film 10 for electrical storage devices and seal the electrical storage device element, and the like. Further, the electrical storage device and other electrical components can be all colored black to impart a high-grade feeling as a product. Carbon black is a more preferable colorant because of a high shielding property.

The average particle diameter of the pigment is not particularly limited, and is, for example, about 0.05 to 5 μm, preferably about 0.08 to 2 μm. The average particle size of carbon black is within the range of 0.161 to 0.221 μm. The average particle size of the pigment is a median diameter measured by a laser diffraction/scattering particle size distribution measuring apparatus.

The content of the pigment in the adhesive agent layers 4 and 5 is not particularly limited as long as the packaging film for electrical storage devices is colored, and the content of the pigment is, for example, about 5 to 60 mass %, preferably 10 to 40 mass %.

The thickness of each of the adhesive agent layers 4 and 5 is not particularly limited as long as the resin layer 2 and the heat-sealable resin layer 1 can be bonded to each other, and the thickness is, for example, about 1 μm or more, or about 2 μm or more. The thickness of each of the adhesive agent layers 4 and 5 is, for example, about 10 μm or less, or about 5 μm or less. The thickness of each of the adhesive agent layers 4 and 5 is preferably in the range of about 1 to 10 μm, about 1 to 5 μm, about 2 to 10 μm, or about 2 to 5 μm.

### [Colored Layer C]

In the present disclosure, the colored layer C (not shown) is provided between the resin layer 2 and the heat-sealable resin layer 1 or outside the resin layer 2 as necessary. When the adhesive agent layers 4 and 5 are present, the colored layer C may be provided between the resin layer 2 and the adhesive agent layers 4 and 5. By providing the colored layer C, the packaging film for electrical storage devices can be colored. When the colored layer C is colored to the extent that a shielding property can be imparted to the packaging film for electrical storage devices, the colored layer C can be used as the shielding layer S. In the packaging film 10 for electrical storage devices, the colored layer C is preferably the shielding layer S. The colored layer C between the resin layer 2 and the heat-sealable resin layer 1 may be referred to as an inner colored layer, and the colored layer C outside the resin layer 2 may be referred to as an outer colored layer. It is preferable that the colored layer C is provided on at least one surface of the resin layer 2 (that is, the resin layer 2 and the colored layer C are in contact with each other).

In the present disclosure, the colored layer C can be formed by, for example, applying an ink containing a colorant to the surface of the resin layer 2. As the colorant, known colorants such as pigments and dyes can be used. The colorants may be used alone, or may be used in combination of two or more thereof.

In the present disclosure, specific examples of the colorant contained in the colored layer C include the same colorants as those exemplified in the section [Adhesive agent layers 4 and 5].

In the present disclosure, the thickness of the colored layer C is not particularly limited as long as the packaging film 10 for electrical storage devices is colored, and the thickness is, for example, about 1 μm or more, or about 2 μm or more. The thickness of the colored layer C is, for example, about 10 μm or less, or about 5 μm or less. The thickness of the colored layer C is preferably in the range of about 1 to 10 μm, about 1 to 5 μm, about 2 to 10 μm, or about 2 to 5 μm.

### [Surface Coating Layer]

The packaging film for electrical storage devices according to the present disclosure may include a surface coating layer (not shown) on the resin layer 2 (a surface of the resin layer 2 on a side opposite to the heat-sealable resin layer 1) if necessary for the purpose of improving at least one of designability, electrolytic solution resistance, scratch resistance, moldability and the like. The surface coating layer is a layer located on the outermost layer side of the packaging film for electrical storage devices when the electrical storage device is constructed using the packaging film for electrical storage devices. The colorant or the like may be blended in the surface coating layer to form the shielding layer S.

Examples of the resin for forming the surface coating layer include resins such as polyvinylidene chloride, polyester, polyamide, epoxy resin, acrylic resin, fluororesin, polyurethane, silicone resin and phenol resin, and modified products of these resins. The resin may be a copolymer of these resins or a modified product of the copolymer. A mixture of these resins may be used. The resin is preferably a curable resin. That is, it is preferable that the surface coating layer includes a cured product of a resin composition containing a curable resin.

When the resin forming the surface coating layer is a curable resin, the resin may be any of a one-liquid curable type and a two-liquid curable type, and is preferably a two-liquid curable type. Examples of the two-liquid curable resin include two-liquid curable polyurethane, two-liquid curable polyester and two-liquid curable epoxy resins. Of these, two-liquid curable polyurethane is preferable.

Examples of the two-liquid curable polyurethane include polyurethane which contains a first component containing a polyol compound and a second component containing an isocyanate compound. The polyurethane is preferably a two-liquid curable polyurethane adhesive having polyol such as polyester polyol, polyether polyol or acrylic polyol as a first component, and aromatic or aliphatic polyisocyanate as a second component. Examples of the polyurethane include polyurethane containing an isocyanate compound and a polyurethane compound obtained by reacting a polyol compound with an isocyanate compound in advance. Examples of the polyurethane include polyurethane containing a polyurethane compound and a polyurethane compound obtained by reacting a polyol compound with an isocyanate compound in advance. Examples of the polyurethane include polyurethane obtained by reacting a polyol compound with an isocyanate compound to form a polyurethane compound in advance, and reacting the polyurethane compound with moisture in the air or the like. It is preferable that polyester polyol having a hydroxyl group in the side chain in addition to a hydroxyl group at the end of the repeating unit is used as the polyol compound. Examples of the second component include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g., a trimer) as the polyisocyanate compound. Examples of the multimer include adducts, biurets, and nurates. The aliphatic isocyanate-based compound is an isocyanate having an aliphatic group and having no aromatic ring, the alicyclic isocyanate-based compound is an isocyanate having an alicyclic hydrocarbon group, and the aromatic isocyanate-based compound is an isocyanate having an aromatic ring. Since the surface coating layer is formed of polyurethane, excellent electrolytic solution resistance is imparted to the packaging film for electrical storage devices.

If necessary, the surface coating layer may contain additives such as the slipping agent, an anti-blocking agent, a matting agent, a flame retardant, an antioxidant, a tackifier and an anti-static agent on at least one of the surface and the inside of the surface coating layer according to the functionality and the like to be imparted to the surface coating layer and the surface thereof. The additives are in the form of, for example, fine particles having an average particle diameter of about 0.5 nm to 5 μm. The average particle diameter of the additives is a median diameter measured by a laser diffraction/scattering particle size distribution measuring apparatus.

The additives may be either inorganic substances or organic substances. The shape of the additive is not particularly limited, and examples thereof include a spherical shape, a fibrous shape, a plate shape, an amorphous shape and a scaly shape.

Specific examples of the additives include talc, silica, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, acrylate resins, crosslinked acryl, crosslinked styrene, crosslinked polyethylene, benzoguanamine, gold, aluminum, copper and nickel. The additives may be used alone, or may be used in combination of two or more thereof. Of these additives, silica, barium sulfate and titanium oxide are preferable from the viewpoint of dispersion stability, costs, and so on. The surface of the additive may be subjected to various kinds of surface treatments such as insulation treatment and dispersibility enhancing treatment.

The method for forming the surface coating layer is not particularly limited, and examples thereof include a method in which a resin for forming the surface coating layer is applied. When the additive is added to the surface coating layer, a resin mixed with the additive may be applied.

The thickness of the surface coating layer is not particularly limited as long as the above-mentioned function as the surface coating layer is performed, and it is, for example, about 0.5 to 10 μm, preferably about 1 to 5 μm.

### 3. Method for Manufacturing Packaging Film for Electrical Storage Devices

The method for manufacturing a packaging film for electrical storage devices is not particularly limited as long as the packaging film for electrical storage devices according to the present disclosure is obtained. For example, when the packaging film for electrical storage devices according to the first aspect of the present disclosure includes the resin layer 2 and the heat-sealable resin layer 1, the method includes a step of preparing a laminate in which at least a resin layer and a heat-sealable resin layer are laminated in this order from the outside, and the laminate has a CO₂ transmission rate of 100 cc·100 μm/m²/24 hr/atm or more in an environment at a temperature of 30° C. For example, when the packaging film for electrical storage devices according to the second aspect of the present disclosure includes the resin layer 2 and the heat-sealable resin layer 1, the method includes a step of preparing a laminate in which at least a resin layer and a heat-sealable resin layer are laminated in this order from the outside, and the laminate is bondable to metal, and does not include a metal layer formed of metal.

An example of the manufacturing method when the packaging film for electrical storage devices according to the present disclosure includes a laminate including the resin layer 2, the adhesive agent layer 4, the base material 3, the adhesive agent layer 5 and the heat-sealable resin layer 1 in this order is as follows. First, materials for forming the layers are provided. Subsequently, the resin layer 2 and the base material 3 are laminated with the adhesive agent layer 4 interposed therebetween, and the base material 3 and the heat-sealable resin layer 1 are laminated with the adhesive agent layer 5 interposed therebetween. Specifically, using an adhesive for forming the adhesive agent layer 4, the resin layer 2 and the base material 3 are laminated by a dry lamination method or the like to laminate the resin layer 2, the adhesive agent layer 4 and the base material 3, and further, using an adhesive for forming the adhesive agent layer 5, the base material 3 and the heat-sealable resin layer 1 are laminated by a dry lamination method or the like to manufacture the packaging film 10 for electrical storage devices. When the resin layer 2, the base material 3 and the heat-sealable resin layer 1 are laminated without the adhesive agent layers 4 and 5, the packaging film 10 for electrical storage devices can be manufactured by, for example, a method in which a resin for forming the resin layer 2 is melted and extruded to one side of the base material 3, and a resin for forming the heat-sealable resin layer 1 is melted and extruded to the other side of the base material 3. When the colored layer is provided, the colored layer may be formed on the surface of the resin layer 2, and then laminated to the base material 3 and the heat-sealable resin layer 1. When a surface coating layer is provided, for example, the resin composition for forming the surface coating layer is applied to the surface of the resin layer 2, and cured to form the surface coating layer.

The packaging film 10 for electrical storage devices may be further subjected to heat treatment for enhancing the bondability of the adhesive agent layers 4 and 5.

### 4. Use of Packaging Film for Electrical Storage Devices

The packaging film for electrical storage devices according to the present disclosure is used as a packaging for hermetically sealing and storing electrical storage device elements such as a positive electrode, a negative electrode, and an electrolyte. That is, in a packaging formed of the packaging film for electrical storage devices according to the present disclosure, an electrical storage device element including at least a positive electrode, a negative electrode, and an electrolyte can be housed to obtain an electrical storage device.

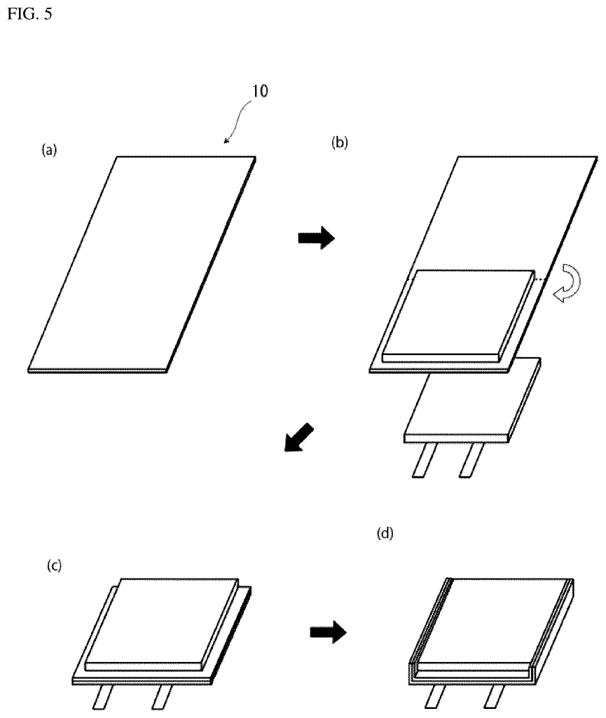

Specifically, an electrical storage device element including at least a positive electrode, a negative electrode, and an electrolyte is covered with the packaging film for electrical storage devices according to the present disclosure such that a flange portion (region where a heat-sealable resin layer is in contact with itself) can be formed on the periphery of the electrical storage device element while a metal terminal connected to each of the positive electrode and the negative electrode protrudes to the outside, and the heat-sealable resin layer at the flange portion is heat-sealed with itself, thereby providing an electrical storage device using the packaging film for electrical storage devices. When the electrical storage device element is housed in the packaging formed of the packaging film for electrical storage devices according to the present disclosure, the packaging is formed in such a manner that the heat-sealable resin portion of the packaging film for electrical storage devices according to the present disclosure is on the inner side (a surface contacting the electrical storage device element). The heat-sealable resin layers of two packaging films for electrical storage devices may be superposed in such a manner as to face each other, followed by heat-sealing the peripheral edge portions of the superposed packaging films for electrical storage devices to form a packaging. Alternatively, as in the example shown in FIG. 5, one packaging film for electrical storage devices may be folded over itself, followed by heat-sealing the peripheral edge portions to form a packaging. When the exterior material is folded over itself, a packaging may be formed by three-side sealing with the exterior material heat-sealed at sides other than the folding side as in the example shown in FIG. 5, or may be subjected to four-side sealing with the exterior material folded in such a manner that a flange portion can be formed. In the packaging film for electrical storage devices, a concave portion for housing an electrical storage device element may be formed by deep drawing molding or bulging molding. As in the example shown in FIG. 5, one packaging film for electrical storage devices may be provided with a concave portion while the other packaging film for electrical storage devices is not provided a concave portion, or the other packaging film for electrical storage devices may also be provided with a concave portion.

As shown in FIG. 7, the packaging film 10 for electrical storage devices according to the present disclosure can be suitably used as an inner packaging 10a of an electrical storage device 30 in which an electrical storage device element 32 is housed in a double-structured case with the inner packaging 10a and an outer packaging 20. That is, the electrical storage device element 32 including at least a positive electrode, a negative electrode and an electrolyte is housed in the inner packaging 10a formed from the packaging film 10 for electrical storage devices according to the present disclosure, and the inner packaging 10a is housed in the outer packaging 20 to obtain the electrical storage device 30 in which an electrical storage device element is housed in a double-structured case with the inner packaging 10a and the outer packaging 20. The electrical storage device 30 can be obtained by providing one or more members with the electrical storage device element 32 housed in the inner packaging 10a formed from the packaging film 10 for electrical storage devices according to the present disclosure, and housing the one or more members in the outer packaging 20. In FIGS. 5 to 7, the corners each have a right angle. However, the angles of the corners and ridge line portions are not limited, and the corners and ridge portions may be rounded.

In the electrical storage device 30 of FIG. 7, the electrical storage device element 32 is covered such that a flange portion (a region where the heat-sealable resin layers 1 are in contact with each other, the region being a peripheral edge portion 30a of the inner packaging 10a) of the inner packaging 10a formed from the packaging film 10 for electrical storage devices can be formed on the peripheral edge of the electrical storage device element 32 while a metal terminal 31 connected to each of the positive electrode and the negative electrode of the electrical storage device element 32 protrudes to the outside, and the heat-sealable resin layers 1 at the flange portion are heat-sealed to each other, whereby the electrical storage device element 32 is sealed with the inner packaging 10a while the heat-sealable resin layer 1 is bonded to the metal terminal 10. When the inner surface of the heat-sealable resin layer 1 of the packaging film 10 for electrical storage devices according to the present disclosure is bondable to metal, the packaging film can be suitably used as a packaging film for directly packaging the electrical storage device element 32 such that the packaging film is bonded to the metal terminal 31. In the electrical storage device 30 with the electrical storage device element 32 housed in a double-structured packaging including the inner packaging 10a and the outer packaging 20 as shown in FIG. 7, the packaging film 10 for electrical storage devices according to the present disclosure can be suitably used for formation of the inner packaging 10a. Since the metal terminal 31 and the heat-sealable resin layer of the packaging film are formed of different materials, adhesion is likely to decrease at an interface between the metal terminal 31 and the heat-sealable resin layer in general. Thus, an adhesive film is typically disposed between the metal terminal and the heat-sealable resin layer of the packaging film, but the packaging film 10 for electrical storage devices of the present disclosure is bondable to metal, and therefore is capable of sealing the electrical storage device element 32 while being bonded to the metal terminal 31, so that it is not necessary to use an adhesive film between the metal terminal and the packaging film.

For the outer packaging 20, there is no particular limitation, and a packaging film including a film-shaped laminate obtained by laminating a base material layer, a metal layer and a heat-sealable resin layer in this order, a metal can, or the like can be used.

The packaging film for electrical storage devices according to the present disclosure can be suitably used for electrical storage devices such as batteries (including condensers, capacitors and the like). The packaging film for electrical storage devices according to the present disclosure may be used for either primary batteries or secondary batteries, and is preferably used for secondary batteries. The type of a secondary battery to which the packaging film for electrical storage devices according to the present disclosure is applied is not particularly limited, and examples thereof include lithium ion batteries, lithium ion polymer batteries, all-solid-state batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers and capacitors. Of these secondary batteries, preferred subjects to which the packaging film for electrical storage devices according to the present disclosure is applied include lithium ion batteries and lithium ion polymer batteries.

Further, the packaging film for electrical storage devices according to the first aspect of the present disclosure (a packaging film for electrical storage devices including at least a heat-sealable resin layer, in which a CO₂ transmission rate in an environment at a temperature of 30° C. is 100 cc·100 μm/m²/24 hr/atm or more) and the packaging film for electrical storage devices according to the second aspect of the present disclosure (a packaging film for electrical storage devices including at least a heat-sealable resin layer, in which the packaging film for electrical storage devices is bondable to metal, and the packaging film for electrical storage devices does not have a metal layer formed of metal) can be each suitably applied to an electrical storage device or a method for manufacturing the electrical storage device according to Embodiment A (Embodiments A1 to A5 and modifications thereof), an electrical storage device or a method for manufacturing the electrical storage device according to Embodiment B (Embodiments B1 to B5 and modifications thereof), and an electrical storage device or a method for manufacturing the electrical storage device according to Embodiment C (Embodiments C1 to C5 and modifications thereof). Hereinafter, Embodiments A, B and C in the first and second aspects will be described in detail.

### Embodiment A

As described above, in a manufacturing process of an electrical storage device, in general, an electrical storage device element is housed in a packaging film for electrical storage devices, and then temporarily sealed by sealing a peripheral edge of the packaging film for electrical storage devices. Thereafter, an initial charge/discharge step, an aging step and the like are carried out. In these steps, gas such as CO₂ is known to be generated from the electrical storage device element. In the present circumstances, for providing a space for holding gas inside a temporarily sealed packaging (formed from a packaging film for electrical storage devices) and releasing gas to the outside by removing the space together with the gas held therein, a packaging film for electrical storage devices, whose size is larger than that needed for an electrical storage device obtained as an end product (for example, equal to or larger than twice a size needed for sealing the electrical storage device element), is used for manufacturing the electrical storage device. Therefore, the manufacturing process of the electrical storage device is complicated.

An object of the invention according to Embodiment A is to provide a method for manufacturing an electrical storage device, which is capable of easily manufacturing an electrical storage device, and an electrical storage device manufactured by the manufacturing method.

The method for manufacturing an electrical storage device according to a first mode of the invention according to Embodiment A is a method for manufacturing an electrical storage device, the electrical storage device including an electrical storage device element, and an inner packaging housing the electrical storage device element, the inner packaging including a gas-permeable packaging film for electrical storage devices, the method including an inner side packaging step of wrapping the electrical storage device element with the packaging film for electrical storage devices, an inner side sealing step of sealing the packaging film for electrical storage devices so as to seal the electrical storage device element with packaging film for electrical storage devices after the inner side packaging step, and a degassing step of releasing gas generated from the electrical storage device element through the packaging film for electrical storage devices after the inner side sealing step.

The method for manufacturing an electrical storage device according to a second mode of the invention according to Embodiment A is the method for manufacturing the electrical storage device according to the first mode, in which in the inner side packaging step, the electrical storage device element is wrapped with the packaging film for electrical storage devices which is substantially identical in size to the inner packaging of a finished product of the electrical storage device.

The electrical storage device according to a third mode of the invention according to Embodiment A includes an electrical storage device element, an inner packaging housing the electrical storage device element, and an outer packaging housing the inner packaging in which the electrical storage device element is housed, the inner packaging including a gas-permeable packaging film for electrical storage devices.

The electrical storage device according to a fourth mode of the invention according to Embodiment A is the electrical storage device according to the third mode, further including a metal terminal electrically connected to the electrical storage device element, and a tab film disposed between the inner packaging and the metal terminal, in which the outer packaging is joined to the inner packaging, the inner packaging and the metal terminal are joined to each other with the tab film interposed therebetween, and at least a part of an outer edge of the inner packaging is exposed from the outer packaging.

The electrical storage device according to a fifth mode of the invention according to Embodiment A is the electrical storage device according to the third mode, further including a metal terminal electrically connected to the electrical storage device element, and tab films disposed between the inner packaging and outer packaging and the metal terminal, in which the inner packaging and the outer packaging are joined to the metal terminal with the tab film interposed therebetween, and a whole of the inner packaging is covered with the outer packaging.

The electrical storage device according to a sixth mode of the invention according to Embodiment A is the electrical storage device according to the third mode, further including a metal terminal electrically connected to the electrical storage device element, in which the inner packaging and the metal terminal are joined to each other, and at least a part of an outer edge of the inner packaging is exposed from the outer packaging.

The electrical storage device according to a seventh mode of the invention according to Embodiment A is the electrical storage device according to any one of the third to sixth modes, in which the packaging film for electrical storage devices further has transparency.

### Embodiment A1

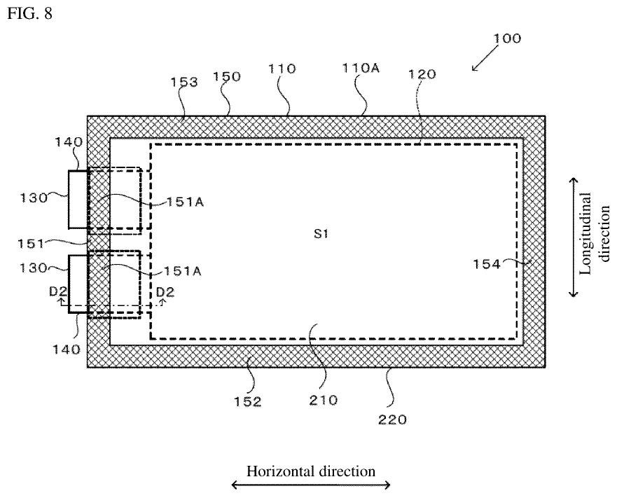

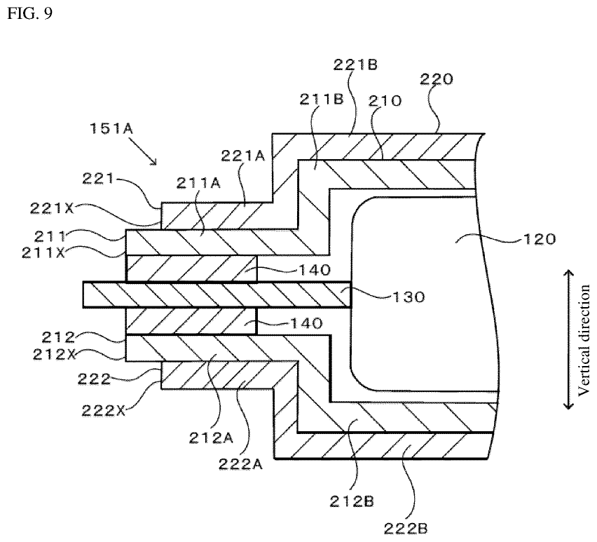

FIG. 8 shows a plan view of an electrical storage device 100 according to the present Embodiment A1. FIG. 9 is a sectional view taken along line D2-D2 in FIG. 8. In FIG. 8, portions that are normally invisible from the outside are partially indicated by dotted lines for reference. Hereinafter, unless otherwise specified, the vertical direction and the horizontal direction in FIG. 8 are referred to as a “longitudinal direction” and a “horizontal direction”, respectively, and the vertical direction in FIG. 9 is referred to as a “vertical direction”, for convenience of explanation. However, the direction of the electrical storage device 100 during use is not limited thereto. In FIG. 8, for simplification of the drawing, the relative positional relationship between an inner packaging 210 and an outer packaging 220 is simplified.

The electrical storage device 100 includes a housing 110, an electrical storage device element 120, a pair of metal terminals 130, and a pair of tab films 140. The housing 110 includes an internal space S1 and a peripheral edge seal portion 150. The electrical storage device element 120 is housed in the internal space S1 of the housing 110. One end of the metal terminal 130 is joined to the electrical storage device element 120, and the other end protrudes outward from the peripheral edge seal portion 150 of the housing 110. A part of the metal terminal 130 between one end and the other end thereof is sealed to the peripheral edge seal portion 150 with the tab film 140 interposed therebetween.

The housing 110 includes a case 110A. The case 110A includes an inner packaging 210 and an outer packaging 220. The inner packaging 210 houses the electrical storage device element 120. The outer packaging 220 houses the inner packaging 210 in which the electrical storage device element 120 is housed. The internal space S1 is formed inside the inner packaging 210. The inner packaging 210 includes packaging films 211 and 212 for electrical storage devices. The outer packaging 220 includes exterior films 221 and 222. At the outer peripheral portion of the case 110A in plan view, the inner packaging 210 and the outer packaging 220 are sealed to each other by heat sealing to form the peripheral edge seal portion 150. An internal space S1 of the case 110A, which is cut off from the external space, is formed in the inner packaging 210 by the peripheral edge seal portion 150. The peripheral edge seal portion 150 defines a peripheral edge of the internal space S1 of the case 110A. The form of the heat sealing mentioned here is assumed to be sealing by heating from a heat source, ultrasonic sealing or the like. In any case, the peripheral edge seal portion 150 means a portion in which the inner packaging 210 and the outer packaging 220 are sealed to each other to be integrated.

The peripheral edge seal portion 150 includes a top seal portion 151, a pair of side seal portions 152 and 153, and a bottom seal portion 154. The top seal portion 151 includes a portion that is sealed while sandwiching the metal terminal 130 and the tab film 140 (hereinafter, referred to as a “terminal seal portion 151A”, and extends in the longitudinal direction. The pair of side seal portions 152 and 153 extend in the horizontal direction. The side seal portion 152 and the side seal portion 153 face each other with the internal space S1 therebetween. The bottom seal portion 154 faces the top seal portion 151 with the internal space S1 therebetween. The bottom seal portion 154 extends in the longitudinal direction.

As shown in FIG. 9, in the terminal seal portion 151A of the top seal portion 151, an exterior film 221, a packaging film 211 for electrical storage devices, one tab film 140, a metal terminal 130, the other tab film 140, a packaging film 212 for electrical storage devices, and an exterior film 222 are laminated in this order from the top, and integrated. Therefore, the top seal portion 151 can be easily formed. In a portion of the top seal portion 151 other than the terminal seal portion 151A, in other words, a portion in which only the pair of tab films 140 are sandwiched by the inner packaging 210 and the outer packaging 220, the exterior film 221, the packaging film 211 for electrical storage devices, one tab film 140, the other tab film 140, the packaging film 212 for electrical storage devices, and the exterior film 222 are laminated in this order from the top, and integrated. Further, in a portion of the top seal portion 151 which is outside the terminal seal portion 151A (a portion on the left of the level difference forming a boundary in FIG. 9), the packaging film 211 for electrical storage devices, one tab film 140, the metal terminal 130, the other tab film 140 and the packaging film 212 for electrical storage devices are laminated in this order from the top, and integrated. Thus, there is a level difference between the portion outside the terminal seal portion 151A where the exterior films 221 and 222 do not exist and the portion inside the terminal seal portion 151A where the exterior films 221 and 222 exist (a portion on the right of the level difference forming the boundary in FIG. 9), but FIG. 8 schematically illustrates the region of the peripheral edge seal portion 150, and does not show the level difference forming a boundary.

The packaging films 211 and 212 for electrical storage devices which form the inner packaging 210 have gas permeability from the viewpoint of easily manufacturing the electrical storage device 100. Hereinafter, a preferred example of the packaging films 211 and 212 for electrical storage devices which form the inner packaging 210 will be described. Hereinafter, the packaging films 211 and 212 for electrical storage devices may be collectively referred to as the packaging film 10 for electrical storage devices when the packaging films 211 and 212 for electrical storage devices are not distinguished.

The shape of the inner packaging 210 is not particularly limited, and can be, for example, a bag shape (pouch shape). The bag shape mentioned here may be of three-way seal type, four-way seal type, pillow type, gusset type or the like. The inner packaging 210 in Embodiment A1 is manufactured by heat-sealing the packaging film 212 for electrical storage devices which has a shape shown in FIG. 9 and is molded in a tray shape and the packaging film 211 for electrical storage devices which is also molded in a tray shape and is superposed on the packaging film 212 for electrical storage devices, along an outer peripheral portion in plan view. The packaging film 212 for electrical storage devices includes an angular ring-shaped flange portion 212A corresponding to the outer peripheral portion in plan view, and a molded part 212B which is continuous with the inner edge of the flange portion 212A and extends downward therefrom. Similarly, the packaging film 211 for electrical storage devices includes an angular ring-shaped flange portion 211A corresponding to the outer peripheral portion in plan view, and a part 211B which is continuous with the inner edge of the flange portion 211A and extends upward therefrom. The packaging films 211 and 212 for electrical storage devices are superposed such that the molded parts 211B and 212B extend in opposite directions. In this state, the flange portion 211A of the packaging film 211 for electrical storage devices and the flange portion 212A of the packaging film 212 for electrical storage devices are heat-sealed so as to be integrated with each other, resulting in formation of a part of the peripheral edge seal portion 150. One of the packaging films 211 and 212 for electrical storage devices may have a sheet shape.

The exterior films 221 and 222 for forming the outer packaging 220 are formed from, for example, a resin molded article or film. The resin molded article mentioned here can be manufactured by a method such as injection molding, compressed-air molding, vacuum molding or blow molding, where in-mold molding may be performed for imparting a design property, and functionality. The type of the resin may be polyolefin, polyester, nylon, ABS, or the like. The film mentioned here is, for example, a resin film that can be manufactured by a method such as an inflation method or a T-die method, or a film obtained by laminating such a resin film on a metal foil or a metal sheet. The film mentioned here may be a stretched film, and may be a single layer film or multiple layer film. The multiple layer film mentioned here may be manufactured by a coating method, may be obtained by bonding a plurality of films with an adhesive or the like, or may be manufactured by a multilayer extrusion method.

The exterior films 221 and 222 can be formed in various ways as described above, and include a laminate film in Embodiment A1. The laminate film can be a laminate obtained by laminating a base material layer, a barrier layer and a heat-sealable resin layer. The base material layer functions as a base material of the exterior films 221 and 222, and is typically a resin layer forming an outer layer of the outer packaging 220 and having insulation quality. The barrier layer has functions of improving the strength of the exterior films 221 and 222 and preventing at least ingress of moisture, among others, into the electrical storage device 100. The barrier layer is typically a metal layer made of an aluminum alloy foil or the like. The heat-sealable resin layer is typically made of a heat-sealable resin such as polyolefin, and forms the innermost layer of the outer packaging 220.

The shape of the outer packaging 220 is not particularly limited, and can be, for example, a bag shape (pouch shape). The bag shape mentioned here may be of three-way seal type, four-way seal type, pillow type, gusset type or the like. However, the case 110A according to Embodiment A1 has a shape as in FIG. 9, and is manufactured by heat-sealing the exterior film 222 molded in a tray shape and the exterior film 221 also molded in a tray shape and superposed on the exterior film 222, along the outer peripheral portion in plan view. The exterior film 222 includes an angular ring-shaped flange portion 222A corresponding to an outer peripheral portion in plan view, and a molded part 222B which is continuous with the inner edge of the flange portion 222A and extends downward therefrom. Similarly, the exterior film 221 includes an angular ring-shaped flange portion 221A corresponding to the outer peripheral portion in plan view, and a part 221B which is continuous with the inner edge of the flange portion 221A and extends upward therefrom. The exterior films 221 and 222 are superposed such that the molded parts 221B and 222B extend in opposite directions. In this state, the flange portion 221A of the exterior film 221 and the flange portion 222A of the exterior film 222 are heat-sealed so as to be integrated with each other, resulting in formation of a part of the peripheral edge seal portion 150. One of the exterior films 221 and 222 may have a sheet shape.

As shown in FIG. 9, in the terminal seal portion 151A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to the flange portion 211A of the packaging film 211 for electrical storage devices. The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

The electrical storage device element 120 includes at least a positive electrode, a negative electrode and an electrolyte, and is, for example, a power storage member of a lithium ion battery (secondary battery), a capacitor, or the like.

The metal terminal 130 is a metal terminal used for inputting and outputting electric power to and from the electrical storage device element 120. The metal terminals 130 are disposed on the top seal portion 151 of the case 110A, with one metal terminal forming a terminal on the positive electrode side and the other forming a terminal on the negative electrode side. One end part of each metal terminal 130 in the horizontal direction is electrically connected to an electrode (positive electrode or negative electrode) of the electrical storage device element 120 in the internal space S1 of the case 110A, and the other end part protrudes outward from the peripheral edge seal portion 150. The above form of the electrical storage device 100 is particularly preferable uses in, for example, an electrically driven vehicle such as an electric vehicle or a hybrid vehicle in which a large number of electrical storage devices 100 are connected in series and used at a high voltage. The locations of attachment of the two metal terminals 130 forming the terminals of the positive electrode and the negative electrode are not particularly limited, and for example, the metal terminals 130 may be disposed on the side seal portions 152 and 153 or the bottom seal portion 154 of the peripheral edge seal portion 150.

The metal material forming the metal terminal 130 is, for example, aluminum, nickel, or copper. When the electrical storage device element 120 is a lithium ion battery, the metal terminal 130 connected to the positive electrode is typically made of aluminum or the like, and the metal terminal 130 connected to the negative electrode is typically made of copper, nickel or the like.

The tab film 140 is a so-called adhesive film, and is configured to be bonded to both the packaging films 211 and 212 for electrical storage devices and the metal terminal 130. By interposing the tab film 140, the metal terminal 130 and the innermost layer (heat-sealable resin layer) of the packaging films 211 and 212 for electrical storage devices can be fixed even if the former and the latter are made of different materials. The tab film 140 is sealed and fixed to the metal terminal 130 to integrate the tab film and the metal terminal in advance, and the packaging films 211 and 212 for electrical storage devices are sealed to the metal terminal 130 to which the tab film 140 is fixed.

### [Method for Manufacturing Electrical Storage Device]

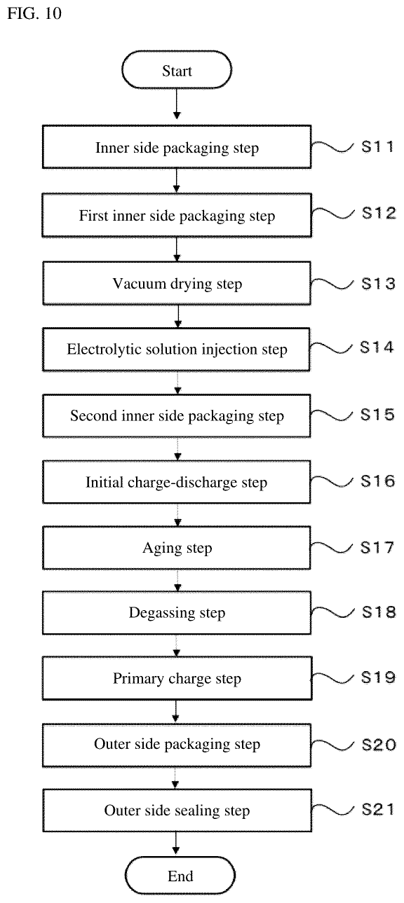

FIG. 10 is a flowchart showing an example of a method for manufacturing the electrical storage device 100. The method for manufacturing the electrical storage device 100 includes a plurality of steps.

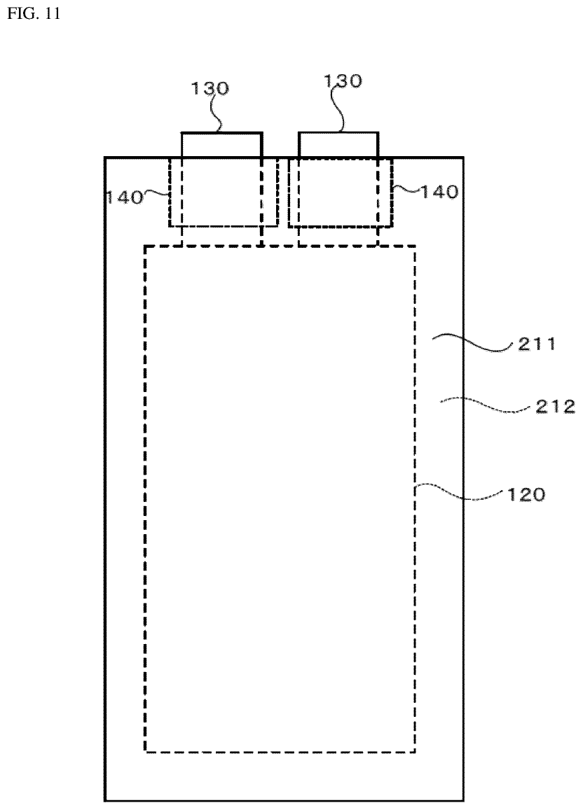

In inner side packaging step S11, the electrical storage device element 120 is wrapped by the molded packaging films 211 and 212 for electrical storage devices as shown in FIG. 11. In the electrical storage device 100 according to the present Embodiment A1, formation of an auxiliary chamber for temporarily storing gas generated from the electrical storage device element 120 in the later-described initial filling step and the like is not necessary because the packaging films 211 and 212 for electrical storage devices have gas permeability. Therefore, in the inner side packaging step, the electrical storage device element 120 is wrapped by packaging films 211 and 212 for electrical storage devices, which are substantially identical in size to packaging films 211 and 212 for electrical storage devices in the inner packaging 210 of a finished product of the electrical storage device 100. Therefore, the manufacturing process of the electrical storage device 100 can be simplified. In addition, the amount of materials used for the electrical storage device 100 can be reduced. The term “substantially identical in size” includes being larger in size than the packaging films 211 and 212 for electrical storage devices in the inner packaging 210 of a finished product of the electrical storage device 100 to the extent that an auxiliary chamber cannot be formed. The metal terminal 130 is connected to the electrical storage device element 120 in advance, and the tab film 140 is joined to the metal terminal 130.

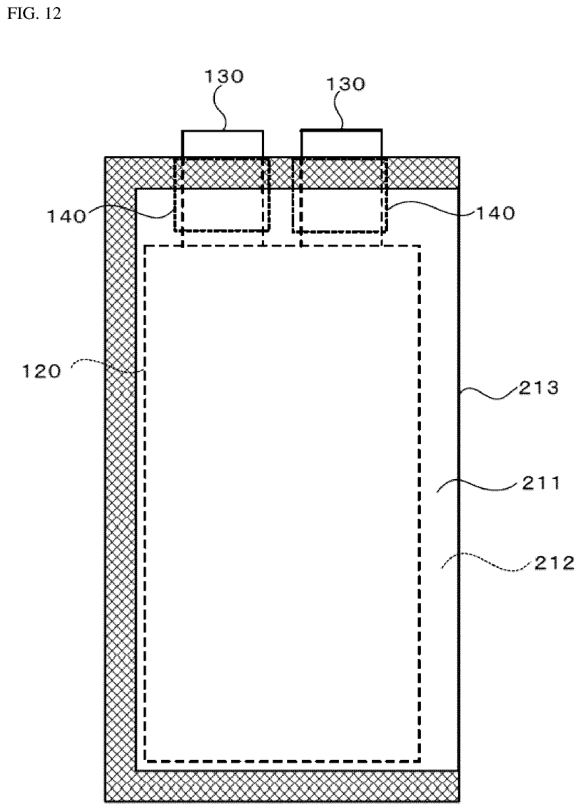

First inner side sealing step S12 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed as shown in FIG. 12. When the first inner side sealing step is completed, an opening 213 is formed in a portion of the peripheral edge of the packaging films 211 and 212 for electrical storage devices on which the side seal portion 153 is to be formed. Vacuum drying step S13 is carried out after the first inner side sealing step.

Electrolytic solution injection step S14 is carried out after the vacuum drying step. In the electrolytic solution injection step, an electrolytic solution is injected through the opening 213 (see FIG. 12).

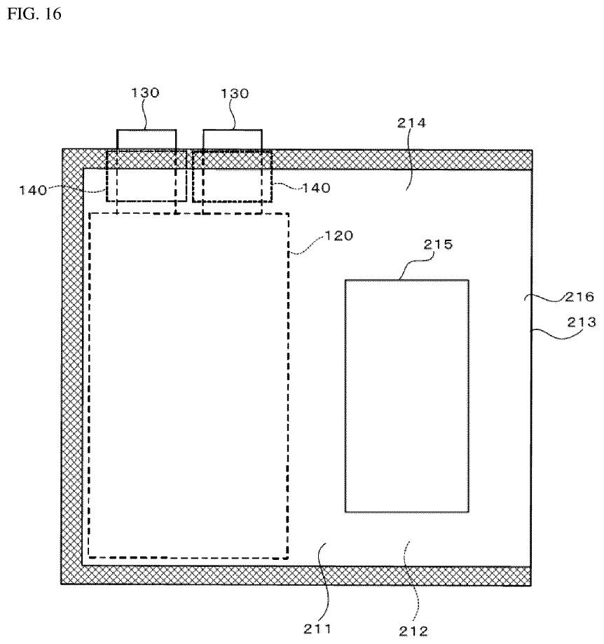

Second inner side sealing step S15 is carried out after the electrolytic solution injection step. In the second inner side sealing step, the opening 213 is closed by sealing a portion of the peripheral edge of the packaging films 211 and 212 for electrical storage devices on which the side seal portion 153 is to be formed as shown in FIG. 16. In the electrical storage device 100, whether or not the packaging film 211 for electrical storage devices and the packaging film 212 for electrical storage devices are appropriately sealed can be easily confirmed after completion of the first inner side sealing step or the second inner side sealing step because the packaging films 211 and 212 for electrical storage devices are transparent. Therefore, the electrical storage device 100 can be suitably manufactured. The state in which the packaging film 211 for electrical storage devices and the packaging film 212 for electrical storage devices are not appropriately sealed includes, for example, a first state, a second state or a third state. The first state is a state in which the packaging film 211 for electrical storage devices and the packaging film 212 for electrical storage devices are sealed with contaminants caught therebetween. The second state is a state in which a part of a portion to be sealed is not sealed. The third state is a state in which a portion that should not be sealed is sealed. After the second inner side sealing step, initial charge-discharge step S16 and aging step S17 are performed in this order.

Degassing step S18 is carried out in parallel to the initial charge-discharge step and the aging step. In Embodiment A1, since the packaging films 211 and 212 for electrical storage devices has gas permeability, gas such as carbon dioxide generated from the electrical storage device element 120 is discharged to the outside through the packaging films 211 and 212 for electrical storage devices when the initial charge-discharge step and the aging step are carried out. Primary charge step S19 is carried out after the degassing step.

Outer side packaging step S20 is carried out after the primary charge step. In the outer side packaging step, the inner packaging 210 in which the electrical storage device element 120 is housed is wrapped by the exterior films 221 and 222.

Outer side sealing step S21 is carried out after the outer side packaging step. In the outer side sealing step, the peripheral edges of the exterior films 221 and 222 are sealed to form the peripheral edge seal portion 150.

### [Characteristics of Electrical Storage Device]

In the electrical storage device 100 according to the present Embodiment A1, formation of an auxiliary chamber for temporarily storing gas generated from the electrical storage device element 120 in the later-described initial filling step and the like is not necessary because the packaging films 211 and 212 for electrical storage devices have gas permeability. Therefore, the manufacturing process of the electrical storage device 100 can be simplified. In addition, the amount of materials used for the electrical storage device 100 can be reduced.

### Embodiment A2

An electrical storage device 100 according to Embodiment A2 has the same configuration as in Embodiment A1 except that the packaging films 211 and 212 for electrical storage devices are not transparent. Hereinafter, the electrical storage device 100 according to Embodiment A2 will be described mainly for portions different from those in Embodiment A2.

### [Method for Manufacturing Electrical Storage Device]

FIG. 11 is a flowchart showing an example of a method for manufacturing the electrical storage device 100 according to Embodiment A2. The method for manufacturing the electrical storage device 100 includes a plurality of steps.

In inner side packaging step S31, the electrical storage device element 120 is wrapped by the molded packaging films 211 and 212 for electrical storage devices as shown in FIG. 12. In the electrical storage device 100 according to the present Embodiment A2, an auxiliary chamber 214 for temporarily storing gas generated from the electrical storage device element 120 in the initial filling step and the like. Therefore, in the inner side packaging step, the electrical storage device element 120 is wrapped by packaging films 211 and 212 for electrical storage devices, which are larger in size than packaging films 211 and 212 for electrical storage devices in the inner packaging 210 of a finished product of the electrical storage device 100. In the auxiliary chamber 214 of the packaging films 211 and 212 for electrical storage devices, a housing chamber 215 for storing a larger amount of gas generated from the electrical storage device element 120 is formed.

First inner side sealing step S32 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed so as to extend to the auxiliary chamber 214 as shown in FIG. 16. When the first inner side sealing step is completed, an opening 213 is formed in a portion 216 of the peripheral edge of the packaging films 211 and 212 for electrical storage devices which faces a portion on which the side seal portion 153 is to be formed, with the auxiliary chamber 214 being interposed between the former and latter portions. Vacuum drying step S33 is carried out after the first inner side sealing step.

Electrolytic solution injection step S34 is carried out after the vacuum drying step. In the electrolytic solution injection step, an electrolytic solution is injected through the opening 213 (see FIG. 16).

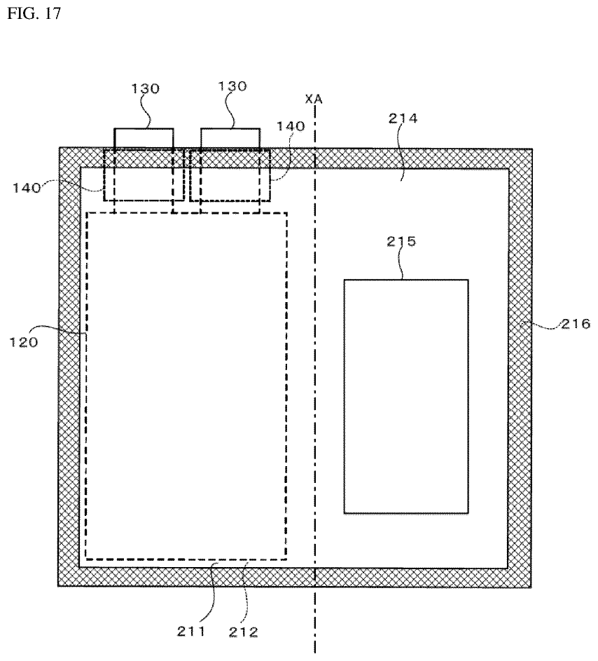

Second inner side sealing step S35 is carried out after the electrolytic solution injection step. In the second inner side sealing step, as shown in FIG. 17, the opening 213 is closed by sealing a portion 216 of the peripheral edge of the packaging films 211 and 212 for electrical storage devices which faces a portion on which the side seal portion 153 is to be formed, with the auxiliary chamber 214 being interposed between the former and latter portions. After the second inner side sealing step, initial charge-discharge step S36 and aging step S37 are performed in this order.

Degassing step S38 is carried out after the aging step. In the degassing step, gas such as carbon dioxide generated from the electrical storage device element 120 is temporarily stored in the auxiliary chamber 214 of the packaging films 211 and 212 for electrical storage devices.

Auxiliary chamber removing step S39 is carried out after the degassing step. In the auxiliary chamber removing step, the auxiliary chamber 214 is removed by cutting the packaging films 211 and 212 for electrical storage devices along the one dot chain line XA shown in FIG. 17 such that the film is identical in size to the inner packaging 210 of a finished product of the electrical storage device 100.

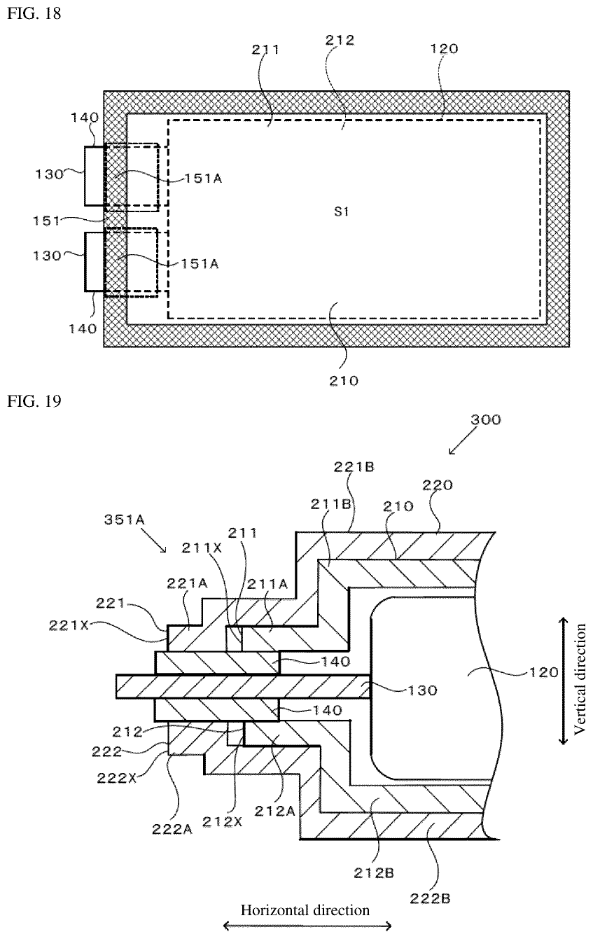

Inner side sealing step S40 is carried out after the auxiliary chamber removing step. In the inner side sealing step, a portion of the peripheral edge of the packaging films 211 and 212 for electrical storage devices which corresponds to the side seal portion 153 is sealed as shown in FIG. 18. Primary charge step S41 is carried out after the inner side sealing step.

Outer side packaging step S42 is carried out after the primary charge step. In the outer side packaging step, the inner packaging 210 in which the electrical storage device element 120 is housed is wrapped by the exterior films 221 and 222.

Outer side sealing step S43 is carried out after the outer side packaging step. In the outer side sealing step, the peripheral edges of the exterior films 221 and 222 are sealed to form the peripheral edge seal portion 150.

### Embodiments A3

An electrical storage device 300 according to Embodiment A3 has the same configuration as in Embodiment A1 except that the configuration of the terminal seal portion 151A is different from that in Embodiment A1. Hereinafter, the electrical storage device 300 according to Embodiment A3 will be described mainly for portions different from those in Embodiment A1.

FIG. 19 is a sectional view of a terminal seal portion 351A of the electrical storage device 300 according to Embodiment A3. In the terminal seal portion 351A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to one tab film 140. The flange portion 222A of the exterior film 222 is joined to the other tab film 140. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 300, ingress of moisture and the like into the internal space S1 of the inner packaging 210 from the outside is suppressed because the inner packaging 210 is covered with the outer packaging 220.

### Embodiment A4

An electrical storage device 400 according to Embodiment A4 has the same configuration as in Embodiment A1 except that the configuration of the terminal seal portion 151A is different from that in Embodiment A1. Hereinafter, the electrical storage device 400 according to Embodiment A4 will be described mainly for portions different from those in Embodiment A1.

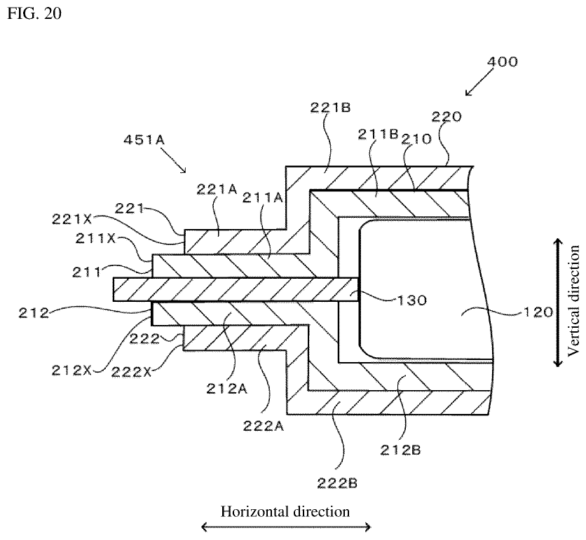

FIG. 20 is a sectional view of a terminal seal portion 451A of the electrical storage device 400 according to Embodiment A4. The electrical storage device 400 does not include the tab film 140. In a terminal seal portion 451A of the electrical storage device 400, the exterior film 221, the packaging film 211 for electrical storage devices, the metal terminal 130, the packaging film 212 for electrical storage devices, and the exterior film 222 are laminated in this order from the top, and integrated.

The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 221A of the exterior film 221 is joined to the flange portion 211A of the packaging film 211 for electrical storage devices. The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

### [Characteristics of Electrical Storage Device]

In the electrical storage device 400, the number of members is small because the packaging films 211 and 212 for electrical storage devices and the metal terminal 130 are joined without interposing the tab film 140 therebetween. In addition, the method for manufacturing the electrical storage device 400 can be simplified.

### Embodiment A5

An electrical storage device 500 according to Embodiment A5 has the same configuration as in Embodiment A4 except that the configuration of the terminal seal portion 451A is different from that in Embodiment A4. Hereinafter, the electrical storage device 500 according to Embodiment A5 will be described mainly for portions different from those in Embodiment A4.

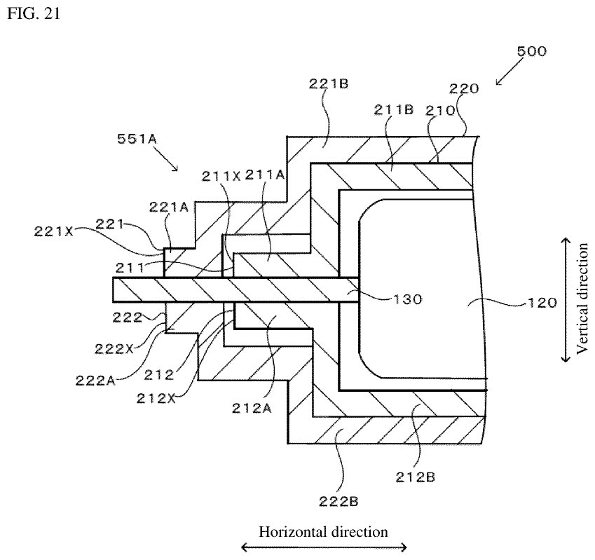

FIG. 21 is a sectional view of a terminal seal portion 551A of the electrical storage device 500 according to Embodiment A5. In the terminal seal portion 551A, a part of the flange portion 211A of the packaging film 211 for electrical storage devices is joined to the metal terminal 130. A part of the flange portion 212A of the packaging film 212 for electrical storage devices is joined to the metal terminal 130.

The flange portion 221A of the exterior film 221 is joined to the metal terminal 130. The flange portion 222A of the exterior film 222 is joined to the metal terminal 130. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 500, ingress of moisture and the like into the internal space S1 of the inner packaging 210 from the outside is suppressed because the inner packaging 210 is covered with the outer packaging 220. In the electrical storage device 500, the number of members is small because the packaging films 211 and 212 for electrical storage devices and the metal terminal 130 are joined without interposing the tab film 140 therebetween. In addition, the method for manufacturing the electrical storage device 500 can be simplified.

### [Modifications]

The embodiments are examples of possible forms of an electrical storage device and a method for manufacturing an electrical storage device according to the present disclosure, and are not intended to limit the forms thereof. The electrical storage device and the method for manufacturing an electrical storage device according to the present disclosure may have a form different from that exemplified in the embodiments. An example thereof is a form in which a part of the configuration of the embodiments is replaced, changed or omitted, or a form in which a new configuration is added to the embodiments. Some examples of modifications of the embodiments will be described below. The following modifications can be combined as long as there is no technical contradiction.

In the electrical storage device 100 according to Embodiment A1, one outer packaging 220 may be configured to house a plurality of inner packagings 210 in which the electrical storage device element 120 is housed. In this modification, the sizes of a plurality of inner packagings 210 may be different or the same. According to this modification, the voltage can be easily adjusted because a plurality of electrical storage device elements 120 can be connected in series or in parallel.

In the electrical storage device 100 according to Embodiment A1, the packaging films 211 and 212 for electrical storage devices are not required to be transparent. The packaging films 211 and 212 for electrical storage devices are only required to have at least gas permeability.

In the electrical storage device 100 according to Embodiment A1, the inner packaging 210 may be formed by folding one packaging film 211 for electrical storage devices, and heat-sealing the peripheral edge portion. Similarly, the outer packaging 220 may be formed by folding one exterior film 221, and heat-sealing the peripheral edge portion.

### Embodiment B

In a manufacturing process of an electrical storage device, in general, an electrical storage device element is housed in a packaging film for electrical storage devices, and then temporarily sealed by sealing a peripheral edge of the packaging film for electrical storage devices. Thereafter, an initial charge/discharge step, an aging step and the like are carried out. The packaging film for electrical storage devices in the secondary battery has a shielding property because it includes a metal layer. For this reason, when the electrical storage device element is sealed by the packaging film for electrical storage devices, it is not possible to confirm whether the peripheral edge of the packaging film for electrical storage devices is appropriately sealed or not. Therefore, the electrical storage device cannot be suitably manufactured.

An object of the invention according to Embodiment B is to provide a method for manufacturing an electrical storage device, which is capable of suitably manufacturing an electrical storage device, and an electrical storage device manufactured by the manufacturing method.

The method for manufacturing an electrical storage device according to the first mode of the invention according to Embodiment B is a method for manufacturing an electrical storage device, the electrical storage device including an electrical storage device element, and an inner packaging housing the electrical storage device element, the inner packaging including a transparent packaging film for electrical storage devices, the method including an inner side packaging step of wrapping the electrical storage device element with the packaging film for electrical storage devices, and an inner side sealing step of sealing the packaging film for electrical storage devices so as to seal the electrical storage device element with packaging film for electrical storage devices after the inner side packaging step.

The method for manufacturing an electrical storage device according to the second mode of the invention according to Embodiment B is the method for manufacturing the electrical storage device according to the first mode, in which the packaging film for electrical storage devices further has gas permeability, the method further including a degassing step of releasing gas generated from the electrical storage device element through the packaging film for electrical storage devices after the inner side sealing step.

The method for manufacturing an electrical storage device according to the third mode of the invention according to Embodiment B is the method for manufacturing the electrical storage device according to the second mode, in which in the inner side packaging step, the electrical storage device element is wrapped with the packaging film for electrical storage devices which is substantially identical in size to the inner packaging of a finished product of the electrical storage device.

The electrical storage device according to the fourth mode of the invention according to Embodiment B includes an electrical storage device element, an inner packaging housing the electrical storage device element, and an outer packaging housing the inner packaging in which the electrical storage device element is housed, the inner packaging including a transparent packaging film for electrical storage devices.

The electrical storage device according to the fifth mode of the invention according to Embodiment B is the electrical storage device according to the fourth mode, further including a metal terminal electrically connected to the electrical storage device element, and a tab film disposed between the inner packaging and the metal terminal, in which the outer packaging is joined to the inner packaging, the inner packaging and the metal terminal are joined to each other with the tab film interposed therebetween, and at least a part of an outer edge of the inner packaging is exposed from the outer packaging.

The electrical storage device according to the sixth mode of the invention according to Embodiment B is the electrical storage device according to the fourth mode, further including a metal terminal electrically connected to the electrical storage device element, and tab films disposed between the inner packaging and outer packaging and the metal terminal, in which the inner packaging and the outer packaging are joined to the metal terminal with the tab film interposed therebetween, and a whole of the inner packaging is covered with the outer packaging.

The electrical storage device according to the seventh mode of the invention according to Embodiment B is the electrical storage device according to the fourth mode, further including a metal terminal electrically connected to the electrical storage device element, in which the inner packaging and the metal terminal are joined to each other, and at least a part of an outer edge of the inner packaging is exposed from the outer packaging.

The electrical storage device according to the eighth mode of the invention according to Embodiment B the present disclosure is the electrical storage device according to the fourth mode, further including a metal terminal electrically connected to the electrical storage device element, in which the inner packaging and the outer packaging are joined to the metal terminal, and a whole of the inner packaging is covered with the outer packaging.

The electrical storage device according to the ninth mode of the invention according to Embodiment B is the electrical storage device according to any one of the third to eighth modes, in which the packaging film for electrical storage devices further has gas permeability.

### Embodiment B1

FIG. 8 shows a plan view of an electrical storage device 100 according to the present Embodiment B1. FIG. 9 is a sectional view taken along line D2-D2 in FIG. 8. In FIG. 8, portions that are normally invisible from the outside are partially indicated by dotted lines for reference. Hereinafter, unless otherwise specified, the vertical direction and the horizontal direction in FIG. 8 are referred to as a “longitudinal direction” and a “horizontal direction”, respectively, and the vertical direction in FIG. 9 is referred to as a “vertical direction”, for convenience of explanation. However, the direction of the electrical storage device 100 during use is not limited thereto. In FIG. 8, for simplification of the drawing, the relative positional relationship between an inner packaging 210 and an outer packaging 220 is simplified.

The electrical storage device 100 includes a housing 110, an electrical storage device element 120, a pair of metal terminals 130, and a pair of tab films 140. The housing 110 includes an internal space S1 and a peripheral edge seal portion 150. The electrical storage device element 120 is housed in the internal space S1 of the housing 110. One end of the metal terminal 130 is joined to the electrical storage device element 120, and the other end protrudes outward from the peripheral edge seal portion 150 of the housing 110. A part of the metal terminal 130 between one end and the other end thereof is sealed to the peripheral edge seal portion 150 with the tab film 140 interposed therebetween.

The housing 110 includes a case 110A. The case 110A includes an inner packaging 210 and an outer packaging 220. The inner packaging 210 houses the electrical storage device element 120. The outer packaging 220 houses the inner packaging 210 in which the electrical storage device element 120 is housed. The internal space S1 is formed inside the inner packaging 210. The inner packaging 210 includes packaging films 211 and 212 for electrical storage devices. The outer packaging 220 includes exterior films 221 and 222. At the outer peripheral portion of the case 110A in plan view, the inner packaging 210 and the outer packaging 220 are sealed to each other by heat sealing to form the peripheral edge seal portion 150. An internal space S1 of the case 110A, which is cut off from the external space, is formed in the inner packaging 210 by the peripheral edge seal portion 150. The peripheral edge seal portion 150 defines a peripheral edge of the internal space S1 of the case 110A. The form of the heat sealing mentioned here is assumed to be sealing by heating from a heat source, ultrasonic sealing or the like. In any case, the peripheral edge seal portion 150 means a portion in which the inner packaging 210 and the outer packaging 220 are sealed to each other to be integrated.

The peripheral edge seal portion 150 includes a top seal portion 151, a pair of side seal portions 152 and 153, and a bottom seal portion 154. The top seal portion 151 includes a portion that is sealed while sandwiching the metal terminal 130 and the tab film 140 (hereinafter, referred to as a “terminal seal portion 151A”, and extends in the longitudinal direction. The pair of side seal portions 152 and 153 extend in the horizontal direction. The side seal portion 152 and the side seal portion 153 face each other with the internal space S1 therebetween. The bottom seal portion 154 faces the top seal portion 151 with the internal space S1 therebetween. The bottom seal portion 154 extends in the longitudinal direction.

As shown in FIG. 9, in the terminal seal portion 151A of the top seal portion 151, an exterior film 221, a packaging film 211 for electrical storage devices, one tab film 140, a metal terminal 130, the other tab film 140, a packaging film 212 for electrical storage devices, and an exterior film 222 are laminated in this order from the top, and integrated. Therefore, the top seal portion 151 can be easily formed. In a portion of the top seal portion 151 other than the terminal seal portion 151A, in other words, a portion in which only the pair of tab films 140 are sandwiched by the inner packaging 210 and the outer packaging 220, the exterior film 221, the packaging film 211 for electrical storage devices, one tab film 140, the other tab film 140, the packaging film 212 for electrical storage devices, and the exterior film 222 are laminated in this order from the top, and integrated. Further, in a portion of the top seal portion 151 which is outside the terminal seal portion 151A (a portion on the left of the level difference forming a boundary in FIG. 9), the packaging film 211 for electrical storage devices, one tab film 140, the metal terminal 130, the other tab film 140 and the packaging film 212 for electrical storage devices are laminated in this order from the top, and integrated. Thus, there is a level difference between the portion outside the terminal seal portion 151A where the exterior films 221 and 222 do not exist and the portion inside the terminal seal portion 151A where the exterior films 221 and 222 exist (a portion on the right of the level difference forming the boundary in FIG. 9), but FIG. 8 schematically illustrates the region of the peripheral edge seal portion 150, and does not show the level difference forming a boundary.

The packaging films 211 and 212 for electrical storage devices which form the inner packaging 210 are transparent as a whole from the viewpoint of suitably manufacturing the electrical storage device 100. Hereinafter, a preferred example of the packaging films 211 and 212 for electrical storage devices which form the inner packaging 210 will be described. Hereinafter, the packaging films 211 and 212 for electrical storage devices may be collectively referred to as the packaging film 10 for electrical storage devices when the packaging films 211 and 212 for electrical storage devices are not distinguished.

The shape of the inner packaging 210 is not particularly limited, and can be, for example, a bag shape (pouch shape). The bag shape mentioned here may be of three-way seal type, four-way seal type, pillow type, gusset type or the like. The inner packaging 210 in Embodiment B1 is manufactured by heat-sealing the packaging film 212 for electrical storage devices which has a shape shown in FIG. 9 and is molded in a tray shape and the packaging film 211 for electrical storage devices which is also molded in a tray shape and is superposed on the packaging film 212 for electrical storage devices, along an outer peripheral portion in plan view. The packaging film 212 for electrical storage devices includes an angular ring-shaped flange portion 212A corresponding to the outer peripheral portion in plan view, and a molded part 212B which is continuous with the inner edge of the flange portion 212A and extends downward therefrom. Similarly, the packaging film 211 for electrical storage devices includes an angular ring-shaped flange portion 211A corresponding to the outer peripheral portion in plan view, and a part 211B which is continuous with the inner edge of the flange portion 211A and extends upward therefrom. The packaging films 211 and 212 for electrical storage devices are superposed such that the molded parts 211B and 212B extend in opposite directions. In this state, the flange portion 211A of the packaging film 211 for electrical storage devices and the flange portion 212A of the packaging film 212 for electrical storage devices are heat-sealed so as to be integrated with each other, resulting in formation of a part of the peripheral edge seal portion 150. One of the packaging films 211 and 212 for electrical storage devices may have a sheet shape.

The exterior films 221 and 222 for forming the outer packaging 220 are formed from, for example, a resin molded article or film. The resin molded article mentioned here can be manufactured by a method such as injection molding, compressed-air molding, vacuum molding or blow molding, where in-mold molding may be performed for imparting a design property, and functionality. The type of the resin may be polyolefin, polyester, nylon, ABS, or the like. The film mentioned here is, for example, a resin film that can be manufactured by a method such as an inflation method or a T-die method, or a film obtained by laminating such a resin film on a metal foil or a metal sheet. The film mentioned here may be a stretched film, and may be a single layer film or multiple layer film. The multiple layer film mentioned here may be manufactured by a coating method, may be obtained by bonding a plurality of films with an adhesive or the like, or may be manufactured by a multilayer extrusion method.

The exterior films 221 and 222 can be formed in various ways as described above, and include a laminate film in Embodiment B1. The laminate film can be a laminate obtained by laminating a base material layer, a barrier layer and a heat-sealable resin layer. The base material layer functions as a base material of the exterior films 221 and 222, and is typically a resin layer forming an outer layer of the outer packaging 220 and having insulation quality. The barrier layer has functions of improving the strength of the exterior films 221 and 222 and preventing at least ingress of moisture, among others, into the electrical storage device 100. The barrier layer is typically a metal layer made of an aluminum alloy foil or the like. The heat-sealable resin layer is typically made of a heat-sealable resin such as polyolefin, and forms the innermost layer of the outer packaging 220.

The shape of the outer packaging 220 is not particularly limited, and can be, for example, a bag shape (pouch shape). The bag shape mentioned here may be of three-way seal type, four-way seal type, pillow type, gusset type or the like. However, the case 110A according to Embodiment B1 has a shape as in FIG. 9, and is manufactured by heat-sealing the exterior film 222 molded in a tray shape and the exterior film 221 also molded in a tray shape and superposed on the exterior film 222, along the outer peripheral portion in plan view. The exterior film 222 includes an angular ring-shaped flange portion 222A corresponding to an outer peripheral portion in plan view, and a molded part 222B which is continuous with the inner edge of the flange portion 222A and extends downward therefrom. Similarly, the exterior film 221 includes an angular ring-shaped flange portion 221A corresponding to the outer peripheral portion in plan view, and a part 221B which is continuous with the inner edge of the flange portion 221A and extends upward therefrom. The exterior films 221 and 222 are superposed such that the molded parts 221B and 222B extend in opposite directions. In this state, the flange portion 221A of the exterior film 221 and the flange portion 222A of the exterior film 222 are heat-sealed so as to be integrated with each other, resulting in formation of a part of the peripheral edge seal portion 150. One of the exterior films 221 and 222 may have a sheet shape.

As shown in FIG. 9, in the terminal seal portion 151A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to the flange portion 211A of the packaging film 211 for electrical storage devices. The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

The electrical storage device element 120 includes at least a positive electrode, a negative electrode and an electrolyte, and is, for example, a power storage member of a lithium ion battery (secondary battery), a capacitor, or the like.

The metal terminal 130 is a metal terminal used for inputting and outputting electric power to and from the electrical storage device element 120. The metal terminals 130 are disposed on the top seal portion 151 of the case 110A, with one metal terminal forming a terminal on the positive electrode side and the other forming a terminal on the negative electrode side. One end part of each metal terminal 130 in the horizontal direction is electrically connected to an electrode (positive electrode or negative electrode) of the electrical storage device element 120 in the internal space S1 of the case 110A, and the other end part protrudes outward from the peripheral edge seal portion 150. The above form of the electrical storage device 100 is particularly preferable uses in, for example, an electrically driven vehicle such as an electric vehicle or a hybrid vehicle in which a large number of electrical storage devices 100 are connected in series and used at a high voltage. The locations of attachment of the two metal terminals 130 forming the terminals of the positive electrode and the negative electrode are not particularly limited, and for example, the metal terminals 130 may be disposed on the side seal portions 152 and 153 or the bottom seal portion 154 of the peripheral edge seal portion 150.

The metal material forming the metal terminal 130 is, for example, aluminum, nickel, or copper. When the electrical storage device element 120 is a lithium ion battery, the metal terminal 130 connected to the positive electrode is typically made of aluminum or the like, and the metal terminal 130 connected to the negative electrode is typically made of copper, nickel or the like.

The tab film 140 is a so-called adhesive film, and is configured to be bonded to both the packaging films 211 and 212 for electrical storage devices and the metal terminal 130. By interposing the tab film 140, the metal terminal 130 and the innermost layer (heat-sealable resin layer) of the packaging films 211 and 212 for electrical storage devices can be fixed even if the former and the latter are made of different materials. The tab film 140 is sealed and fixed to the metal terminal 130 to integrate the tab film and the metal terminal in advance, and the packaging films 211 and 212 for electrical storage devices are sealed to the metal terminal 130 to which the tab film 140 is fixed.

### [Method for Manufacturing Electrical Storage Device]

FIG. 10 is a flowchart showing an example of a method for manufacturing the electrical storage device 100. The method for manufacturing the electrical storage device 100 includes a plurality of steps.

In inner side packaging step S11, the electrical storage device element 120 is wrapped by the molded packaging films 211 and 212 for electrical storage devices as shown in FIG. 11. In the electrical storage device 100 according to the present Embodiment B1, formation of an auxiliary chamber for temporarily storing gas generated from the electrical storage device element 120 in the later-described initial filling step and the like is not necessary because the packaging films 211 and 212 for electrical storage devices have gas permeability. Therefore, in the inner side packaging step, the electrical storage device element 120 is wrapped by packaging films 211 and 212 for electrical storage devices, which are substantially identical in size to packaging films 211 and 212 for electrical storage devices in the inner packaging 210 of a finished product of the electrical storage device 100. Therefore, the manufacturing process of the electrical storage device 100 can be simplified. In addition, the amount of materials used for the electrical storage device 100 can be reduced. The term “substantially identical in size” includes being larger in size than the packaging films 211 and 212 for electrical storage devices in the inner packaging 210 of a finished product of the electrical storage device 100 to the extent that an auxiliary chamber cannot be formed. The metal terminal 130 is connected to the electrical storage device element 120 in advance, and the tab film 140 is joined to the metal terminal 130.

First inner side sealing step S12 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed as shown in FIG. 12. When the first inner side sealing step is completed, an opening 213 is formed in a portion of the peripheral edge of the packaging films 211 and 212 for electrical storage devices on which the side seal portion 153 is to be formed. Vacuum drying step S13 is carried out after the first inner side sealing step.

Electrolytic solution injection step S14 is carried out after the vacuum drying step. In the electrolytic solution injection step, an electrolytic solution is injected through the opening 213 (see FIG. 12).

Second inner side sealing step S15 is carried out after the electrolytic solution injection step. In the second inner side sealing step, the opening 213 is closed by sealing a portion of the peripheral edge of the packaging films 211 and 212 for electrical storage devices on which the side seal portion 153 is to be formed as shown in FIG. 10. After the second inner side sealing step, initial charge-discharge step S16 and aging step S17 are performed in this order.

Degassing step S18 is carried out in parallel to the initial charge-discharge step and the aging step. In Embodiment B1, since the packaging films 211 and 212 for electrical storage devices has gas permeability, gas such as carbon dioxide generated from the electrical storage device element 120 is discharged to the outside through the packaging films 211 and 212 for electrical storage devices when the initial charge-discharge step and the aging step are carried out. Primary charge step S19 is carried out after the degassing step.

Outer side packaging step S20 is carried out after the primary charge step. In the outer side packaging step, the inner packaging 210 in which the electrical storage device element 120 is housed is wrapped by the exterior films 221 and 222.

Outer side sealing step S21 is carried out after the outer side packaging step. In the outer side sealing step, the peripheral edges of the exterior films 221 and 222 are sealed to form the peripheral edge seal portion 150.

### [Characteristics of Electrical Storage Device]

In the electrical storage device 100, whether or not the packaging film 211 for electrical storage devices and the packaging film 212 for electrical storage devices are appropriately sealed can be easily confirmed after completion of the first inner side sealing step or the second inner side sealing step because the packaging films 211 and 212 for electrical storage devices are transparent. Therefore, the electrical storage device 100 can be suitably manufactured. The state in which the packaging film 211 for electrical storage devices and the packaging film 212 for electrical storage devices are not appropriately sealed includes, for example, a first state, a second state or a third state. The first state is a state in which the packaging film 211 for electrical storage devices and the packaging film 212 for electrical storage devices are sealed with contaminants caught therebetween. The second state is a state in which a part of a portion to be sealed is not sealed. The third state is a state in which a portion that should not be sealed is sealed.

### Embodiment B2

An electrical storage device 100 according to Embodiment B2 has the same configuration as in Embodiment B1 except that the packaging films 211 and 212 for electrical storage devices do not have gas permeability, or do not have such high gas permeability that the degassing step S18 is carried out as in Embodiment B1. Hereinafter, the electrical storage device 100 according to Embodiment B2 will be described mainly for portions different from those in Embodiment B2.

### [Method for Manufacturing Electrical Storage Device]

FIG. 11 is a flowchart showing an example of a method for manufacturing the electrical storage device 100 according to Embodiment B2. The method for manufacturing the electrical storage device 100 includes a plurality of steps.

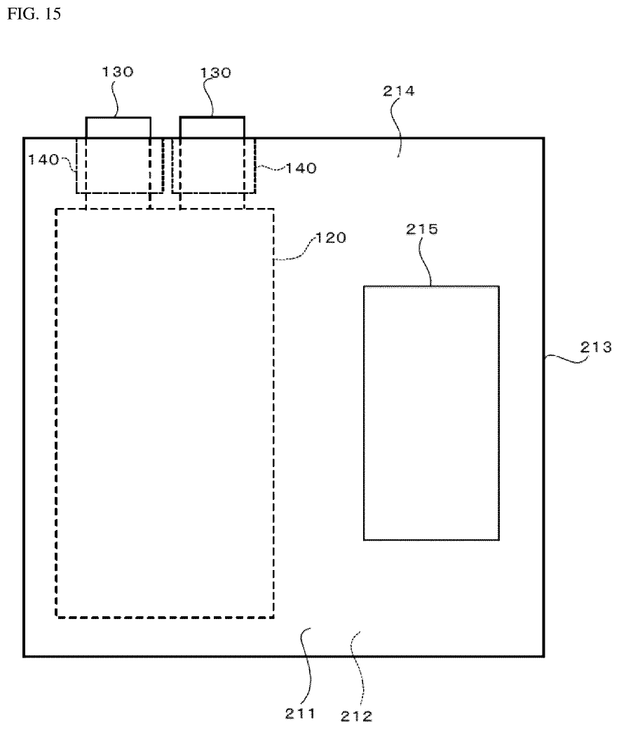

In inner side packaging step S31, the electrical storage device element 120 is wrapped by the molded packaging films 211 and 212 for electrical storage devices as shown in FIG. 15. In the electrical storage device 100 according to the present Embodiment B2, formation of the auxiliary chamber 214 for temporarily storing gas generated from the electrical storage device element 120 in the initial filling step and the like is preferable because the packaging films 211 and 212 for electrical storage devices do not have gas permeability. Therefore, in the inner side packaging step, the electrical storage device element 120 is wrapped by packaging films 211 and 212 for electrical storage devices, which are larger in size than packaging films 211 and 212 for electrical storage devices in the inner packaging 210 of a finished product of the electrical storage device 100. In the auxiliary chamber 214 of the packaging films 211 and 212 for electrical storage devices, a housing chamber 215 for storing a larger amount of gas generated from the electrical storage device element 120 is formed.

First inner side sealing step S32 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed so as to extend to the auxiliary chamber 214 as shown in FIG. 16. When the first inner side sealing step is completed, an opening 213 is formed in a portion 216 of the peripheral edge of the packaging films 211 and 212 for electrical storage devices which faces a portion on which the side seal portion 153 is to be formed, with the auxiliary chamber 214 being interposed between the former and latter portions. Vacuum drying step S33 is carried out after the first inner side sealing step.

Electrolytic solution injection step S34 is carried out after the vacuum drying step. In the electrolytic solution injection step, an electrolytic solution is injected through the opening 213 (see FIG. 16).

Second inner side sealing step S35 is carried out after the electrolytic solution injection step. In the second inner side sealing step, as shown in FIG. 17, the opening 213 is closed by sealing a portion 216 of the peripheral edge of the packaging films 211 and 212 for electrical storage devices which faces a portion on which the side seal portion 153 is to be formed, with the auxiliary chamber 214 being interposed between the former and latter portions. After the second inner side sealing step, initial charge-discharge step S36 and aging step S37 are performed in this order.

Degassing step S38 is carried out after the aging step. In the degassing step, gas such as carbon dioxide generated from the electrical storage device element 120 is temporarily stored in the auxiliary chamber 214 of the packaging films 211 and 212 for electrical storage devices.

Auxiliary chamber removing step S39 is carried out after the degassing step. In the auxiliary chamber removing step, the auxiliary chamber 214 is removed by cutting the packaging films 211 and 212 for electrical storage devices along the one dot chain line XA shown in FIG. 17 such that the film is identical in size to the inner packaging 210 of a finished product of the electrical storage device 100.

Inner side sealing step S40 is carried out after the auxiliary chamber removing step. In the inner side sealing step, a portion of the peripheral edge of the packaging films 211 and 212 for electrical storage devices which corresponds to the side seal portion 153 is sealed as shown in FIG. 18. Primary charge step S41 is carried out after the inner side sealing step.

Outer side packaging step S42 is carried out after the primary charge step. In the outer side packaging step, the inner packaging 210 in which the electrical storage device element 120 is housed is wrapped by the exterior films 221 and 222.

Outer side sealing step S43 is carried out after the outer side packaging step. In the outer side sealing step, the peripheral edges of the exterior films 221 and 222 are sealed to form the peripheral edge seal portion 150.

### [Characteristics of Electrical Storage Device]

The electrical storage device 100 according to Embodiment B3 has the same effect as the electrical storage device 100 according to Embodiment B1 because the packaging films 211 and 212 for electrical storage devices are transparent.

### Embodiment B3

An electrical storage device 300 according to Embodiment B3 has the same configuration as in Embodiment B1 except that the configuration of the terminal seal portion 151A is different from that in Embodiment B1. Hereinafter, the electrical storage device 300 according to Embodiment B3 will be described mainly for portions different from those in Embodiment B1.

FIG. 19 is a sectional view of a terminal seal portion 351A of the electrical storage device 300 according to Embodiment B3. In the terminal seal portion 351A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to one tab film 140. The flange portion 222A of the exterior film 222 is joined to the other tab film 140. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 300, ingress of moisture and the like into the internal space S1 of the inner packaging 210 from the outside is suppressed because the inner packaging 210 is covered with the outer packaging 220.

### Embodiment B4

An electrical storage device 400 according to Embodiment B4 has the same configuration as in Embodiment B1 except that the configuration of the terminal seal portion 151A is different from that in Embodiment B1. Hereinafter, the electrical storage device 400 according to Embodiment B4 will be described mainly for portions different from those in Embodiment B1.

FIG. 20 is a sectional view of a terminal seal portion 451A of the electrical storage device 400 according to Embodiment B4. The electrical storage device 400 does not include the tab film 140. In a terminal seal portion 451A of the electrical storage device 400, the exterior film 221, the packaging film 211 for electrical storage devices, the metal terminal 130, the packaging film 212 for electrical storage devices, and the exterior film 222 are laminated in this order from the top, and integrated.

The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 221A of the exterior film 221 is joined to the flange portion 211A of the packaging film 211 for electrical storage devices. The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

### [Characteristics of Electrical Storage Device]

In the electrical storage device 400, the number of members is small because the packaging films 211 and 212 for electrical storage devices and the metal terminal 130 are joined without interposing the tab film 140 therebetween. In addition, the method for manufacturing the electrical storage device 400 can be simplified.

### Embodiment B5

An electrical storage device 500 according to Embodiment B5 has the same configuration as in Embodiment B4 except that the configuration of the terminal seal portion 451A is different from that in Embodiment B4. Hereinafter, the electrical storage device 500 according to Embodiment B5 will be described mainly for portions different from those in Embodiment B4.

FIG. 21 is a sectional view of a terminal seal portion 551A of the electrical storage device 500 according to Embodiment B5. In the terminal seal portion 551A, a part of the flange portion 211A of the packaging film 211 for electrical storage devices is joined to the metal terminal 130. A part of the flange portion 212A of the packaging film 212 for electrical storage devices is joined to the metal terminal 130.

The flange portion 221A of the exterior film 221 is joined to the metal terminal 130. The flange portion 222A of the exterior film 222 is joined to the metal terminal 130. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 500, ingress of moisture and the like into the internal space S1 of the inner packaging 210 from the outside is suppressed because the inner packaging 210 is covered with the outer packaging 220. In the electrical storage device 500, the number of members is small because the packaging films 211 and 212 for electrical storage devices and the metal terminal 130 are joined without interposing the tab film 140 therebetween. In addition, the method for manufacturing the electrical storage device 500 can be simplified.

### [Modifications]

The embodiments B are examples of possible forms of an electrical storage device and a method for manufacturing an electrical storage device according to the present disclosure, and are not intended to limit the forms thereof. The electrical storage device and the method for manufacturing an electrical storage device according to the present disclosure may have a form different from that exemplified in the embodiments. An example thereof is a form in which a part of the configuration of the embodiments is replaced, changed or omitted, or a form in which a new configuration is added to the embodiments. Some examples of modifications of the embodiments will be described below. The following modifications can be combined as long as there is no technical contradiction.

In the electrical storage device 100 according to Embodiment B1, one outer packaging 220 may be configured to house a plurality of inner packagings 210 in which the electrical storage device element 120 is housed. In this modification, the sizes of a plurality of inner packagings 210 may be different or the same. According to this modification, the voltage can be easily adjusted because a plurality of electrical storage device elements 120 can be connected in series or in parallel.

In the electrical storage device 100 according to Embodiment B1, the packaging films 211 and 212 for electrical storage devices are not required to have gas permeability. The packaging films 211 and 212 for electrical storage devices are only required to have at least transparency.

In the electrical storage device 100 according to Embodiment B1, the inner packaging 210 may be formed by folding one packaging film 211 for electrical storage devices, and heat-sealing the peripheral edge portion. Similarly, the outer packaging 220 may be formed by folding one exterior film 221, and heat-sealing the peripheral edge portion.

### Embodiment C

It is preferable that an electrical storage device has a high value-added function in addition to functions that an electrical storage devices typically has.

An object of the invention according to Embodiment C is to provide an electrical storage device having a high value-added function.

The electrical storage device according to a first mode of the invention according to Embodiment C includes an electrical storage device element, an inner packaging housing the electrical storage device element, an outer packaging housing the inner packaging in which the electrical storage device element is housed, and a functional body disposed between the inner packaging and the outer packaging, the functional body having shock absorbency.

The electrical storage device according to a second mode of the invention according to Embodiment C includes an electrical storage device element, an inner packaging housing the electrical storage device element, an outer packaging housing the inner packaging in which the electrical storage device element is housed, and a functional body disposed between the inner packaging and the outer packaging, the functional body having flame retardancy.

The electrical storage device according to a third mode of the invention according to Embodiment C includes an electrical storage device element, an inner packaging housing the electrical storage device element, an outer packaging housing the inner packaging in which the electrical storage device element is housed, and a functional body disposed between the inner packaging and the outer packaging, the functional body having a cooling property.

The electrical storage device according to a fourth mode of the invention according to Embodiment C includes an electrical storage device element, an inner packaging housing the electrical storage device element, an outer packaging housing the inner packaging in which the electrical storage device element is housed, and a functional body disposed between the inner packaging and the outer packaging, the functional body having a fire-extinguishing property.

The electrical storage device according to a fifth mode of the invention according to Embodiment C includes an electrical storage device element, an inner packaging housing the electrical storage device element, an outer packaging housing the inner packaging in which the electrical storage device element is housed, in which at least one of the inner packaging and the outer packaging has at least one of impact absorbency, flame retardancy, a cooling property and a fire-extinguishing property.

The electrical storage device according to a sixth mode of the invention according to Embodiment C is the electrical storage device according to any one of the first to fifth modes, the inner packaging having at least one of transparency and gas permeability.

The electrical storage device according to a seventh mode of the invention according to Embodiment C is the electrical storage device according to any one of the first to sixth modes, further including a metal terminal electrically connected to the electrical storage device element, and a tab film disposed between the inner packaging and the metal terminal, in which the outer packaging is joined to the inner packaging, the inner packaging and the metal terminal are joined to each other with the tab film interposed therebetween, and at least a part of an outer edge of the inner packaging is exposed from the outer packaging.

The electrical storage device according to an eighth mode of the invention according to Embodiment C is the electrical storage device according to any one of the first to sixth modes, further including a metal terminal electrically connected to the electrical storage device element, and tab films disposed between the inner packaging and outer packaging and the metal terminal, in which the inner packaging and the outer packaging are joined to the metal terminal with the tab film interposed therebetween, and a whole of the inner packaging is covered with the outer packaging.

The electrical storage device according to a ninth mode of the invention according to Embodiment C is the electrical storage device according to any one of the first to sixth modes, further including a metal terminal electrically connected to the electrical storage device element, in which the inner packaging and the metal terminal are joined to each other, and at least a part of an outer edge of the inner packaging is exposed from the outer packaging.

The electrical storage device according to a tenth mode of the invention according to Embodiment C is the electrical storage device according to any one of the first to sixth modes, further including a metal terminal electrically connected to the electrical storage device element, in which the inner packaging and the outer packaging are joined to the metal terminal, and a whole of the inner packaging is covered with the outer packaging.

### Embodiment C1

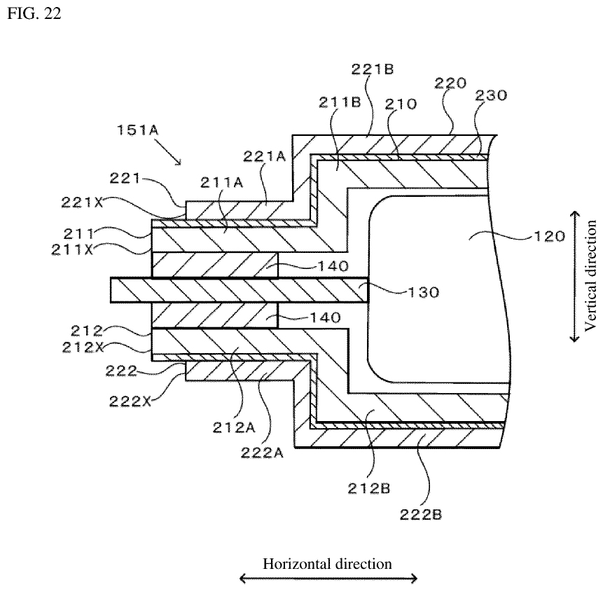

FIG. 8 shows a plan view of an electrical storage device 100 according to the present Embodiment C1. FIG. 22 is a sectional view taken along line D2-D2 in FIG. 8. In FIG. 8, portions that are normally invisible from the outside are partially indicated by dotted lines for reference. Hereinafter, unless otherwise specified, the vertical direction and the horizontal direction in FIG. 8 are referred to as a “longitudinal direction” and a “horizontal direction”, respectively, and the vertical direction in FIG. 22 is referred to as a “vertical direction”, for convenience of explanation. However, the direction of the electrical storage device 100 during use is not limited thereto. In FIG. 8, for simplification of the drawing, the relative positional relationship between an inner packaging 210 and an outer packaging 220 is simplified.

The electrical storage device 100 includes a housing 110, an electrical storage device element 120, a pair of metal terminals 130, and a pair of tab films 140. The housing 110 includes an internal space S1 and a peripheral edge seal portion 150. The electrical storage device element 120 is housed in the internal space S1 of the housing 110. One end of the metal terminal 130 is joined to the electrical storage device element 120, and the other end protrudes outward from the peripheral edge seal portion 150 of the housing 110. A part of the metal terminal 130 between one end and the other end thereof is sealed to the peripheral edge seal portion 150 with the tab film 140 interposed therebetween.

The housing 110 includes a case 110A. The case 110A includes an inner packaging 210 and an outer packaging 220. The inner packaging 210 houses the electrical storage device element 120. The outer packaging 220 houses the inner packaging 210 in which the electrical storage device element 120 is housed. The internal space S1 is formed inside the inner packaging 210. The inner packaging 210 includes packaging films 211 and 212 for electrical storage devices. The outer packaging 220 includes exterior films 221 and 222. At the outer peripheral portion of the case 110A in plan view, the inner packaging 210 and the outer packaging 220 are sealed to each other by heat sealing to form the peripheral edge seal portion 150. An internal space S1 of the case 110A, which is cut off from the external space, is formed in the inner packaging 210 by the peripheral edge seal portion 150. The peripheral edge seal portion 150 defines a peripheral edge of the internal space S1 of the case 110A. The form of the heat sealing mentioned here is assumed to be sealing by heating from a heat source, ultrasonic sealing or the like. In any case, the peripheral edge seal portion 150 means a portion in which the inner packaging 210 and the outer packaging 220 are sealed to each other to be integrated.

The peripheral edge seal portion 150 includes a top seal portion 151, a pair of side seal portions 152 and 153, and a bottom seal portion 154. The top seal portion 151 includes a portion that is sealed while sandwiching the metal terminal 130 and the tab film 140 (hereinafter, referred to as a “terminal seal portion 151A”, and extends in the longitudinal direction. The pair of side seal portions 152 and 153 extend in the horizontal direction. The side seal portion 152 and the side seal portion 153 face each other with the internal space S1 therebetween. The bottom seal portion 154 faces the top seal portion 151 with the internal space S1 therebetween. The bottom seal portion 154 extends in the longitudinal direction.

As shown in FIG. 22, in the terminal seal portion 151A of the top seal portion 151, an exterior film 221, a packaging film 211 for electrical storage devices, one tab film 140, a metal terminal 130, the other tab film 140, a packaging film 212 for electrical storage devices, and an exterior film 222 are laminated in this order from the top, and integrated. Therefore, the top seal portion 151 can be easily formed. In a portion of the top seal portion 151 other than the terminal seal portion 151A, in other words, a portion in which only the pair of tab films 140 are sandwiched by the inner packaging 210 and the outer packaging 220, the exterior film 221, the packaging film 211 for electrical storage devices, one tab film 140, the other tab film 140, the packaging film 212 for electrical storage devices, and the exterior film 222 are laminated in this order from the top, and integrated. Further, in a portion of the top seal portion 151 which is outside the terminal seal portion 151A (a portion on the left of the level difference forming a boundary in FIG. 22), the packaging film 211 for electrical storage devices, one tab film 140, the metal terminal 130, the other tab film 140 and the packaging film 212 for electrical storage devices are laminated in this order from the top, and integrated. Thus, there is a level difference between the portion outside the terminal seal portion 151A where the exterior films 221 and 222 do not exist and the portion inside the terminal seal portion 151A where the exterior films 221 and 222 exist (a portion on the right of the level difference forming the boundary in FIG. 22), but FIG. 8 schematically illustrates the region of the peripheral edge seal portion 150, and does not show the level difference forming a boundary.

The packaging films 211 and 212 for electrical storage devices which form the inner packaging 210 are preferably transparent as a whole from the viewpoint of suitably manufacturing the electrical storage device 100. The packaging films 211 and 212 for electrical storage devices preferably have gas permeability from the viewpoint of easily manufacturing the electrical storage device 100. Hereinafter, a preferred example of the packaging films 211 and 212 for electrical storage devices which form the inner packaging 210 will be described. Hereinafter, the packaging films 211 and 212 for electrical storage devices may be collectively referred to as the packaging film 10 for electrical storage devices when the packaging films 211 and 212 for electrical storage devices are not distinguished.

The shape of the inner packaging 210 is not particularly limited, and can be, for example, a bag shape (pouch shape). The bag shape mentioned here may be of three-way seal type, four-way seal type, pillow type, gusset type or the like. The inner packaging 210 in Embodiment C1 is manufactured by heat-sealing the packaging film 212 for electrical storage devices which has a shape shown in FIG. 22 and is molded in a tray shape and the packaging film 211 for electrical storage devices which is also molded in a tray shape and is superposed on the packaging film 212 for electrical storage devices, along an outer peripheral portion in plan view. The packaging film 212 for electrical storage devices includes an angular ring-shaped flange portion 212A corresponding to the outer peripheral portion in plan view, and a molded part 212B which is continuous with the inner edge of the flange portion 212A and extends downward therefrom. Similarly, the packaging film 211 for electrical storage devices includes an angular ring-shaped flange portion 211A corresponding to the outer peripheral portion in plan view, and a part 211B which is continuous with the inner edge of the flange portion 211A and extends upward therefrom. The packaging films 211 and 212 for electrical storage devices are superposed such that the molded parts 211B and 212B extend in opposite directions. In this state, the flange portion 211A of the packaging film 211 for electrical storage devices and the flange portion 212A of the packaging film 212 for electrical storage devices are heat-sealed so as to be integrated with each other, resulting in formation of a part of the peripheral edge seal portion 150. One of the packaging films 211 and 212 for electrical storage devices may have a sheet shape.

The exterior films 221 and 222 for forming the outer packaging 220 are formed from, for example, a resin molded article or film. The resin molded article mentioned here can be manufactured by a method such as injection molding, compressed-air molding, vacuum molding or blow molding, where in-mold molding may be performed for imparting a design property, and functionality. The type of the resin may be polyolefin, polyester, nylon, ABS, or the like. The film mentioned here is, for example, a resin film that can be manufactured by a method such as an inflation method or a T-die method, or a film obtained by laminating such a resin film on a metal foil or a metal sheet. The film mentioned here may be a stretched film, and may be a single layer film or multiple layer film. The multiple layer film mentioned here may be manufactured by a coating method, may be obtained by bonding a plurality of films with an adhesive or the like, or may be manufactured by a multilayer extrusion method.

The exterior films 221 and 222 can be formed in various ways as described above, and include a laminate film in Embodiment C1. The laminate film can be a laminate obtained by laminating a base material layer, a barrier layer and a heat-sealable resin layer. The base material layer functions as a base material of the exterior films 221 and 222, and is typically a resin layer forming an outer layer of the outer packaging 220 and having insulation quality. The barrier layer has functions of improving the strength of the exterior films 221 and 222 and preventing at least ingress of moisture, among others, into the electrical storage device 100. The barrier layer is typically a metal layer made of an aluminum alloy foil or the like. The heat-sealable resin layer is typically made of a heat-sealable resin such as polyolefin, and forms the innermost layer of the outer packaging 220.

The shape of the outer packaging 220 is not particularly limited, and can be, for example, a bag shape (pouch shape). The bag shape mentioned here may be of three-way seal type, four-way seal type, pillow type, gusset type or the like. However, the case 110A according to Embodiment C1 has a shape as in FIG. 22, and is manufactured by heat-sealing the exterior film 222 molded in a tray shape and the exterior film 221 also molded in a tray shape and superposed on the exterior film 222, along the outer peripheral portion in plan view. The exterior film 222 includes an angular ring-shaped flange portion 222A corresponding to an outer peripheral portion in plan view, and a molded part 222B which is continuous with the inner edge of the flange portion 222A and extends downward therefrom. Similarly, the exterior film 221 includes an angular ring-shaped flange portion 221A corresponding to the outer peripheral portion in plan view, and a part 221B which is continuous with the inner edge of the flange portion 221A and extends upward therefrom. The exterior films 221 and 222 are superposed such that the molded parts 221B and 222B extend in opposite directions. In this state, the flange portion 221A of the exterior film 221 and the flange portion 222A of the exterior film 222 are heat-sealed so as to be integrated with each other, resulting in formation of a part of the peripheral edge seal portion 150. One of the exterior films 221 and 222 may have a sheet shape.

As shown in FIG. 22, in the terminal seal portion 151A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to the flange portion 211A of the packaging film 211 for electrical storage devices. The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

The electrical storage device element 120 includes at least a positive electrode, a negative electrode and an electrolyte, and is, for example, a power storage member of a lithium ion battery (secondary battery), a capacitor, or the like.

The metal terminal 130 is a metal terminal used for inputting and outputting electric power to and from the electrical storage device element 120. The metal terminals 130 are disposed on the top seal portion 151 of the case 110A, with one metal terminal forming a terminal on the positive electrode side and the other forming a terminal on the negative electrode side. One end part of each metal terminal 130 in the horizontal direction is electrically connected to an electrode (positive electrode or negative electrode) of the electrical storage device element 120 in the internal space S1 of the case 110A, and the other end part protrudes outward from the peripheral edge seal portion 150. The above form of the electrical storage device 100 is particularly preferable uses in, for example, an electrically driven vehicle such as an electric vehicle or a hybrid vehicle in which a large number of electrical storage devices 100 are connected in series and used at a high voltage. The locations of attachment of the two metal terminals 130 forming the terminals of the positive electrode and the negative electrode are not particularly limited, and for example, the metal terminals 130 may be disposed on the side seal portions 152 and 153 or the bottom seal portion 154 of the peripheral edge seal portion 150.

The metal material forming the metal terminal 130 is, for example, aluminum, nickel, or copper. When the electrical storage device element 120 is a lithium ion battery, the metal terminal 130 connected to the positive electrode is typically made of aluminum or the like, and the metal terminal 130 connected to the negative electrode is typically made of copper, nickel or the like.

The tab film 140 is a so-called adhesive film, and is configured to be bonded to both the packaging films 211 and 212 for electrical storage devices and the metal terminal 130. By interposing the tab film 140, the metal terminal 130 and the innermost layer (heat-sealable resin layer) of the packaging films 211 and 212 for electrical storage devices can be fixed even if the former and the latter are made of different materials. The tab film 140 is sealed and fixed to the metal terminal 130 to integrate the tab film and the metal terminal in advance, and the packaging films 211 and 212 for electrical storage devices are sealed to the metal terminal 130 to which the tab film 140 is fixed.

The electrical storage device 100 according to Embodiment C1 includes functional body 230 so as to have a high value-added function in addition to functions of a common electrical storage device. The functional body 230 has at least one of shock absorbency, flame retardancy, a cooling property and a fire-extinguishing property. The functional body 230 is disposed between the inner packaging 210 and the outer packaging 220. A specific form of the functional body 230 can be arbitrarily selected. The functional body 230 may be in the form of a sheet such as a film, may be a liquid that can be applied to a film, or may be in the form of particles or a liquid having predetermined fluidity (viscosity).

When the functional body 230 is in the form of a sheet such as a film, for example, the functional body 230 is wound around the inner packaging 210 and joined to the inner packaging 210. The functional body 230 may be joined to the inner packaging 210 so as to cover at least a part of the surface of the inner packaging 210, but is preferably joined to the inner packaging 210 so as to cover substantially the whole of the surface of the inner packaging 210.

When the functional body 230 is a liquid that can be applied to a film or the like, the functional body 230 is applied to the surface of the inner packaging 210 or the inner surface of the outer packaging 220. The functional body 230 may be applied to at least a part of the inner packaging 210, but is preferably applied to substantially the whole of the surface of the inner packaging 210. The phrase “the functional body 230 is a liquid that can be applied to a film or the like” includes a state in which the functional body can be sprayed to the inner packaging 210 and the outer packaging 220 by a spray or the like.

When the functional body 230 is in the form of particles or a liquid having predetermined fluidity (viscosity), the functional body 230 is filled in a space between the inner packaging 210 and the outer packaging 220. The functional body 230 may be filled in at least a part of the space between the inner packaging 210 and the outer packaging 220, but is preferably filled in substantially the whole of the space between the inner packaging 210 and the outer packaging 220.

The functional body 230 having impact absorbency is, for example, a highly foamed non-crosslinked polyethylene sheet, a highly foamed electron-beam-crosslinked polyethylene sheet, a highly foamed polyethylene heat-welded sheet, or nitrile rubber.

The functional body 230 having flame retardancy is, for example, a flame-retardant polycarbonate film, or a flame-retardant polyethylene terephthalate.

The functional body 230 having a cooling property is, for example, a high thermal conductivity film, a high thermal conductivity sheet, or a high thermal conductivity graphite sheet.

The functional body 230 having a fire-extinguishing property is, for example, a fire extinguishing agent, or a film containing a fire extinguishing agent (hereinafter, referred to as a “fireproof film”). The fire extinguishing agent is, for example, a common powder-based fire extinguishing agent such as a potassium salt, sodium hydrogen carbonate or a phosphoric acid salt, an ABC fire extinguishing agent, a BC fire extinguishing agent, or sand. When a fire extinguishing agent is used as the functional body 230, a fire extinguishing agent free of water is preferable from the viewpoint of suppressing deterioration of the functions of the electrical storage device 100.

As the fireproof film, a known fireproof film can be used. The fireproof film is, for example, a laminated film including a base material (base material layer) and a fire extinguishing agent-containing layer in this order. The fire extinguishing agent-containing layer may be provided on at least a part of one surface of the base material, but is preferably provided on the whole of the surface of the base material. The base material has a support region for a fire extinguishing agent component and a binder resin in the base material and on the extinguishing agent-containing layer side.

The fireproof film can be used such that the fire extinguishing agent-containing layer faces an object that may ignite. In Embodiment C1, the fireproof film is joined to the inner surface of the outer packaging 220 such that the fire extinguishing agent-containing layer faces the surface of the inner packaging 210. For example, when the electrical storage device element 120 ignites, initial fire-fighting is performed by aerosol generated from the fire extinguishing agent-containing layer.

The base material has voids, and in the form of, for example, a nonwoven fabric formed by entangling incombustible or flame-retardant fibers or a woven fabric formed by interweaving incombustible or flame-retardant fibers. Examples of the incombustible or flame-retardant fiber include glass fiber, ceramic fiber, metal fiber, cellulose fiber, polyester fiber, carbon fiber, graphite fiber, and thermosetting resin fiber. From the viewpoint of having excellent incombustibility, glass fiber and ceramic fiber can be used. Examples of the base material include glass cloth and incombustible paper. As the base material, an incombustible base material corresponding to Flame Retardation Grade 1 defined in JIS Z 2150-1966 can also be used.

In formation of a coating film on a surface of the base material by applying a coating liquid containing a fire extinguishing agent component and a binder resin, a part of the coating liquid enters into the base material to form the support region in the base material. It can be said that the base material includes a support region for the fire extinguishing agent component and the binder resin, and a region that does not support the fire extinguishing agent component and the binder resin.

The fire extinguishing agent-containing layer contains a fire extinguishing agent component and a binder resin. The fire extinguishing agent component generates aerosol by combustion. The fire extinguishing agent component contains, for example, at least an inorganic oxidizing agent and a radical generator. The radical generator has an action of stabilizing combustion radicals to suppress a chain reaction of combustion (negative catalytic action).

### [Method for Manufacturing Electrical Storage Device]

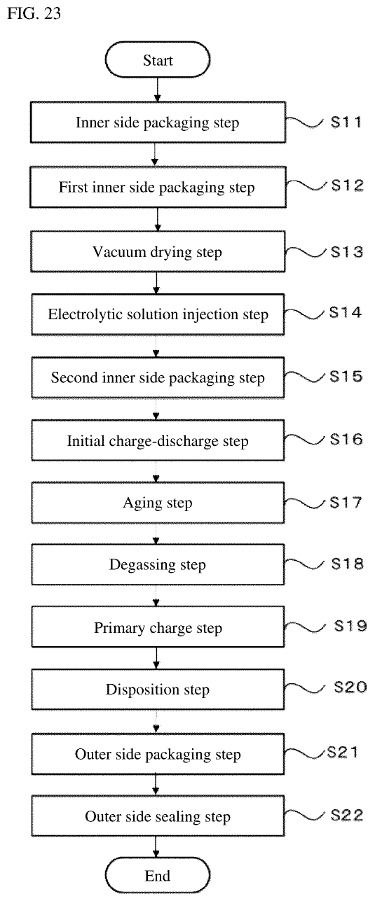

FIG. 23 is a flowchart showing an example of a method for manufacturing the electrical storage device 100. The method for manufacturing the electrical storage device 100 includes a plurality of steps.

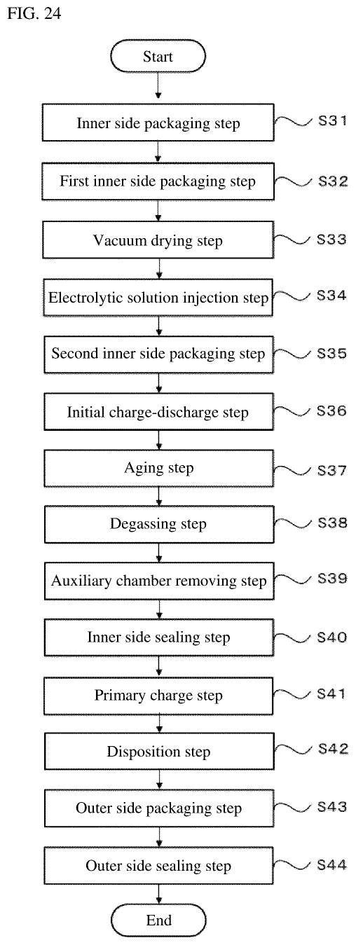

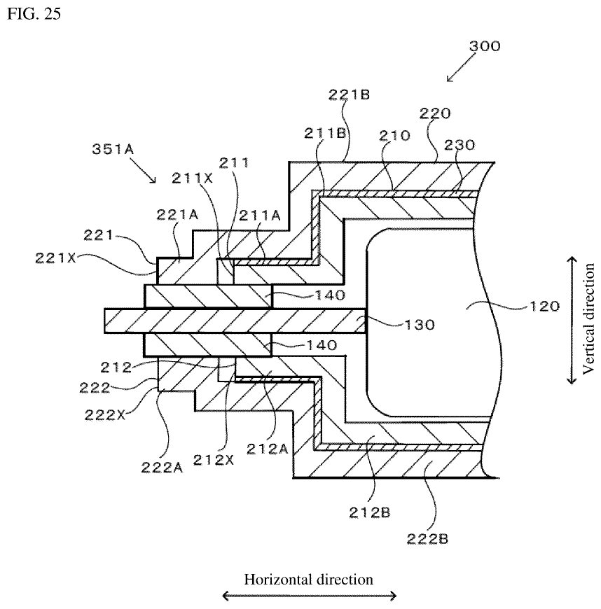

In inner side packaging step S11, the electrical storage device element 120 is wrapped by the molded packaging films 211 and 212 for electrical storage devices as shown in FIG. 24. In the electrical storage device 100 according to the present Embodiment C1, formation of an auxiliary chamber for temporarily storing gas generated from the electrical storage device element 120 in the later-described initial filling step and the like is not necessary because the packaging films 211 and 212 for electrical storage devices have gas permeability. Therefore, in the inner side packaging step, the electrical storage device element 120 is wrapped by packaging films 211 and 212 for electrical storage devices, which are substantially identical in size to packaging films 211 and 212 for electrical storage devices in the inner packaging 210 of a finished product of the electrical storage device 100. Therefore, the manufacturing process of the electrical storage device 100 can be simplified. In addition, the amount of materials used for the electrical storage device 100 can be reduced. The term “substantially identical in size” includes being larger in size than the packaging films 211 and 212 for electrical storage devices in the inner packaging 210 of a finished product of the electrical storage device 100 to the extent that an auxiliary chamber cannot be formed. The metal terminal 130 is connected to the electrical storage device element 120 in advance, and the tab film 140 is joined to the metal terminal 130.

First inner side sealing step S12 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed as shown in FIG. 12. When the first inner side sealing step is completed, an opening 213 is formed in a portion of the peripheral edge of the packaging films 211 and 212 for electrical storage devices on which the side seal portion 153 is to be formed. Vacuum drying step S13 is carried out after the first inner side sealing step.

Electrolytic solution injection step S14 is carried out after the vacuum drying step. In the electrolytic solution injection step, an electrolytic solution is injected through the opening 213 (see FIG. 12).

Second inner side sealing step S15 is carried out after the electrolytic solution injection step. In the second inner side sealing step, the opening 213 is closed by sealing a portion of the peripheral edge of the packaging films 211 and 212 for electrical storage devices on which the side seal portion 153 is to be formed as shown in FIG. 23. In the electrical storage device 100, whether or not the packaging film 211 for electrical storage devices and the packaging film 212 for electrical storage devices are appropriately sealed can be easily confirmed after completion of the first inner side sealing step or the second inner side sealing step because the packaging films 211 and 212 for electrical storage devices are transparent. Therefore, the electrical storage device 100 can be suitably manufactured. The state in which the packaging film 211 for electrical storage devices and the packaging film 212 for electrical storage devices are not appropriately sealed includes, for example, a first state, a second state or a third state. The first state is a state in which the packaging film 211 for electrical storage devices and the packaging film 212 for electrical storage devices are sealed with contaminants caught therebetween. The second state is a state in which a part of a portion to be sealed is not sealed. The third state is a state in which a portion that should not be sealed is sealed. After the second inner side sealing step, initial charge-discharge step S16 and aging step S17 are performed in this order.

Degassing step S18 is carried out in parallel to the initial charge-discharge step and the aging step. In Embodiment C1, since the packaging films 211 and 212 for electrical storage devices has gas permeability, gas such as carbon dioxide generated from the electrical storage device element 120 is discharged to the outside through the packaging films 211 and 212 for electrical storage devices when the initial charge-discharge step and the aging step are carried out. Primary charge step S19 is carried out after the degassing step.

Disposition step S20 is carried out after the primary filling step. In the disposition step, the functional body 230 is disposed between the inner packaging 210 and the outer packaging 230 in a manner appropriate to a specific form of the functional body 230. When the functional body 230 is in the form of a sheet such as a film, for example, the functional body 230 is wound around the inner packaging 210 and joined to the inner packaging 210. When the functional body 230 is a liquid that can be applied to a film or the like, the functional body 230 is applied to the surface of the inner packaging 210 or the inner surface of the outer packaging 220.

Outer side packaging step S21 is carried out after the disposition step. In the outer side packaging step, the inner packaging 210 in which the electrical storage device element 120 is housed is wrapped by the exterior films 221 and 222.

Outer side sealing step S22 is carried out after the outer side packaging step. In the outer side sealing step, the peripheral edges of the exterior films 221 and 222 are sealed to form the peripheral edge seal portion 150. When the functional body 230 is in the form of particles or a liquid having predetermined fluidity (viscosity), the disposition step may be carried out by filling the functional body from an opening of a portion in which the bottom seal portion 154 is formed after formation of, for example, the top seal portion 151 and the side seal portions 152 and 153 of the peripheral edge seal portion 150 in the outer side sealing step.

### [Characteristics of Electrical Storage Device]

The electrical storage device 100 has a high added value because it includes the functional body 230.

### Embodiment C2

An electrical storage device 100 according to Embodiment C2 has the same configuration as in Embodiment C1 except that the packaging films 211 and 212 for electrical storage devices do not have gas permeability, or do not have such high gas permeability that the degassing step S18 is carried out as in Embodiment C1. Hereinafter, the electrical storage device 100 according to Embodiment C2 will be described mainly for portions different from those in Embodiment C2.

### [Method for Manufacturing Electrical Storage Device]

FIG. 24 is a flowchart showing an example of a method for manufacturing the electrical storage device 100 according to Embodiment C2. The method for manufacturing the electrical storage device 100 includes a plurality of steps.

In inner side packaging step S31, the electrical storage device element 120 is wrapped by the molded packaging films 211 and 212 for electrical storage devices as shown in FIG. 15. In the electrical storage device 100 according to the present Embodiment C2, formation of the auxiliary chamber 214 for temporarily storing gas generated from the electrical storage device element 120 in the initial filling step and the like is preferable because the packaging films 211 and 212 for electrical storage devices do not have gas permeability. Therefore, in the inner side packaging step, the electrical storage device element 120 is wrapped by packaging films 211 and 212 for electrical storage devices, which are larger in size than packaging films 211 and 212 for electrical storage devices in the inner packaging 210 of a finished product of the electrical storage device 100. In the auxiliary chamber 214 of the packaging films 211 and 212 for electrical storage devices, a housing chamber 215 for storing a larger amount of gas generated from the electrical storage device element 120 is formed.

First inner side sealing step S32 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed so as to extend to the auxiliary chamber 214 as shown in FIG. 16. When the first inner side sealing step is completed, an opening 213 is formed in a portion 216 of the peripheral edge of the packaging films 211 and 212 for electrical storage devices which faces a portion on which the side seal portion 153 is to be formed, with the auxiliary chamber 214 being interposed between the former and latter portions. Vacuum drying step S33 is carried out after the first inner side sealing step.

Electrolytic solution injection step S34 is carried out after the vacuum drying step. In the electrolytic solution injection step, an electrolytic solution is injected through the opening 213 (see FIG. 16).

Second inner side sealing step S35 is carried out after the electrolytic solution injection step. In the second inner side sealing step, as shown in FIG. 17, the opening 213 is closed by sealing a portion 216 of the peripheral edge of the packaging films 211 and 212 for electrical storage devices which faces a portion on which the side seal portion 153 is to be formed, with the auxiliary chamber 214 being interposed between the former and latter portions. After the second inner side sealing step, initial charge-discharge step S36 and aging step S37 are performed in this order.

Degassing step S38 is carried out after the aging step. In the degassing step, gas such as carbon dioxide generated from the electrical storage device element 120 is temporarily stored in the auxiliary chamber 214 of the packaging films 211 and 212 for electrical storage devices.

Auxiliary chamber removing step S39 is carried out after the degassing step. In the auxiliary chamber removing step, the auxiliary chamber 214 is removed by cutting the packaging films 211 and 212 for electrical storage devices along the one dot chain line XA shown in FIG. 17 such that the film is identical in size to the inner packaging 210 of a finished product of the electrical storage device 100.

Inner side sealing step S40 is carried out after the auxiliary chamber removing step. In the inner side sealing step, a portion of the peripheral edge of the packaging films 211 and 212 for electrical storage devices which corresponds to the side seal portion 153 is sealed as shown in FIG. 18. Primary charge step S41 is carried out after the inner side sealing step.

Disposition step S42 is carried out after the primary filling step. In the disposition step, the functional body 230 is disposed between the inner packaging 210 and the outer packaging 230 in a manner appropriate to a specific form of the functional body 230. When the functional body 230 is in the form of a sheet such as a film, for example, the functional body 230 is wound around the inner packaging 210 and joined to the inner packaging 210. When the functional body 230 is a liquid that can be applied to a film or the like, the functional body 230 is applied to the surface of the inner packaging 210 or the inner surface of the outer packaging 220.

Outer side packaging step S43 is carried out after the disposition step. In the outer side packaging step, the inner packaging 210 in which the electrical storage device element 120 is housed is wrapped by the exterior films 221 and 222.

Outer side sealing step S44 is carried out after the outer side packaging step. In the outer side sealing step, the peripheral edges of the exterior films 221 and 222 are sealed to form the peripheral edge seal portion 150. When the functional body 230 is in the form of particles or a liquid having predetermined fluidity (viscosity), the disposition step may be carried out by filling the functional body from an opening of a portion in which the bottom seal portion 154 is formed after formation of, for example, the top seal portion 151 and the side seal portions 152 and 153 of the peripheral edge seal portion 150 in the outer side sealing step.

### [Characteristics of Electrical Storage Device]

The electrical storage device 100 according to Embodiment C3 has the same effect as the electrical storage device 100 according to Embodiment C1 because the electrical storage device 100 according to Embodiment C3 includes the functional body 230.

### Embodiment C3

An electrical storage device 300 according to Embodiment C3 has the same configuration as in Embodiment C1 except that the configuration of the terminal seal portion 151A is different from that in Embodiment C1. Hereinafter, the electrical storage device 300 according to Embodiment C3 will be described mainly for portions different from those in Embodiment C1.

FIG. 25 is a sectional view of a terminal seal portion 351A of the electrical storage device 300 according to Embodiment C3. In the terminal seal portion 351A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to one tab film 140. The flange portion 222A of the exterior film 222 is joined to the other tab film 140. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 300, ingress of moisture and the like into the internal space S1 of the inner packaging 210 from the outside is suppressed because the inner packaging 210 is covered with the outer packaging 220.

### Embodiment C4

An electrical storage device 400 according to Embodiment C4 has the same configuration as in Embodiment C1 except that the configuration of the terminal seal portion 151A is different from that in Embodiment C. Hereinafter, the electrical storage device 400 according to Embodiment C4 will be described mainly for portions different from those in Embodiment C1.

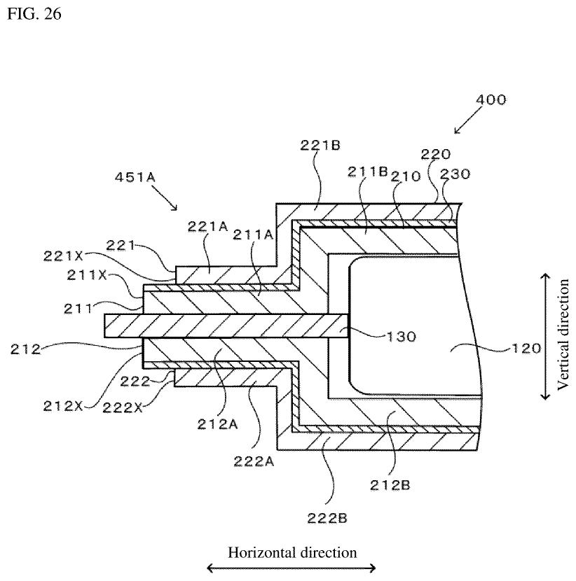

FIG. 26 is a sectional view of a terminal seal portion 451A of the electrical storage device 400 according to Embodiment C4. The electrical storage device 400 does not include the tab film 140. In a terminal seal portion 451A of the electrical storage device 400, the exterior film 221, the packaging film 211 for electrical storage devices, the metal terminal 130, the packaging film 212 for electrical storage devices, and the exterior film 222 are laminated in this order from the top, and integrated.

The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 221A of the exterior film 221 is joined to the flange portion 211A of the packaging film 211 for electrical storage devices. The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

### [Characteristics of Electrical Storage Device]

In the electrical storage device 400, the number of members is small because the packaging films 211 and 212 for electrical storage devices and the metal terminal 130 are joined without interposing the tab film 140 therebetween. In addition, the method for manufacturing the electrical storage device 400 can be simplified.

### Embodiment C5

An electrical storage device 500 according to Embodiment C5 has the same configuration as in Embodiment C4 except that the configuration of the terminal seal portion 451A is different from that in Embodiment C4. Hereinafter, the electrical storage device 500 according to Embodiment C5 will be described mainly for portions different from those in Embodiment C4.

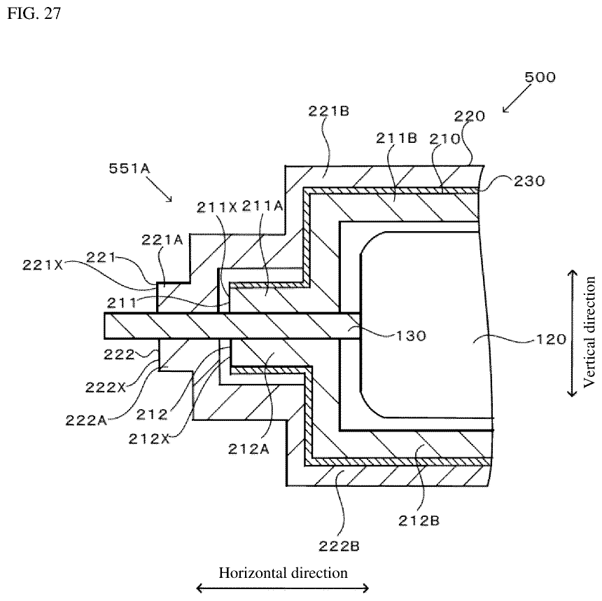

FIG. 27 is a sectional view of a terminal seal portion 551A of the electrical storage device 500 according to Embodiment C5. In the terminal seal portion 551A, a part of the flange portion 211A of the packaging film 211 for electrical storage devices is joined to the metal terminal 130. A part of the flange portion 212A of the packaging film 212 for electrical storage devices is joined to the metal terminal 130.

The flange portion 221A of the exterior film 221 is joined to the metal terminal 130. The flange portion 222A of the exterior film 222 is joined to the metal terminal 130. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 500, ingress of moisture and the like into the internal space S1 of the inner packaging 210 from the outside is suppressed because the inner packaging 210 is covered with the outer packaging 220. In the electrical storage device 500, the number of members is small because the packaging films 211 and 212 for electrical storage devices and the metal terminal 130 are joined without interposing the tab film 140 therebetween. In addition, the method for manufacturing the electrical storage device 500 can be simplified.

### [Modifications]

The embodiments C are examples of possible forms of an electrical storage device and a method for manufacturing an electrical storage device according to the present disclosure, and are not intended to limit the forms thereof. The electrical storage device and the method for manufacturing an electrical storage device according to the present disclosure may have a form different from that exemplified in the embodiments. An example thereof is a form in which a part of the configuration of the embodiments is replaced, changed or omitted, or a form in which a new configuration is added to the embodiments. Some examples of modifications of the embodiments will be described below. The following modifications can be combined as long as there is no technical contradiction.

In electrical storage device 100 according to Embodiment C1, the functional body 230 may be contained in the packaging films 211 and 212 for electrical storage devices and/or the exterior films 221 and 222. That is, in the electrical storage device 100 of this modification, at least one of the inner packaging 210 and the outer packaging 220 is configured to have at least one of shock absorbability, flame retardancy, a cooling property, and a fire-extinguishing property.

In the electrical storage device 100 according to Embodiment C1, one outer packaging 220 may be configured to house a plurality of inner packagings 210 in which the electrical storage device element 120 is housed. In this modification, the sizes of a plurality of inner packagings 210 may be different or the same. According to this modification, the voltage can be easily adjusted because a plurality of electrical storage device elements 120 can be connected in series or in parallel.

In the electrical storage device 100 according to Embodiment C1, the packaging films 211 and 212 for electrical storage devices are not required to have transparency and gas permeability.

In the electrical storage device 100 according to Embodiment C1, the inner packaging 210 may be formed by folding one packaging film 211 for electrical storage devices, and heat-sealing the peripheral edge portion. Similarly, the outer packaging 220 may be formed by folding one exterior film 221, and heat-sealing the peripheral edge portion.

### Third Aspect

### Embodiment 1

FIG. 8 shows a plan view of an electrical storage device 100 according to the present Embodiment 1. FIG. 9 is a sectional view taken along line D2-D2 in FIG. 8. In FIG. 8, portions that are normally invisible from the outside are partially indicated by dotted lines for reference. Hereinafter, unless otherwise specified, the vertical direction and the horizontal direction in FIG. 8 are referred to as a “longitudinal direction” and a “horizontal direction”, respectively, and the vertical direction in FIG. 9 is referred to as a “vertical direction”, for convenience of explanation. However, the direction of the electrical storage device 100 during use is not limited thereto. In FIG. 8, for simplification of the drawing, the relative positional relationship between an inner packaging 210 and an outer packaging 220 is simplified.

The electrical storage device 100 includes a housing 110, an electrical storage device element 120, a pair of metal terminals 130, and a pair of tab films 140. The housing 110 includes an internal space S1 and a peripheral edge seal portion 150. The electrical storage device element 120 is housed in the internal space S1 of the housing 110. One end of the metal terminal 130 is joined to the electrical storage device element 120, and the other end protrudes outward from the peripheral edge seal portion 150 of the housing 110. A part of the metal terminal 130 between one end and the other end thereof is sealed to the peripheral edge seal portion 150 with the tab film 140 interposed therebetween.

The housing 110 includes a case 110A. The case 110A includes an inner packaging 210 and an outer packaging 220. The inner packaging 210 houses the electrical storage device element 120. The outer packaging 220 houses the inner packaging 210 in which the electrical storage device element 120 is housed. The internal space S1 is formed inside the inner packaging 210. The inner packaging 210 includes packaging films 211 and 212 for electrical storage devices. The outer packaging 220 includes exterior films 221 and 222. At the outer peripheral portion of the case 110A in plan view, the inner packaging 210 and the outer packaging 220 are sealed to each other by heat sealing to form the peripheral edge seal portion 150. An internal space S1 of the case 110A, which is cut off from the external space, is formed in the inner packaging 210 by the peripheral edge seal portion 150. The peripheral edge seal portion 150 defines a peripheral edge of the internal space S1 of the case 110A. The form of the heat sealing mentioned here is assumed to be sealing by heating from a heat source, ultrasonic sealing or the like. In any case, the peripheral edge seal portion 150 means a portion in which the inner packaging 210 and the outer packaging 220 are sealed to each other to be integrated.

The peripheral edge seal portion 150 includes a top seal portion 151, a pair of side seal portions 152 and 153, and a bottom seal portion 154. The top seal portion 151 includes a portion that is sealed while sandwiching the metal terminal 130 and the tab film 140 (hereinafter, referred to as a “terminal seal portion 151A”, and extends in the longitudinal direction. The pair of side seal portions 152 and 153 extend in the horizontal direction. The side seal portion 152 and the side seal portion 153 face each other with the internal space S1 therebetween. The bottom seal portion 154 faces the top seal portion 151 with the internal space S1 therebetween. The bottom seal portion 154 extends in the longitudinal direction.

As shown in FIG. 9, in the terminal seal portion 151A of the top seal portion 151, an exterior film 221, a packaging film 211 for electrical storage devices, one tab film 140, a metal terminal 130, the other tab film 140, a packaging film 212 for electrical storage devices, and an exterior film 222 are laminated in this order from the top, and integrated. Therefore, the top seal portion 151 can be easily formed. In a portion of the top seal portion 151 other than the terminal seal portion 151A, in other words, a portion in which only the pair of tab films 140 are sandwiched by the inner packaging 210 and the outer packaging 220, the exterior film 221, the packaging film 211 for electrical storage devices, one tab film 140, the other tab film 140, the packaging film 212 for electrical storage devices, and the exterior film 222 are laminated in this order from the top, and integrated. Further, in a portion of the top seal portion 151 which is outside the terminal seal portion 151A (a portion on the left of the level difference forming a boundary in FIG. 9), the packaging film 211 for electrical storage devices, one tab film 140, the metal terminal 130, the other tab film 140 and the packaging film 212 for electrical storage devices are laminated in this order from the top, and integrated. Thus, there is a level difference between the portion outside the terminal seal portion 151A where the exterior films 221 and 222 do not exist and the portion inside the terminal seal portion 151A where the exterior films 221 and 222 exist (a portion on the right of the level difference forming the boundary in FIG. 9), but FIG. 8 schematically illustrates the region of the peripheral edge seal portion 150, and does not show the level difference forming a boundary.

The packaging films 211 and 212 for electrical storage devices which form the inner packaging 210 are transparent as a whole from the viewpoint of suitably manufacturing the electrical storage device 100. Hereinafter, a preferred example of the packaging films 211 and 212 for electrical storage devices which form the inner packaging 210 will be described. Hereinafter, the packaging films 211 and 212 for electrical storage devices may be collectively referred to as the packaging film 10 for electrical storage devices when the packaging films 211 and 212 for electrical storage devices are not distinguished.

### [Laminated Structure and Physical Properties of Packaging Film for Electrical Storage Devices According to Third Aspect]

As shown in, for example, FIGS. 1 to 4, a packaging film 10 for electrical storage devices according to the third aspect includes at least a heat-sealable resin layer 1. In construction of an electrical storage device using the packaging film 10 for electrical storage devices and an electrical storage device element, the electrical storage device element is put in a space formed by heat-sealing the peripheral portions of heat-sealable resin layers 1 of the packaging film 10 for electrical storage devices which face each other.

The packaging film 10 for electrical storage devices according to the third aspect may include only the heat-sealable resin layer 1 as shown in FIG. 1. When the packaging film 10 for electrical storage devices includes only the heat-sealable resin layer 1, it is preferable that at least one surface of the heat-sealable resin layer 1 is bondable to metal.

In addition, it is preferable that the packaging film 10 for electrical storage devices according to the third aspect includes a laminate including at least a resin layer 2 and the heat-sealable resin layer 1 as shown in FIGS. 2 to 4. In such a packaging film 10 for electrical storage devices, the resin layer 2 is on the outer side, and the heat-sealable resin layer 1 is on the inner side (innermost layer). When the packaging film 10 for electrical storage devices includes a laminate including the resin layer 2 and the heat-sealable resin layer 1, it is preferable that bondability to metal is imparted to at least one of an outer surface of the resin layer 2 and an inner surface of the heat-sealable resin layer 1, and it is more preferable that bondability to metal is imparted to an inner surface of the heat-sealable resin layer 1 which faces the metal terminal 130.

Further, it is preferable that the packaging film 10 for electrical storage devices according to the third aspect includes a laminate including at least the resin layer 2, a base material 3 and the heat-sealable resin layer 1 as shown in FIGS. 3 and 4. In such a packaging film 10 for electrical storage devices, the resin layer 2 is on the outer side, the heat-sealable resin layer 1 is on the inner side (innermost layer), and the base material 3 is located between the resin layer 2 and the heat-sealable resin layer 1. Even when the packaging film 10 for electrical storage devices includes a laminate including the resin layer 2, the base material 3 and the heat-sealable resin layer 1, it is preferable that bondability to metal is imparted to at least one of an outer surface of the resin layer 2 and an inner surface of the heat-sealable resin layer 1, and it is more preferable that bondability to metal is imparted to an inner surface of the heat-sealable resin layer 1 which faces the metal terminal 130.

It is possible to provide the adhesive agent layer 4 between the resin layer 2 and the heat-sealable resin layer 1 as shown in FIG. 2, and the adhesive agent layer 5 between the heat-sealable resin layer 1 and the base material 3 as shown in FIG. 4.

In the packaging film 10 for electrical storage devices according to the third aspect of the present disclosure, a CO₂ transmission rate in an environment at a temperature of 30° C. is preferably 100 cc·100 μm/m²/24 hr/atm or more, more preferably about 200 cc·100 μm/m²/24 hr/atm or more, still more preferably about 300 cc·100 μm/m²/24 hr/atm or more, even more preferably about 500 cc·100 μm/m²/24 hr/atm or more. The CO₂ transmission rate of the packaging film 10 for electrical storage devices according to the third aspect is, for example, about 2,000 cc·100 μm/m²/24 hr/atm or less, preferably about 1000 cc·100 μm/m²/24 hr/atm or less, more preferably about 800 cc·100 μm/m²/24 hr/atm or less, and preferably in the range of about 100 to 2,000 cc·100 μm/m²/24 hr/atm, about 100 to 1,000 cc·100 μm/m²/24 hr/atm, about 100 to 800 cc·100 μm/m²/24 hr/atm, about 200 to 2,000 cc·100 μm/m²/24 hr/atm, about 200 to 1,000 cc·100 μm/m²/24 hr/atm, about 200 to 800 cc·100 μm/m²/24 hr/atm, about 300 to 2,000 cc·100 μm/m²/24 hr/atm, about 300 to 1,000 cc·100 μm/m²/24 hr/atm, about 300 to 800 cc·100 μm/m²/24 hr/atm, about 500 to 2,000 cc·100 μm/m²/24 hr/atm, about 500 to 1,000 cc·100 μm/m²/24 hr/atm, or 500 to 800 cc·100 μm/m²/24 hr/atm. The method for measuring the CO₂ transmission rate of the packaging film for electrical storage devices is as follows.

### [Measurement of CO₂ Transmission Rate]

CO₂ passing through a φ60 mm part of the packaging film 10 for electrical storage devices is quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate.

A surface coating layer or the like may be further provided on the outside of the resin layer 2 (on a side opposite to the heat-sealable resin layer 1 side) if necessary (not shown).

The thickness of the laminate forming the packaging film 10 for electrical storage devices according to the third aspect is not particularly limited, and is, for example, 190 μm or less, preferably about 180 μm or less, or about 170 μm or less, from the viewpoint of cost reduction, energy density improvement, and the like. The thickness of the laminate forming the packaging film 10 for electrical storage devices is preferably about 35 μm or more, about 45 μm or more, or about 60 μm or more, from the viewpoint of maintaining the function of a packaging film for electrical storage devices to protect of an electrical storage device element. The laminate forming the packaging film 10 for electrical storage devices is preferably in the range of, for example, about 35 to 190 μm, about 35 to 180 μm, about 35 to 170 μm, about 45 to 190 μm, about 45 to 180 μm, about 45 to 170 μm, about 60 to 190 μm, about 60 to 180 μm, and about 60 to 170 μm, particularly preferably about 45 to 170 μm.

In the packaging film 10 for electrical storage devices according to the third aspect, the ratio of the total thickness of the resin layer 2, the adhesive agent layer 4, the base material 3, the adhesive agent layer 5 and the heat-sealable resin layer 1 to the thickness (total thickness) of the laminate forming the packaging film 10 for electrical storage devices is preferably 90% or more, more preferably 95% or more, still more preferably 98% or more. As a specific example, when the packaging film 10 for electrical storage devices according to the third aspect includes the resin layer 2, the adhesive agent layer 4, the base material 3, the adhesive agent layer 5 and the heat-sealable resin layer 1, the ratio of the total thickness of these layers to the thickness (total thickness) of the laminate forming the packaging film 10 for electrical storage devices is preferably 90% or more, more preferably 95% or more, still more preferably 98% or more. In addition, when the packaging film 10 for electrical storage devices according to the third aspect is a laminate including the resin layer 2, the adhesive agent layer 4 and the heat-sealable resin layer 1, the ratio of the total thickness of these layers to the thickness (total thickness) of the laminate forming the packaging film 10 for electrical storage devices may be, for example, 80% or more, preferably 90% or more, more preferably 95% or more, still more preferably 98% or more.

The laminate forming the packaging film 10 for electrical storage devices according to the third aspect can have a total light transmittance of, for example, 80% or more, 85% or more, or 90% or more as measured in accordance with the provisions of JIS K7361-1: 1997. The shielding property that can be exhibited by the packaging film 10 for electrical storage devices is enhanced as the total light transmittance decreases. On the other hand, the light permeability that can be exhibited by the packaging film 10 for electrical storage devices is enhanced as the total light transmittance increases. Therefore, by setting the lower limit of the total light transmittance to a certain level, desired transparency can be maintained. The lower limit value of the total light transmittance is 0%, and the upper limit of the total light transmittance is 100%. For the total light transmittance of the packaging film for electrical storage devices, the transmittance in a visible light region (400 to 700 nm) is measured with a commercially available spectrophotometer (for example, Ultraviolet-Visible-Near Infrared Spectrophotometer V-670 manufactured by JASCO Corporation) by a measurement method specified in JIS K7361-1: 1997, and the average value thereof is taken as a total light transmittance. For measurement conditions, a halogen lamp is used as a light source, the UV/Vis bandwidth is 5.0 nm, the scanning rate is 1,000 nm/min, the response is set to Medium, and the data capture interval is 1.0 nm.

The packaging film 10 for electrical storage devices according to the third aspect can be colored black to become black-colored and transparent. When the packaging film 10 for electrical storage devices is colored black, the packaging film 10 for electrical storage devices is highly discriminable due to exhibition of a characteristic color, and has high designability. In addition, in a manufacturing process of the electrical storage device, it is possible to identify a location by a sensor with higher accuracy, and it is possible to more accurately convey the packaging film 10 for electrical storage devices and seal the electrical storage device element, and the like. Further, the electrical storage device and other electrical components can be all colored black to impart a high-grade feeling as a product.

### <Layers Forming Packaging Film for Electrical Storage Devices According to Third Aspect>

The layers forming the packaging film for electrical storage devices according to the third aspect are the same as those of the packaging film for electrical storage devices according to the first aspect and the packaging film for electrical storage devices according to the second aspect, and therefore are not described.

### [Method for Manufacturing Packaging Film for Electrical Storage Devices According to Third Aspect]

The method for manufacturing a packaging film for electrical storage devices according to the third aspect is not particularly limited as long as a packaging film for electrical storage devices according to the third aspect is obtained. For example, when the packaging film for electrical storage devices according to the third aspect includes the resin layer 2 and the heat-sealable resin layer 1, it is preferable that the method includes a step of preparing a laminate in which at least a resin layer and a heat-sealable resin layer are laminated in this order from the outside, and the laminate has a CO₂ transmission rate of 100 cc·100 μm/m²/24 hr/atm or more in an environment at a temperature of 30° C.

An example of the manufacturing method when the packaging film for electrical storage devices according to the third aspect includes a laminate including the resin layer 2, the adhesive agent layer 4, the base material 3, the adhesive agent layer 5 and the heat-sealable resin layer 1 in this order is as follows. First, materials for forming the layers are provided. Subsequently, the resin layer 2 and the base material 3 are laminated with the adhesive agent layer 4 interposed therebetween, and the base material 3 and the heat-sealable resin layer 1 are laminated with the adhesive agent layer 5 interposed therebetween. Specifically, using an adhesive for forming the adhesive agent layer 4, the resin layer 2 and the base material 3 are laminated by a dry lamination method or the like to laminate the resin layer 2, the adhesive agent layer 4 and the base material 3, and further, using an adhesive for forming the adhesive agent layer 5, the base material 3 and the heat-sealable resin layer 1 are laminated by a dry lamination method or the like to manufacture the packaging film 10 for electrical storage devices. When the resin layer 2, the base material 3 and the heat-sealable resin layer 1 are laminated without the adhesive agent layers 4 and 5, the packaging film 10 for electrical storage devices can be manufactured by, for example, a method in which a resin for forming the resin layer 2 is melted and extruded to one side of the base material 3, and a resin for forming the heat-sealable resin layer 1 is melted and extruded to the other side of the base material 3. When the colored layer is provided, the colored layer may be formed on the surface of the resin layer 2, and then laminated to the base material 3 and the heat-sealable resin layer 1. When a surface coating layer is provided, for example, the resin composition for forming the surface coating layer is applied to the surface of the resin layer 2, and cured to form the surface coating layer.

The packaging film 10 for electrical storage devices may be further subjected to heat treatment for enhancing the bondability of the adhesive agent layers 4 and 5.

The shape of the inner packaging 210 in the third aspect is not particularly limited, and can be, for example, a bag shape (pouch shape). The bag shape mentioned here may be of three-way seal type, four-way seal type, pillow type, gusset type or the like. The inner packaging 210 in Embodiment 1 is manufactured by heat-sealing the packaging film 212 for electrical storage devices which has a shape shown in FIG. 2 and is molded in a tray shape and the packaging film 211 for electrical storage devices which is also molded in a tray shape and is superposed on the packaging film 212 for electrical storage devices, along an outer peripheral portion in plan view. The packaging film 212 for electrical storage devices includes an angular ring-shaped flange portion 212A corresponding to the outer peripheral portion in plan view, and a molded part 212B which is continuous with the inner edge of the flange portion 212A and extends downward therefrom. Similarly, the packaging film 211 for electrical storage devices includes an angular ring-shaped flange portion 211A corresponding to the outer peripheral portion in plan view, and a part 211B which is continuous with the inner edge of the flange portion 211A and extends upward therefrom. The packaging films 211 and 212 for electrical storage devices are superposed such that the molded parts 211B and 212B extend in opposite directions. In this state, the flange portion 211A of the packaging film 211 for electrical storage devices and the flange portion 212A of the packaging film 212 for electrical storage devices are heat-sealed so as to be integrated with each other, resulting in formation of a part of the peripheral edge seal portion 150. One of the packaging films 211 and 212 for electrical storage devices may have a sheet shape.

The exterior films 221 and 222 for forming the outer packaging 220 in the third aspect are formed from, for example, a resin molded article or film. The resin molded article mentioned here can be manufactured by a method such as injection molding, compressed-air molding, vacuum molding or blow molding, where in-mold molding may be performed for imparting a design property, and functionality. The type of the resin may be polyolefin, polyester, nylon, ABS, or the like. The film mentioned here is, for example, a resin film that can be manufactured by a method such as an inflation method or a T-die method, or a film obtained by laminating such a resin film on a metal foil or a metal sheet. The film mentioned here may be a stretched film, and may be a single layer film or multiple layer film. The multiple layer film mentioned here may be manufactured by a coating method, may be obtained by bonding a plurality of films with an adhesive or the like, or may be manufactured by a multilayer extrusion method.

The exterior films 221 and 222 in the third aspect can be formed in various ways as described above, and include a laminate film in Embodiment 1. The laminate film can be a laminate obtained by laminating a base material layer, a barrier layer and a heat-sealable resin layer. The base material layer functions as a base material of the exterior films 221 and 222, and is typically a resin layer forming an outer layer of the outer packaging 220 and having insulation quality. The barrier layer has functions of improving the strength of the exterior films 221 and 222 and preventing at least ingress of moisture, among others, into the electrical storage device 100. The barrier layer is typically a metal layer made of an aluminum alloy foil or the like. The heat-sealable resin layer is typically made of a heat-sealable resin such as polyolefin, and forms the innermost layer of the outer packaging 220.

The shape of the outer packaging 220 in the third aspect is not particularly limited, and can be, for example, a bag shape (pouch shape). The bag shape mentioned here may be of three-way seal type, four-way seal type, pillow type, gusset type or the like. However, the case 110A according to Embodiment 1 has a shape as in FIG. 2, and is manufactured by heat-sealing the exterior film 222 molded in a tray shape and the exterior film 221 also molded in a tray shape and superposed on the exterior film 222, along the outer peripheral portion in plan view. The exterior film 222 includes an angular ring-shaped flange portion 222A corresponding to an outer peripheral portion in plan view, and a molded part 222B which is continuous with the inner edge of the flange portion 222A and extends downward therefrom. Similarly, the exterior film 221 includes an angular ring-shaped flange portion 221A corresponding to the outer peripheral portion in plan view, and a part 221B which is continuous with the inner edge of the flange portion 221A and extends upward therefrom. The exterior films 221 and 222 are superposed such that the molded parts 221B and 222B extend in opposite directions. In this state, the flange portion 221A of the exterior film 221 and the flange portion 222A of the exterior film 222 are heat-sealed so as to be integrated with each other, resulting in formation of a part of the peripheral edge seal portion 150. One of the exterior films 221 and 222 may have a sheet shape.

As shown in FIG. 2, in the terminal seal portion 151A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 in the third aspect is joined to the flange portion 211A of the packaging film 211 for electrical storage devices. The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 222A of the exterior film 222 in the third aspect is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

The electrical storage device element 120 according to the third aspect includes at least a positive electrode, a negative electrode and an electrolyte, and is, for example, a power storage member of a lithium ion battery (secondary battery), a capacitor, or the like.

The metal terminal 130 is a metal terminal used for inputting and outputting electric power to and from the electrical storage device element 120. The metal terminals 130 are disposed on the top seal portion 151 of the case 110A, with one metal terminal forming a terminal on the positive electrode side and the other forming a terminal on the negative electrode side. One end part of each metal terminal 130 in the horizontal direction is electrically connected to an electrode (positive electrode or negative electrode) of the electrical storage device element 120 in the internal space S1 of the case 110A, and the other end part protrudes outward from the peripheral edge seal portion 150. The above form of the electrical storage device 100 is particularly preferable uses in, for example, an electrically driven vehicle such as an electric vehicle or a hybrid vehicle in which a large number of electrical storage devices 100 are connected in series and used at a high voltage. The locations of attachment of the two metal terminals 130 forming the terminals of the positive electrode and the negative electrode are not particularly limited, and for example, the metal terminals 130 may be disposed on the side seal portions 152 and 153 or the bottom seal portion 154 of the peripheral edge seal portion 150.

The metal material forming the metal terminal 130 is, for example, aluminum, nickel, or copper. When the electrical storage device element 120 is a lithium ion battery, the metal terminal 130 connected to the positive electrode is typically made of aluminum or the like, and the metal terminal 130 connected to the negative electrode is typically made of copper, nickel or the like.

The tab film 140 is a so-called adhesive film, and is configured to be bonded to both the packaging films 211 and 212 for electrical storage devices and the metal terminal 130. By interposing the tab film 140, the metal terminal 130 and the innermost layer (heat-sealable resin layer) of the packaging films 211 and 212 for electrical storage devices can be fixed even if the former and the latter are made of different materials. The tab film 140 is sealed and fixed to the metal terminal 130 to integrate the tab film and the metal terminal in advance, and the packaging films 211 and 212 for electrical storage devices are sealed to the metal terminal 130 to which the tab film 140 is fixed.

### [Method for Manufacturing Electrical Storage Device According to Third Aspect]

FIG. 10 is a flowchart showing an example of a method for manufacturing the electrical storage device 100. The method for manufacturing the electrical storage device 100 includes a plurality of steps.

In inner side packaging step S11, the electrical storage device element 120 is wrapped by the molded packaging films 211 and 212 for electrical storage devices as shown in FIG. 11. In the electrical storage device 100 according to the present Embodiment 1, formation of an auxiliary chamber for temporarily storing gas generated from the electrical storage device element 120 in the later-described initial filling step and the like is not necessary because the packaging films 211 and 212 for electrical storage devices have gas permeability. Therefore, in the inner side packaging step, the electrical storage device element 120 is wrapped by packaging films 211 and 212 for electrical storage devices, which are substantially identical in size to packaging films 211 and 212 for electrical storage devices in the inner packaging 210 of a finished product of the electrical storage device 100. Therefore, the manufacturing process of the electrical storage device 100 can be simplified. In addition, the amount of materials used for the electrical storage device 100 can be reduced. The term “substantially identical in size” includes being larger in size than the packaging films 211 and 212 for electrical storage devices in the inner packaging 210 of a finished product of the electrical storage device 100 to the extent that an auxiliary chamber cannot be formed. The metal terminal 130 is connected to the electrical storage device element 120 in advance, and the tab film 140 is joined to the metal terminal 130.

First inner side sealing step S12 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed as shown in FIG. 12. When the first inner side sealing step is completed, an opening 213 is formed in a portion of the peripheral edge of the packaging films 211 and 212 for electrical storage devices on which the side seal portion 153 is to be formed. Vacuum drying step S13 is carried out after the first inner side sealing step.

Electrolytic solution injection step S14 is carried out after the vacuum drying step. In the electrolytic solution injection step, an electrolytic solution is injected through the opening 213 (see FIG. 12).

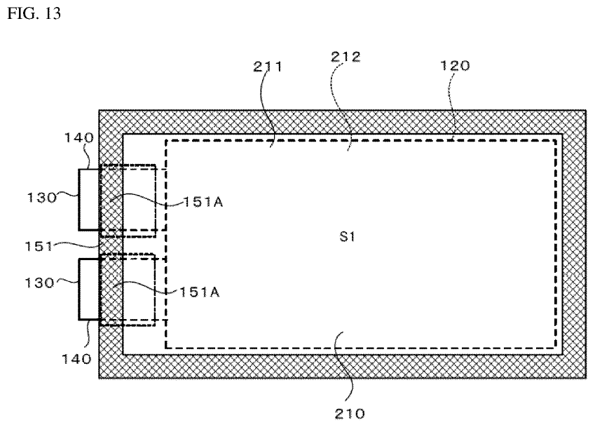

Second inner side sealing step S15 is carried out after the electrolytic solution injection step. In the second inner side sealing step, the opening 213 is closed by sealing a portion of the peripheral edge of the packaging films 211 and 212 for electrical storage devices on which the side seal portion 153 is to be formed as shown in FIG. 13. After the second inner side sealing step, initial charge-discharge step S16 and aging step S17 are performed in this order.

Degassing step S18 is carried out in parallel to the initial charge-discharge step and the aging step. In Embodiment 1, since the packaging films 211 and 212 for electrical storage devices has gas permeability, gas such as carbon dioxide generated from the electrical storage device element 120 is discharged to the outside through the packaging films 211 and 212 for electrical storage devices when the initial charge-discharge step and the aging step are carried out. Primary charge step S19 is carried out after the degassing step.

Outer side packaging step S20 is carried out after the primary charge step. In the outer side packaging step, the inner packaging 210 in which the electrical storage device element 120 is housed is wrapped by the exterior films 221 and 222.

Outer side sealing step S21 is carried out after the outer side packaging step. In the outer side sealing step, the peripheral edges of the exterior films 221 and 222 are sealed to form the peripheral edge seal portion 150.

### [Characteristics of Electrical Storage Device According to Third Aspect]

In the electrical storage device 100, whether or not the packaging film 211 for electrical storage devices and the packaging film 212 for electrical storage devices are appropriately sealed can be easily confirmed after completion of the first inner side sealing step or the second inner side sealing step because the packaging films 211 and 212 for electrical storage devices are transparent. Therefore, the electrical storage device 100 can be suitably manufactured. The state in which the packaging film 211 for electrical storage devices and the packaging film 212 for electrical storage devices are not appropriately sealed includes, for example, a first state, a second state or a third state. The first state is a state in which the packaging film 211 for electrical storage devices and the packaging film 212 for electrical storage devices are sealed with contaminants caught therebetween. The second state is a state in which a part of a portion to be sealed is not sealed. The third state is a state in which a portion that should not be sealed is sealed.

### Embodiment 2 of Third Aspect

An electrical storage device 100 according to Embodiment 2 has the same configuration as in Embodiment 1 except that the packaging films 211 and 212 for electrical storage devices do not have gas permeability, or do not have such high gas permeability that the degassing step S18 is carried out as in Embodiment 1. Hereinafter, the electrical storage device 100 according to Embodiment 2 will be described mainly for portions different from those in Embodiment 2.

### [Method for Manufacturing Electrical Storage Device]

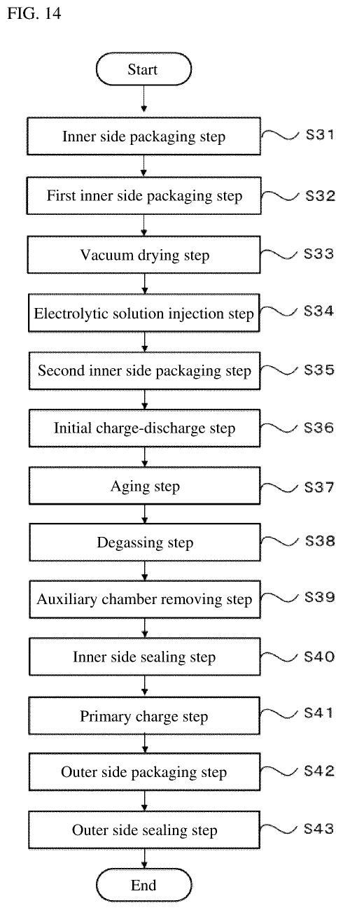

FIG. 14 is a flowchart showing an example of a method for manufacturing the electrical storage device 100 according to Embodiment 2. The method for manufacturing the electrical storage device 100 includes a plurality of steps.

In inner side packaging step S31, the electrical storage device element 120 is wrapped by the molded packaging films 211 and 212 for electrical storage devices as shown in FIG. 15. In the electrical storage device 100 according to the present Embodiment 2, formation of the auxiliary chamber 214 for temporarily storing gas generated from the electrical storage device element 120 in the initial filling step and the like is preferable because the packaging films 211 and 212 for electrical storage devices do not have gas permeability. Therefore, in the inner side packaging step, the electrical storage device element 120 is wrapped by packaging films 211 and 212 for electrical storage devices, which are larger in size than packaging films 211 and 212 for electrical storage devices in the inner packaging 210 of a finished product of the electrical storage device 100. In the auxiliary chamber 214 of the packaging films 211 and 212 for electrical storage devices, a housing chamber 215 for storing a larger amount of gas generated from the electrical storage device element 120 is formed.

First inner side sealing step S32 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed so as to extend to the auxiliary chamber 214 as shown in FIG. 16. When the first inner side sealing step is completed, an opening 213 is formed in a portion 216 of the peripheral edge of the packaging films 211 and 212 for electrical storage devices which faces a portion on which the side seal portion 153 is to be formed, with the auxiliary chamber 214 being interposed between the former and latter portions. Vacuum drying step S33 is carried out after the first inner side sealing step.

Electrolytic solution injection step S34 is carried out after the vacuum drying step. In the electrolytic solution injection step, an electrolytic solution is injected through the opening 213 (see FIG. 16).

Second inner side sealing step S35 is carried out after the electrolytic solution injection step. In the second inner side sealing step, as shown in FIG. 17, the opening 213 is closed by sealing a portion 216 of the peripheral edge of the packaging films 211 and 212 for electrical storage devices which faces a portion on which the side seal portion 153 is to be formed, with the auxiliary chamber 214 being interposed between the former and latter portions. After the second inner side sealing step, initial charge-discharge step S36 and aging step S37 are performed in this order.

Degassing step S38 is carried out after the aging step. In the degassing step, gas such as carbon dioxide generated from the electrical storage device element 120 is temporarily stored in the auxiliary chamber 214 of the packaging films 211 and 212 for electrical storage devices.

Auxiliary chamber removing step S39 is carried out after the degassing step. In the auxiliary chamber removing step, the auxiliary chamber 214 is removed by cutting the packaging films 211 and 212 for electrical storage devices along the one dot chain line XA shown in FIG. 17 such that the film is identical in size to the inner packaging 210 of a finished product of the electrical storage device 100.

Inner side sealing step S40 is carried out after the auxiliary chamber removing step. In the inner side sealing step, a portion of the peripheral edge of the packaging films 211 and 212 for electrical storage devices which corresponds to the side seal portion 153 is sealed as shown in FIG. 18. Primary charge step S41 is carried out after the inner side sealing step.

Outer side packaging step S42 is carried out after the primary charge step. In the outer side packaging step, the inner packaging 210 in which the electrical storage device element 120 is housed is wrapped by the exterior films 221 and 222.

Outer side sealing step S43 is carried out after the outer side packaging step. In the outer side sealing step, the peripheral edges of the exterior films 221 and 222 are sealed to form the peripheral edge seal portion 150.

### [Characteristics of Electrical Storage Device]

The electrical storage device 100 according to Embodiment 3 has the same effect as the electrical storage device 100 according to Embodiment 1 because the packaging films 211 and 212 for electrical storage devices are transparent.

### Embodiment 3 of Third Aspect

An electrical storage device 300 according to Embodiment 3 has the same configuration as in Embodiment 1 except that the configuration of the terminal seal portion 151A is different from that in Embodiment 1. Hereinafter, the electrical storage device 300 according to Embodiment 3 will be described mainly for portions different from those in Embodiment 1.

FIG. 19 is a sectional view of a terminal seal portion 351A of the electrical storage device 300 according to Embodiment 3. In the terminal seal portion 351A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to one tab film 140. The flange portion 222A of the exterior film 222 is joined to the other tab film 140. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 300, ingress of moisture and the like into the internal space S1 of the inner packaging 210 from the outside is suppressed because the inner packaging 210 is covered with the outer packaging 220.

### Embodiment 4 of Third Aspect

An electrical storage device 400 according to Embodiment 4 has the same configuration as in Embodiment 1 except that the configuration of the terminal seal portion 151A is different from that in Embodiment 1. Hereinafter, the electrical storage device 400 according to Embodiment 4 will be described mainly for portions different from those in Embodiment 1.

FIG. 20 is a sectional view of a terminal seal portion 451A of the electrical storage device 400 according to Embodiment 4. The electrical storage device 400 does not include the tab film 140. In a terminal seal portion 451A of the electrical storage device 400, the exterior film 221, the packaging film 211 for electrical storage devices, the metal terminal 130, the packaging film 212 for electrical storage devices, and the exterior film 222 are laminated in this order from the top, and integrated.

The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 221A of the exterior film 221 is joined to the flange portion 211A of the packaging film 211 for electrical storage devices. The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

### [Characteristics of Electrical Storage Device]

In the electrical storage device 400, the number of members is small because the packaging films 211 and 212 for electrical storage devices and the metal terminal 130 are joined without interposing the tab film 140 therebetween. In addition, the method for manufacturing the electrical storage device 400 can be simplified.

### Embodiment 5 of Third Aspect

An electrical storage device 500 according to Embodiment 5 has the same configuration as in Embodiment 4 except that the configuration of the terminal seal portion 451A is different from that in Embodiment 4. Hereinafter, the electrical storage device 500 according to Embodiment 5 will be described mainly for portions different from those in Embodiment 4.

FIG. 21 is a sectional view of a terminal seal portion 551A of the electrical storage device 500 according to Embodiment 5. In the terminal seal portion 551A, a part of the flange portion 211A of the packaging film 211 for electrical storage devices is joined to the metal terminal 130. A part of the flange portion 212A of the packaging film 212 for electrical storage devices is joined to the metal terminal 130.

The flange portion 221A of the exterior film 221 is joined to the metal terminal 130. The flange portion 222A of the exterior film 222 is joined to the metal terminal 130. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 500, ingress of moisture and the like into the internal space S1 of the inner packaging 210 from the outside is suppressed because the inner packaging 210 is covered with the outer packaging 220. In the electrical storage device 500, the number of members is small because the packaging films 211 and 212 for electrical storage devices and the metal terminal 130 are joined without interposing the tab film 140 therebetween. In addition, the method for manufacturing the electrical storage device 500 can be simplified.

### Modifications of Third Aspect

The embodiments of the third aspect are examples of possible forms of an electrical storage device and a method for manufacturing an electrical storage device according to the present disclosure, and are not intended to limit the forms thereof. The electrical storage device and the method for manufacturing an electrical storage device according to the present disclosure may have a form different from that exemplified in the embodiments. An example thereof is a form in which a part of the configuration of the embodiments is replaced, changed or omitted, or a form in which a new configuration is added to the embodiments. Some examples of modifications of the embodiments will be described below. The following modifications can be combined as long as there is no technical contradiction.

In the electrical storage device 100 according to Embodiment 1 of the third aspect, one outer packaging 220 may be configured to house a plurality of inner packagings 210 in which the electrical storage device element 120 is housed. In this modification, the sizes of a plurality of inner packagings 210 may be different or the same. According to this modification, the voltage can be easily adjusted because a plurality of electrical storage device elements 120 can be connected in series or in parallel.

In the electrical storage device 100 according to Embodiment 1 of the third aspect, the packaging films 211 and 212 for electrical storage devices are not required to have gas permeability. The packaging films 211 and 212 for electrical storage devices are only required to have at least transparency.

In the electrical storage device 100 according to Embodiment 1 of the third aspect, the inner packaging 210 may be formed by folding one packaging film 211 for electrical storage devices, and heat-sealing the peripheral edge portion. Similarly, the outer packaging 220 may be formed by folding one exterior film 221, and heat-sealing the peripheral edge portion.

### Fourth Aspect

### Embodiment 1

FIG. 8 shows a plan view of an electrical storage device 100 according to Embodiment 1 of the fourth aspect. FIG. 9 is a sectional view taken along line D2-D2 in FIG. 8. In FIG. 8, portions that are normally invisible from the outside are partially indicated by dotted lines for reference. Hereinafter, unless otherwise specified, the vertical direction and the horizontal direction in FIG. 8 are referred to as a “longitudinal direction” and a “horizontal direction”, respectively, and the vertical direction in FIG. 9 is referred to as a “vertical direction”, for convenience of explanation. However, the direction of the electrical storage device 100 during use is not limited thereto. In FIG. 8, for simplification of the drawing, the relative positional relationship between an inner packaging 210 and an outer packaging 220 is simplified.

The electrical storage device 100 according to the fourth aspect includes a housing 110, an electrical storage device element 120, a pair of metal terminals 130, and a pair of tab films 140. The housing 110 includes an internal space S1 and a peripheral edge seal portion 150. The electrical storage device element 120 is housed in the internal space S1 of the housing 110. One end of the metal terminal 130 is joined to the electrical storage device element 120, and the other end protrudes outward from the peripheral edge seal portion 150 of the housing 110. A part of the metal terminal 130 between one end and the other end thereof is sealed to the peripheral edge seal portion 150 with the tab film 140 interposed therebetween.

The housing 110 includes a case 110A. The case 110A includes an inner packaging 210 and an outer packaging 220. The inner packaging 210 houses the electrical storage device element 120. The outer packaging 220 houses the inner packaging 210 in which the electrical storage device element 120 is housed. The internal space S1 is formed inside the inner packaging 210. The inner packaging 210 includes packaging films 211 and 212 for electrical storage devices. The outer packaging 220 includes exterior films 221 and 222. At the outer peripheral portion of the case 110A in plan view, the inner packaging 210 and the outer packaging 220 are sealed to each other by heat sealing to form the peripheral edge seal portion 150. An internal space S1 of the case 110A, which is cut off from the external space, is formed in the inner packaging 210 by the peripheral edge seal portion 150. The peripheral edge seal portion 150 defines a peripheral edge of the internal space S1 of the case 110A. The form of the heat sealing mentioned here is assumed to be sealing by heating from a heat source, ultrasonic sealing or the like. In any case, the peripheral edge seal portion 150 means a portion in which the inner packaging 210 and the outer packaging 220 are sealed to each other to be integrated.

The peripheral edge seal portion 150 includes a top seal portion 151, a pair of side seal portions 152 and 153, and a bottom seal portion 154. The top seal portion 151 includes a portion that is sealed while sandwiching the metal terminal 130 and the tab film 140 (hereinafter, referred to as a “terminal seal portion 151A”, and extends in the longitudinal direction. The pair of side seal portions 152 and 153 extend in the horizontal direction. The side seal portion 152 and the side seal portion 153 face each other with the internal space S1 therebetween. The bottom seal portion 154 faces the top seal portion 151 with the internal space S1 therebetween. The bottom seal portion 154 extends in the longitudinal direction.

As shown in FIG. 9, in the terminal seal portion 151A of the top seal portion 151, an exterior film 221, a packaging film 211 for electrical storage devices, one tab film 140, a metal terminal 130, the other tab film 140, a packaging film 212 for electrical storage devices, and an exterior film 222 are laminated in this order from the top, and integrated. Therefore, the top seal portion 151 can be easily formed. In a portion of the top seal portion 151 other than the terminal seal portion 151A, in other words, a portion in which only the pair of tab films 140 are sandwiched by the inner packaging 210 and the outer packaging 220, the exterior film 221, the packaging film 211 for electrical storage devices, one tab film 140, the other tab film 140, the packaging film 212 for electrical storage devices, and the exterior film 222 are laminated in this order from the top, and integrated. Further, in a portion of the top seal portion 151 which is outside the terminal seal portion 151A (a portion on the left of the level difference forming a boundary in FIG. 9), the packaging film 211 for electrical storage devices, one tab film 140, the metal terminal 130, the other tab film 140 and the packaging film 212 for electrical storage devices are laminated in this order from the top, and integrated. Thus, there is a level difference between the portion outside the terminal seal portion 151A where the exterior films 221 and 222 do not exist and the portion inside the terminal seal portion 151A where the exterior films 221 and 222 exist (a portion on the right of the level difference forming the boundary in FIG. 9), but FIG. 8 schematically illustrates the region of the peripheral edge seal portion 150, and does not show the level difference forming a boundary.

The packaging films 211 and 212 for electrical storage devices which form the inner packaging 210 have gas permeability from the viewpoint of easily manufacturing the electrical storage device 100. Hereinafter, a preferred example of the packaging films 211 and 212 for electrical storage devices which form the inner packaging 210 will be described. Hereinafter, the packaging films 211 and 212 for electrical storage devices may be collectively referred to as the packaging film 10 for electrical storage devices when the packaging films 211 and 212 for electrical storage devices are not distinguished.

### [Laminated Structure and Physical Properties of Packaging Film for Electrical Storage Devices According to Fourth Aspect]

As shown in, for example, FIGS. 1 to 4, a packaging film 10 for electrical storage devices according to the fourth aspect includes at least a heat-sealable resin layer 1. In construction of an electrical storage device using the packaging film 10 for electrical storage devices and an electrical storage device element, the electrical storage device element is put in a space formed by heat-sealing the peripheral portions of heat-sealable resin layers 1 of the packaging film 10 for electrical storage devices which face each other.

The packaging film 10 for electrical storage devices according to the fourth aspect may include only the heat-sealable resin layer 1 as shown in FIG. 1. When the packaging film 10 for electrical storage devices includes only the heat-sealable resin layer 1, it is preferable that at least one surface of the heat-sealable resin layer 1 is bondable to metal, and it is more preferable that bondability to metal is imparted to an inner surface of the heat-sealable resin layer 1 which faces the metal terminal 130.

In addition, it is preferable that the packaging film 10 for electrical storage devices according to the fourth aspect includes a laminate including at least a resin layer 2 and the heat-sealable resin layer 1 as shown in FIGS. 2 to 4. In such a packaging film 10 for electrical storage devices, the resin layer 2 is on the outer side, and the heat-sealable resin layer 1 is on the inner side (innermost layer). When the packaging film 10 for electrical storage devices includes a laminate including the resin layer 2 and the heat-sealable resin layer 1, it is preferable that bondability to metal is imparted to at least one of an outer surface of the resin layer 2 and an inner surface of the heat-sealable resin layer 1, and it is more preferable that bondability to metal is imparted to an inner surface of the heat-sealable resin layer 1 which faces the metal terminal 130.

Further, it is preferable that the packaging film 10 for electrical storage devices according to the fourth aspect includes a laminate including at least the resin layer 2, a base material 3 and the heat-sealable resin layer 1 as shown in FIGS. 3 and 4. In such a packaging film 10 for electrical storage devices, the resin layer 2 is on the outer side, the heat-sealable resin layer 1 is on the inner side (innermost layer), and the base material 3 is located between the resin layer 2 and the heat-sealable resin layer 1. Even when the packaging film 10 for electrical storage devices includes a laminate including the resin layer 2, the base material 3 and the heat-sealable resin layer 1, it is preferable that bondability to metal is imparted to at least one of an outer surface of the resin layer 2 and an inner surface of the heat-sealable resin layer 1.

It is possible to provide the adhesive agent layer 4 between the resin layer 2 and the heat-sealable resin layer 1 as shown in FIG. 2, and the adhesive agent layer 5 between the heat-sealable resin layer 1 and the base material 3 as shown in FIG. 4.

In the packaging film 10 for electrical storage devices according to the fourth aspect of the present disclosure, a CO₂ transmission rate in an environment at a temperature of 30° C. is preferably 100 cc·100 μm/m²/24 hr/atm or more, more preferably about 200 cc·100 μm/m²/24 hr/atm or more, still more preferably about 300 cc·100 μm/m²/24 hr/atm or more, even more preferably about 500 cc·100 μm/m²/24 hr/atm or more. The CO₂ transmission rate of the packaging film 10 for electrical storage devices according to the fourth aspect is, for example, about 2,000 cc·100 μm/m²/24 hr/atm or less, preferably about 1000 cc·100 μm/m²/24 hr/atm or less, more preferably about 800 cc·100 μm/m²/24 hr/atm or less, and preferably in the range of about 100 to 2,000 cc·100 μm/m²/24 hr/atm, about 100 to 1,000 cc·100 μm/m²/24 hr/atm, about 100 to 800 cc·100 μm/m²/24 hr/atm, about 200 to 2,000 cc·100 μm/m²/24 hr/atm, about 200 to 1,000 cc·100 μm/m²/24 hr/atm, about 200 to 800 cc·100 μm/m²/24 hr/atm, about 300 to 2,000 cc·100 μm/m²/24 hr/atm, about 300 to 1,000 cc·100 μm/m²/24 hr/atm, about 300 to 800 cc·100 μm/m²/24 hr/atm, about 500 to 2,000 cc·100 μm/m²/24 hr/atm, about 500 to 1,000 cc·100 μm/m²/24 hr/atm, or 500 to 800 cc·100 μm/m²/24 hr/atm. The method for measuring the CO₂ transmission rate of the packaging film for electrical storage devices is as follows.

### [Measurement of CO₂ Transmission Rate]

CO₂ passing through a φ60 mm part of the packaging film 10 for electrical storage devices is quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate.

When a shielding property is imparted to the packaging film 10 for electrical storage devices according to the fourth aspect, it is only required that at least one layer in the packaging film 10 for electrical storage devices be a shielding layer S having a shielding property. For example, FIG. 2 shows a configuration in which the adhesive agent layer 4 bonding the resin layer 2 and the heat-sealable resin layer 1 is the shielding layer S, and FIG. 4 shows a configuration in which an adhesive agent layer 4 bonding the resin layer 2 and the base material 3 is the shielding layer S. In the fourth aspect, any layer in the packaging film 10 for electrical storage devices can be the shielding layer S.

A surface coating layer or the like may be further provided on the outside of the resin layer 2 (on a side opposite to the heat-sealable resin layer 1 side) if necessary (not shown).

The thickness of the laminate forming the packaging film 10 for electrical storage devices according to the fourth aspect is not particularly limited, and is, for example, 190 μm or less, preferably about 180 μm or less, or about 170 μm or less, from the viewpoint of cost reduction, energy density improvement, and the like. The thickness of the laminate forming the packaging film 10 for electrical storage devices is preferably about 35 μm or more, about 45 μm or more, or about 60 μm or more, from the viewpoint of maintaining the function of a packaging film for electrical storage devices to protect of an electrical storage device element. The laminate forming the packaging film 10 for electrical storage devices is preferably in the range of, for example, about 35 to 190 μm, about 35 to 180 μm, about 35 to 170 μm, about 45 to 190 μm, about 45 to 180 μm, about 45 to 170 μm, about 60 to 190 μm, about 60 to 180 μm, and about 60 to 170 μm, particularly preferably about 45 to 170 μm.

In the packaging film 10 for electrical storage devices according to the fourth aspect, the ratio of the total thickness of the resin layer 2, the adhesive agent layer 4, the base material 3, the adhesive agent layer 5 and the heat-sealable resin layer 1 to the thickness (total thickness) of the laminate forming the packaging film 10 for electrical storage devices is preferably 90% or more, more preferably 95% or more, still more preferably 98% or more. As a specific example, when the packaging film 10 for electrical storage devices according to the fourth aspect includes the resin layer 2, the adhesive agent layer 4, the base material 3, the adhesive agent layer 5 and the heat-sealable resin layer 1, the ratio of the total thickness of these layers to the thickness (total thickness) of the laminate forming the packaging film 10 for electrical storage devices is preferably 90% or more, more preferably 95% or more, still more preferably 98% or more. In addition, when the packaging film 10 for electrical storage devices according to the fourth aspect is a laminate including the resin layer 2, the adhesive agent layer 4 and the heat-sealable resin layer 1, the ratio of the total thickness of these layers to the thickness (total thickness) of the laminate forming the packaging film 10 for electrical storage devices may be, for example, 80% or more, preferably 90% or more, more preferably 95% or more, still more preferably 98% or more.

The laminate forming the packaging film 10 for electrical storage devices according to the fourth aspect can have a total light transmittance of, for example, 20% or less, 15% or less, 10% or less, 8% or less as measured in accordance with the provisions of JIS K7361-1: 1997. The laminate forming the packaging film 10 for electrical storage devices according to the fourth aspect can also have a total light transmittance of, for example, 80% or more, 85% or more, or 90% or more as measured in accordance with the provisions of JIS K7361-1: 1997. The shielding property that can be exhibited by the packaging film 10 for electrical storage devices is enhanced as the total light transmittance decreases. On the other hand, the light permeability that can be exhibited by the packaging film 10 for electrical storage devices is enhanced as the total light transmittance increases. The lower limit value of the total light transmittance is 0%, and the upper limit of the total light transmittance is 100%. For the total light transmittance of the packaging film for electrical storage devices, the transmittance in a visible light region (400 to 700 nm) is measured with a commercially available spectrophotometer (for example, Ultraviolet-Visible-Near Infrared Spectrophotometer V-670 manufactured by JASCO Corporation) by a measurement method specified in JIS K7361-1: 1997, and the average value thereof is taken as a total light transmittance. For measurement conditions, a halogen lamp is used as a light source, the UV/Vis bandwidth is 5.0 nm, the scanning rate is 1,000 nm/min, the response is set to Medium, and the data capture interval is 1.0 nm.

The packaging film 10 for electrical storage devices according to the fourth aspect can be colored black. When the packaging film 10 for electrical storage devices is colored black, the packaging film 10 for electrical storage devices has a high shielding property and a high forge-proof effect. In addition, in a manufacturing process of the electrical storage device, it is possible to identify a location by a sensor with higher accuracy, and it is possible to more accurately convey the packaging film 10 for electrical storage devices and seal the electrical storage device element, and the like. Further, the electrical storage device and other electrical components can be all colored black to impart a high-grade feeling as a product.

### <Layers Forming Packaging Film for Electrical Storage Devices According to Fourth Aspect>

The layers forming the packaging film for electrical storage devices according to the fourth aspect are the same as those of the packaging film for electrical storage devices according to the first aspect and the packaging film for electrical storage devices according to the second aspect, and therefore are not described.

### [Method for Manufacturing Packaging Film for Electrical Storage Devices According to Fourth Aspect]

The method for manufacturing a packaging film for electrical storage devices is not particularly limited as long as a packaging film for electrical storage devices according to the fourth aspect is obtained. For example, when the packaging film for electrical storage devices according to the fourth aspect includes the resin layer 2 and the heat-sealable resin layer 1, it is preferable that the method includes a step of preparing a laminate in which at least a resin layer and a heat-sealable resin layer are laminated in this order from the outside, and the laminate has a CO₂ transmission rate of 100 cc·100 μm/m²/24 hr/atm or more in an environment at a temperature of 30° C.

An example of the manufacturing method when the packaging film for electrical storage devices according to the fourth aspect includes a laminate including the resin layer 2, the adhesive agent layer 4, the base material 3, the adhesive agent layer 5 and the heat-sealable resin layer 1 in this order is as follows. First, materials for forming the layers are provided. Subsequently, the resin layer 2 and the base material 3 are laminated with the adhesive agent layer 4 interposed therebetween, and the base material 3 and the heat-sealable resin layer 1 are laminated with the adhesive agent layer 5 interposed therebetween. Specifically, using an adhesive for forming the adhesive agent layer 4, the resin layer 2 and the base material 3 are laminated by a dry lamination method or the like to laminate the resin layer 2, the adhesive agent layer 4 and the base material 3, and further, using an adhesive for forming the adhesive agent layer 5, the base material 3 and the heat-sealable resin layer 1 are laminated by a dry lamination method or the like to manufacture the packaging film 10 for electrical storage devices. When the resin layer 2, the base material 3 and the heat-sealable resin layer 1 are laminated without the adhesive agent layers 4 and 5, the packaging film 10 for electrical storage devices can be manufactured by, for example, a method in which a resin for forming the resin layer 2 is melted and extruded to one side of the base material 3, and a resin for forming the heat-sealable resin layer 1 is melted and extruded to the other side of the base material 3. When the colored layer is provided, the colored layer may be formed on the surface of the resin layer 2, and then laminated to the base material 3 and the heat-sealable resin layer 1. When a surface coating layer is provided, for example, the resin composition for forming the surface coating layer is applied to the surface of the resin layer 2, and cured to form the surface coating layer.

The packaging film 10 for electrical storage devices may be further subjected to heat treatment for enhancing the bondability of the adhesive agent layers 4 and 5.

The shape of the inner packaging 210 is not particularly limited, and can be, for example, a bag shape (pouch shape). The bag shape mentioned here may be of three-way seal type, four-way seal type, pillow type, gusset type or the like. The inner packaging 210 in Embodiment 1 is manufactured by heat-sealing the packaging film 212 for electrical storage devices which has a shape shown in FIG. 9 and is molded in a tray shape and the packaging film 211 for electrical storage devices which is also molded in a tray shape and is superposed on the packaging film 212 for electrical storage devices, along an outer peripheral portion in plan view. The packaging film 212 for electrical storage devices includes an angular ring-shaped flange portion 212A corresponding to the outer peripheral portion in plan view, and a molded part 212B which is continuous with the inner edge of the flange portion 212A and extends downward therefrom. Similarly, the packaging film 211 for electrical storage devices includes an angular ring-shaped flange portion 211A corresponding to the outer peripheral portion in plan view, and a part 211B which is continuous with the inner edge of the flange portion 211A and extends upward therefrom. The packaging films 211 and 212 for electrical storage devices are superposed such that the molded parts 211B and 212B extend in opposite directions. In this state, the flange portion 211A of the packaging film 211 for electrical storage devices and the flange portion 212A of the packaging film 212 for electrical storage devices are heat-sealed so as to be integrated with each other, resulting in formation of a part of the peripheral edge seal portion 150. One of the packaging films 211 and 212 for electrical storage devices may have a sheet shape.

The exterior films 221 and 222 for forming the outer packaging 220 are formed from, for example, a resin molded article or film. The resin molded article mentioned here can be manufactured by a method such as injection molding, compressed-air molding, vacuum molding or blow molding, where in-mold molding may be performed for imparting a design property, and functionality. The type of the resin may be polyolefin, polyester, nylon, ABS, or the like. The film mentioned here is, for example, a resin film that can be manufactured by a method such as an inflation method or a T-die method, or a film obtained by laminating such a resin film on a metal foil or a metal sheet. The film mentioned here may be a stretched film, and may be a single layer film or multiple layer film. The multiple layer film mentioned here may be manufactured by a coating method, may be obtained by bonding a plurality of films with an adhesive or the like, or may be manufactured by a multilayer extrusion method.

The exterior films 221 and 222 can be formed in various ways as described above, and include a laminate film in Embodiment 1. The laminate film can be a laminate obtained by laminating a base material layer, a barrier layer and a heat-sealable resin layer. The base material layer functions as a base material of the exterior films 221 and 222, and is typically a resin layer forming an outer layer of the outer packaging 220 and having insulation quality. The barrier layer has functions of improving the strength of the exterior films 221 and 222 and preventing at least ingress of moisture, among others, into the electrical storage device 100. The barrier layer is typically a metal layer made of an aluminum alloy foil or the like. The heat-sealable resin layer is typically made of a heat-sealable resin such as polyolefin, and forms the innermost layer of the outer packaging 220.

The shape of the outer packaging 220 is not particularly limited, and can be, for example, a bag shape (pouch shape). The bag shape mentioned here may be of three-way seal type, four-way seal type, pillow type, gusset type or the like. However, the case 110A according to Embodiment 1 has a shape as in FIG. 9, and is manufactured by heat-sealing the exterior film 222 molded in a tray shape and the exterior film 221 also molded in a tray shape and superposed on the exterior film 222, along the outer peripheral portion in plan view. The exterior film 222 includes an angular ring-shaped flange portion 222A corresponding to an outer peripheral portion in plan view, and a molded part 222B which is continuous with the inner edge of the flange portion 222A and extends downward therefrom. Similarly, the exterior film 221 includes an angular ring-shaped flange portion 221A corresponding to the outer peripheral portion in plan view, and a part 221B which is continuous with the inner edge of the flange portion 221A and extends upward therefrom. The exterior films 221 and 222 are superposed such that the molded parts 221B and 222B extend in opposite directions. In this state, the flange portion 221A of the exterior film 221 and the flange portion 222A of the exterior film 222 are heat-sealed so as to be integrated with each other, resulting in formation of a part of the peripheral edge seal portion 150. One of the exterior films 221 and 222 may have a sheet shape.

As shown in FIG. 9, in the terminal seal portion 151A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to the flange portion 211A of the packaging film 211 for electrical storage devices. The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

The electrical storage device element 120 includes at least a positive electrode, a negative electrode and an electrolyte, and is, for example, a power storage member of a lithium ion battery (secondary battery), a capacitor, or the like.

The metal terminal 130 is a metal terminal used for inputting and outputting electric power to and from the electrical storage device element 120. The metal terminals 130 are disposed on the top seal portion 151 of the case 110A, with one metal terminal forming a terminal on the positive electrode side and the other forming a terminal on the negative electrode side. One end part of each metal terminal 130 in the horizontal direction is electrically connected to an electrode (positive electrode or negative electrode) of the electrical storage device element 120 in the internal space S1 of the case 110A, and the other end part protrudes outward from the peripheral edge seal portion 150. The above form of the electrical storage device 100 is particularly preferable uses in, for example, an electrically driven vehicle such as an electric vehicle or a hybrid vehicle in which a large number of electrical storage devices 100 are connected in series and used at a high voltage. The locations of attachment of the two metal terminals 130 forming the terminals of the positive electrode and the negative electrode are not particularly limited, and for example, the metal terminals 130 may be disposed on the side seal portions 152 and 153 or the bottom seal portion 154 of the peripheral edge seal portion 150.

The metal material forming the metal terminal 130 is, for example, aluminum, nickel, or copper. When the electrical storage device element 120 is a lithium ion battery, the metal terminal 130 connected to the positive electrode is typically made of aluminum or the like, and the metal terminal 130 connected to the negative electrode is typically made of copper, nickel or the like.

The tab film 140 is a so-called adhesive film, and is configured to be bonded to both the packaging films 211 and 212 for electrical storage devices and the metal terminal 130. By interposing the tab film 140, the metal terminal 130 and the innermost layer (heat-sealable resin layer) of the packaging films 211 and 212 for electrical storage devices can be fixed even if the former and the latter are made of different materials. The tab film 140 is sealed and fixed to the metal terminal 130 to integrate the tab film and the metal terminal in advance, and the packaging films 211 and 212 for electrical storage devices are sealed to the metal terminal 130 to which the tab film 140 is fixed.

### [Method for Manufacturing Electrical Storage Device According to Fourth Aspect]

FIG. 10 is a flowchart showing an example of a method for manufacturing the electrical storage device 100. The method for manufacturing the electrical storage device 100 includes a plurality of steps.

In inner side packaging step S11, the electrical storage device element 120 is wrapped by the molded packaging films 211 and 212 for electrical storage devices as shown in FIG. 11. In the electrical storage device 100 according to the present Embodiment 1, formation of an auxiliary chamber for temporarily storing gas generated from the electrical storage device element 120 in the later-described initial filling step and the like is not necessary because the packaging films 211 and 212 for electrical storage devices have gas permeability. Therefore, in the inner side packaging step, the electrical storage device element 120 is wrapped by packaging films 211 and 212 for electrical storage devices, which are substantially identical in size to packaging films 211 and 212 for electrical storage devices in the inner packaging 210 of a finished product of the electrical storage device 100. Therefore, the manufacturing process of the electrical storage device 100 can be simplified. In addition, the amount of materials used for the electrical storage device 100 can be reduced. The term “substantially identical in size” includes being larger in size than the packaging films 211 and 212 for electrical storage devices in the inner packaging 210 of a finished product of the electrical storage device 100 to the extent that an auxiliary chamber cannot be formed. The metal terminal 130 is connected to the electrical storage device element 120 in advance, and the tab film 140 is joined to the metal terminal 130.

First inner side sealing step S12 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed as shown in FIG. 12. When the first inner side sealing step is completed, an opening 213 is formed in a portion of the peripheral edge of the packaging films 211 and 212 for electrical storage devices on which the side seal portion 153 is to be formed. Vacuum drying step S13 is carried out after the first inner side sealing step.

Electrolytic solution injection step S14 is carried out after the vacuum drying step. In the electrolytic solution injection step, an electrolytic solution is injected through the opening 213 (see FIG. 12).

Second inner side sealing step S15 is carried out after the electrolytic solution injection step. In the second inner side sealing step, the opening 213 is closed by sealing a portion of the peripheral edge of the packaging films 211 and 212 for electrical storage devices on which the side seal portion 153 is to be formed as shown in FIG. 13. In the electrical storage device 100, whether or not the packaging film 211 for electrical storage devices and the packaging film 212 for electrical storage devices are appropriately sealed can be easily confirmed after completion of the first inner side sealing step or the second inner side sealing step because the packaging films 211 and 212 for electrical storage devices are transparent. Therefore, the electrical storage device 100 can be suitably manufactured. The state in which the packaging film 211 for electrical storage devices and the packaging film 212 for electrical storage devices are not appropriately sealed includes, for example, a first state, a second state or a third state. The first state is a state in which the packaging film 211 for electrical storage devices and the packaging film 212 for electrical storage devices are sealed with contaminants caught therebetween. The second state is a state in which a part of a portion to be sealed is not sealed. The third state is a state in which a portion that should not be sealed is sealed. After the second inner side sealing step, initial charge-discharge step S16 and aging step S17 are performed in this order.

Degassing step S18 is carried out in parallel to the initial charge-discharge step and the aging step. In Embodiment 1, since the packaging films 211 and 212 for electrical storage devices has gas permeability, gas such as carbon dioxide generated from the electrical storage device element 120 is discharged to the outside through the packaging films 211 and 212 for electrical storage devices when the initial charge-discharge step and the aging step are carried out. Primary charge step S19 is carried out after the degassing step.

Outer side packaging step S20 is carried out after the primary charge step. In the outer side packaging step, the inner packaging 210 in which the electrical storage device element 120 is housed is wrapped by the exterior films 221 and 222.

Outer side sealing step S21 is carried out after the outer side packaging step. In the outer side sealing step, the peripheral edges of the exterior films 221 and 222 are sealed to form the peripheral edge seal portion 150.

### [Characteristics of Electrical Storage Device]

In the electrical storage device 100 according to the present Embodiment 1, formation of an auxiliary chamber for temporarily storing gas generated from the electrical storage device element 120 in the later-described initial filling step and the like is not necessary because the packaging films 211 and 212 for electrical storage devices have gas permeability. Therefore, the manufacturing process of the electrical storage device 100 can be simplified. In addition, the amount of materials used for the electrical storage device 100 can be reduced.

### Embodiment 2 of Fourth Aspect

An electrical storage device 100 according to Embodiment 2 has the same configuration as in Embodiment 1 except that the packaging films 211 and 212 for electrical storage devices are not transparent. Hereinafter, the electrical storage device 100 according to Embodiment 2 will be described mainly for portions different from those in Embodiment 2.

### [Method for Manufacturing Electrical Storage Device]

FIG. 14 is a flowchart showing an example of a method for manufacturing the electrical storage device 100 according to Embodiment 2. The method for manufacturing the electrical storage device 100 includes a plurality of steps.

In inner side packaging step S31, the electrical storage device element 120 is wrapped by the molded packaging films 211 and 212 for electrical storage devices as shown in FIG. 15. In the electrical storage device 100 according to the present Embodiment 2, an auxiliary chamber 214 for temporarily storing gas generated from the electrical storage device element 120 in the initial filling step and the like. Therefore, in the inner side packaging step, the electrical storage device element 120 is wrapped by packaging films 211 and 212 for electrical storage devices, which are larger in size than packaging films 211 and 212 for electrical storage devices in the inner packaging 210 of a finished product of the electrical storage device 100. In the auxiliary chamber 214 of the packaging films 211 and 212 for electrical storage devices, a housing chamber 215 for storing a larger amount of gas generated from the electrical storage device element 120 is formed.

First inner side sealing step S32 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed so as to extend to the auxiliary chamber 214 as shown in FIG. 16. When the first inner side sealing step is completed, an opening 213 is formed in a portion 216 of the peripheral edge of the packaging films 211 and 212 for electrical storage devices which faces a portion on which the side seal portion 153 is to be formed, with the auxiliary chamber 214 being interposed between the former and latter portions. Vacuum drying step S33 is carried out after the first inner side sealing step.

Electrolytic solution injection step S34 is carried out after the vacuum drying step. In the electrolytic solution injection step, an electrolytic solution is injected through the opening 213 (see FIG. 16).

Second inner side sealing step S35 is carried out after the electrolytic solution injection step. In the second inner side sealing step, as shown in FIG. 17, the opening 213 is closed by sealing a portion 216 of the peripheral edge of the packaging films 211 and 212 for electrical storage devices which faces a portion on which the side seal portion 153 is to be formed, with the auxiliary chamber 214 being interposed between the former and latter portions. After the second inner side sealing step, initial charge-discharge step S36 and aging step S37 are performed in this order.

Degassing step S38 is carried out after the aging step. In the degassing step, gas such as carbon dioxide generated from the electrical storage device element 120 is temporarily stored in the auxiliary chamber 214 of the packaging films 211 and 212 for electrical storage devices.

Auxiliary chamber removing step S39 is carried out after the degassing step. In the auxiliary chamber removing step, the auxiliary chamber 214 is removed by cutting the packaging films 211 and 212 for electrical storage devices along the one dot chain line XA shown in FIG. 17 such that the film is identical in size to the inner packaging 210 of a finished product of the electrical storage device 100.

Inner side sealing step S40 is carried out after the auxiliary chamber removing step. In the inner side sealing step, a portion of the peripheral edge of the packaging films 211 and 212 for electrical storage devices which corresponds to the side seal portion 153 is sealed as shown in FIG. 18. Primary charge step S41 is carried out after the inner side sealing step.

Outer side packaging step S42 is carried out after the primary charge step. In the outer side packaging step, the inner packaging 210 in which the electrical storage device element 120 is housed is wrapped by the exterior films 221 and 222.

Outer side sealing step S43 is carried out after the outer side packaging step. In the outer side sealing step, the peripheral edges of the exterior films 221 and 222 are sealed to form the peripheral edge seal portion 150.

### Embodiment 3 of Fourth Aspect

An electrical storage device 300 according to Embodiment 3 has the same configuration as in Embodiment 1 except that the configuration of the terminal seal portion 151A is different from that in Embodiment 1. Hereinafter, the electrical storage device 300 according to Embodiment 3 will be described mainly for portions different from those in Embodiment 1.

FIG. 19 is a sectional view of a terminal seal portion 351A of the electrical storage device 300 according to Embodiment 3. In the terminal seal portion 351A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to one tab film 140. The flange portion 222A of the exterior film 222 is joined to the other tab film 140. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 300, ingress of moisture and the like into the internal space S1 of the inner packaging 210 from the outside is suppressed because the inner packaging 210 is covered with the outer packaging 220.

### Embodiment 4 of Fourth Aspect

An electrical storage device 400 according to Embodiment 4 has the same configuration as in Embodiment 1 except that the configuration of the terminal seal portion 151A is different from that in Embodiment 1. Hereinafter, the electrical storage device 400 according to Embodiment 4 will be described mainly for portions different from those in Embodiment 1.

FIG. 20 is a sectional view of a terminal seal portion 451A of the electrical storage device 400 according to Embodiment 4. The electrical storage device 400 does not include the tab film 140. In a terminal seal portion 451A of the electrical storage device 400, the exterior film 221, the packaging film 211 for electrical storage devices, the metal terminal 130, the packaging film 212 for electrical storage devices, and the exterior film 222 are laminated in this order from the top, and integrated.

The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 221A of the exterior film 221 is joined to the flange portion 211A of the packaging film 211 for electrical storage devices. The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

### [Characteristics of Electrical Storage Device]

In the electrical storage device 400, the number of members is small because the packaging films 211 and 212 for electrical storage devices and the metal terminal 130 are joined without interposing the tab film 140 therebetween. In addition, the method for manufacturing the electrical storage device 400 can be simplified.

### Embodiment 5 of Fourth Aspect

An electrical storage device 500 according to Embodiment 5 has the same configuration as in Embodiment 4 except that the configuration of the terminal seal portion 451A is different from that in Embodiment 4. Hereinafter, the electrical storage device 500 according to Embodiment 5 will be described mainly for portions different from those in Embodiment 4.

FIG. 21 is a sectional view of a terminal seal portion 551A of the electrical storage device 500 according to Embodiment 5. In the terminal seal portion 551A, a part of the flange portion 211A of the packaging film 211 for electrical storage devices is joined to the metal terminal 130. A part of the flange portion 212A of the packaging film 212 for electrical storage devices is joined to the metal terminal 130.

The flange portion 221A of the exterior film 221 is joined to the metal terminal 130. The flange portion 222A of the exterior film 222 is joined to the metal terminal 130. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 500, ingress of moisture and the like into the internal space S1 of the inner packaging 210 from the outside is suppressed because the inner packaging 210 is covered with the outer packaging 220. In the electrical storage device 500, the number of members is small because the packaging films 211 and 212 for electrical storage devices and the metal terminal 130 are joined without interposing the tab film 140 therebetween. In addition, the method for manufacturing the electrical storage device 500 can be simplified.

### Modifications of Fourth Aspect

The embodiments of the fourth aspect are examples of possible forms of an electrical storage device and a method for manufacturing an electrical storage device according to the present disclosure, and are not intended to limit the forms thereof. The electrical storage device and the method for manufacturing an electrical storage device according to the present disclosure may have a form different from that exemplified in the embodiments. An example thereof is a form in which a part of the configuration of the embodiments is replaced, changed or omitted, or a form in which a new configuration is added to the embodiments. Some examples of modifications of the embodiments will be described below. The following modifications can be combined as long as there is no technical contradiction.

In the electrical storage device 100 according to Embodiment 1 of the fourth aspect, one outer packaging 220 may be configured to house a plurality of inner packagings 210 in which the electrical storage device element 120 is housed. In this modification, the sizes of a plurality of inner packagings 210 may be different or the same. According to this modification, the voltage can be easily adjusted because a plurality of electrical storage device elements 120 can be connected in series or in parallel.

In the electrical storage device 100 according to Embodiment 1 of the fourth aspect, the packaging films 211 and 212 for electrical storage devices are not required to have transparency. The packaging films 211 and 212 for electrical storage devices are only required to have at least gas permeability.

In the electrical storage device 100 according to Embodiment 1 of the fourth aspect, the inner packaging 210 may be formed by folding one packaging film 211 for electrical storage devices, and heat-sealing the peripheral edge portion. Similarly, the outer packaging 220 may be formed by folding one exterior film 221, and heat-sealing the peripheral edge portion.

### Fifth Aspect

### Embodiment 1 of Fifth Aspect

FIG. 8 shows a plan view of an electrical storage device 100 according to Embodiment 1 of the fifth aspect. FIG. 22 is a sectional view taken along line D2-D2 in FIG. 8. In FIG. 8, portions that are normally invisible from the outside are partially indicated by dotted lines for reference. Hereinafter, unless otherwise specified, the vertical direction and the horizontal direction in FIG. 8 are referred to as a “longitudinal direction” and a “horizontal direction”, respectively, and the vertical direction in FIG. 22 is referred to as a “vertical direction”, for convenience of explanation. However, the direction of the electrical storage device 100 during use is not limited thereto. In FIG. 8, for simplification of the drawing, the relative positional relationship between an inner packaging 210 and an outer packaging 220 is simplified.

The electrical storage device 100 includes a housing 110, an electrical storage device element 120, a pair of metal terminals 130, and a pair of tab films 140. The housing 110 includes an internal space S1 and a peripheral edge seal portion 150. The electrical storage device element 120 is housed in the internal space S1 of the housing 110. One end of the metal terminal 130 is joined to the electrical storage device element 120, and the other end protrudes outward from the peripheral edge seal portion 150 of the housing 110. A part of the metal terminal 130 between one end and the other end thereof is sealed to the peripheral edge seal portion 150 with the tab film 140 interposed therebetween.

The housing 110 includes a case 110A. The case 110A includes an inner packaging 210 and an outer packaging 220. The inner packaging 210 houses the electrical storage device element 120. The outer packaging 220 houses the inner packaging 210 in which the electrical storage device element 120 is housed. The internal space S1 is formed inside the inner packaging 210. The inner packaging 210 includes packaging films 211 and 212 for electrical storage devices. The outer packaging 220 includes exterior films 221 and 222. At the outer peripheral portion of the case 110A in plan view, the inner packaging 210 and the outer packaging 220 are sealed to each other by heat sealing to form the peripheral edge seal portion 150. An internal space S1 of the case 110A, which is cut off from the external space, is formed in the inner packaging 210 by the peripheral edge seal portion 150. The peripheral edge seal portion 150 defines a peripheral edge of the internal space S1 of the case 110A. The form of the heat sealing mentioned here is assumed to be sealing by heating from a heat source, ultrasonic sealing or the like. In any case, the peripheral edge seal portion 150 means a portion in which the inner packaging 210 and the outer packaging 220 are sealed to each other to be integrated.

The peripheral edge seal portion 150 includes a top seal portion 151, a pair of side seal portions 152 and 153, and a bottom seal portion 154. The top seal portion 151 includes a portion that is sealed while sandwiching the metal terminal 130 and the tab film 140 (hereinafter, referred to as a “terminal seal portion 151A”, and extends in the longitudinal direction. The pair of side seal portions 152 and 153 extend in the horizontal direction. The side seal portion 152 and the side seal portion 153 face each other with the internal space S1 therebetween. The bottom seal portion 154 faces the top seal portion 151 with the internal space S1 therebetween. The bottom seal portion 154 extends in the longitudinal direction.

As shown in FIG. 22, in the terminal seal portion 151A of the top seal portion 151, an exterior film 221, a packaging film 211 for electrical storage devices, one tab film 140, a metal terminal 130, the other tab film 140, a packaging film 212 for electrical storage devices, and an exterior film 222 are laminated in this order from the top, and integrated. Therefore, the top seal portion 151 can be easily formed. In a portion of the top seal portion 151 other than the terminal seal portion 151A, in other words, a portion in which only the pair of tab films 140 are sandwiched by the inner packaging 210 and the outer packaging 220, the exterior film 221, the packaging film 211 for electrical storage devices, one tab film 140, the other tab film 140, the packaging film 212 for electrical storage devices, and the exterior film 222 are laminated in this order from the top, and integrated. Further, in a portion of the top seal portion 151 which is outside the terminal seal portion 151A (a portion on the left of the level difference forming a boundary in FIG. 22), the packaging film 211 for electrical storage devices, one tab film 140, the metal terminal 130, the other tab film 140 and the packaging film 212 for electrical storage devices are laminated in this order from the top, and integrated. Thus, there is a level difference between the portion outside the terminal seal portion 151A where the exterior films 221 and 222 do not exist and the portion inside the terminal seal portion 151A where the exterior films 221 and 222 exist (a portion on the right of the level difference forming the boundary in FIG. 22), but FIG. 8 schematically illustrates the region of the peripheral edge seal portion 150, and does not show the level difference forming a boundary.

The packaging films 211 and 212 for electrical storage devices which form the inner packaging 210 are preferably transparent as a whole from the viewpoint of suitably manufacturing the electrical storage device 100. The packaging films 211 and 212 for electrical storage devices preferably have gas permeability from the viewpoint of easily manufacturing the electrical storage device 100. Hereinafter, a preferred example of the packaging films 211 and 212 for electrical storage devices which form the inner packaging 210 will be described. Hereinafter, the packaging films 211 and 212 for electrical storage devices may be collectively referred to as the packaging film 10 for electrical storage devices when the packaging films 211 and 212 for electrical storage devices are not distinguished.

### [Laminated Structure and Physical Properties of Packaging Film for Electrical Storage Devices According to Fifth Aspect]

As shown in, for example, FIGS. 1 to 4, a packaging film 10 for electrical storage devices according to the fifth aspect includes at least a heat-sealable resin layer 1. In construction of an electrical storage device using the packaging film 10 for electrical storage devices and an electrical storage device element, the electrical storage device element is put in a space formed by heat-sealing the peripheral portions of heat-sealable resin layers 1 of the packaging film 10 for electrical storage devices which face each other.

The packaging film 10 for electrical storage devices may include only the heat-sealable resin layer 1 as shown in FIG. 1. When the packaging film 10 for electrical storage devices includes only the heat-sealable resin layer 1, it is preferable that at least one surface of the heat-sealable resin layer 1 is bondable to metal.

In addition, it is preferable that the packaging film 10 for electrical storage devices according to the fifth aspect includes a laminate including at least a resin layer 2 and the heat-sealable resin layer 1 as shown in FIGS. 2 to 4. In such a packaging film 10 for electrical storage devices, the resin layer 2 is on the outer side, and the heat-sealable resin layer 1 is on the inner side (innermost layer). When the packaging film 10 for electrical storage devices includes a laminate including the resin layer 2 and the heat-sealable resin layer 1, it is preferable that bondability to metal is imparted to at least one of an outer surface of the resin layer 2 and an inner surface of the heat-sealable resin layer 1, and it is more preferable that bondability to metal is imparted to an inner surface of the heat-sealable resin layer 1 which faces the metal terminal 130.

Further, it is preferable that the packaging film 10 for electrical storage devices according to the fifth aspect includes a laminate including at least the resin layer 2, a base material 3 and the heat-sealable resin layer 1 as shown in FIGS. 3 and 4. In such a packaging film 10 for electrical storage devices, the resin layer 2 is on the outer side, the heat-sealable resin layer 1 is on the inner side (innermost layer), and the base material 3 is located between the resin layer 2 and the heat-sealable resin layer 1. Even when the packaging film 10 for electrical storage devices includes a laminate including the resin layer 2, the base material 3 and the heat-sealable resin layer 1, it is preferable that bondability to metal is imparted to at least one of an outer surface of the resin layer 2 and an inner surface of the heat-sealable resin layer 1, and it is more preferable that bondability to metal is imparted to an inner surface of the heat-sealable resin layer 1 which faces the metal terminal 130.

It is possible to provide the adhesive agent layer 4 between the resin layer 2 and the heat-sealable resin layer 1 as shown in FIG. 2, and the adhesive agent layer 5 between the heat-sealable resin layer 1 and the base material 3 as shown in FIG. 4.

In the packaging film 10 for electrical storage devices according to the fifth aspect of the present disclosure, a CO₂ transmission rate in an environment at a temperature of 30° C. is preferably 100 cc·100 μm/m²/24 hr/atm or more, more preferably about 200 cc·100 μm/m²/24 hr/atm or more, still more preferably about 300 cc·100 μm/m²/24 hr/atm or more, even more preferably about 500 cc·100 μm/m²/24 hr/atm or more. The CO₂ transmission rate of the packaging film 10 for electrical storage devices according to the fifth aspect is, for example, about 2,000 cc·100 μm/m²/24 hr/atm or less, preferably about 1000 cc·100 μm/m²/24 hr/atm or less, more preferably about 800 cc·100 μm/m²/24 hr/atm or less, and preferably in the range of about 100 to 2,000 cc·100 μm/m²/24 hr/atm, about 100 to 1,000 cc·100 μm/m²/24 hr/atm, about 100 to 800 cc·100 μm/m²/24 hr/atm, about 200 to 2,000 cc·100 μm/m²/24 hr/atm, about 200 to 1,000 cc·100 μm/m²/24 hr/atm, about 200 to 800 cc·100 μm/m²/24 hr/atm, about 300 to 2,000 cc·100 μm/m²/24 hr/atm, about 300 to 1,000 cc·100 μm/m²/24 hr/atm, about 300 to 800 cc·100 μm/m²/24 hr/atm, about 500 to 2,000 cc·100 μm/m²/24 hr/atm, about 500 to 1,000 cc·100 μm/m²/24 hr/atm, or 500 to 800 cc·100 μm/m²/24 hr/atm. The method for measuring the CO₂ transmission rate of the packaging film for electrical storage devices is as follows.

### [Measurement of CO₂ Transmission Rate]

CO₂ passing through a φ60 mm part of the packaging film 10 for electrical storage devices is quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate.

When a shielding property is imparted to the packaging film 10 for electrical storage devices according to the fifth aspect, it is only required that at least one layer in the packaging film 10 for electrical storage devices be a shielding layer S having a shielding property. For example, FIG. 2 shows a configuration in which the adhesive agent layer 4 bonding the resin layer 2 and the heat-sealable resin layer 1 is the shielding layer S, and FIG. 4 shows a configuration in which an adhesive agent layer 4 bonding the resin layer 2 and the base material 3 is the shielding layer S. In the fifth aspect, any layer in the packaging film 10 for electrical storage devices can be the shielding layer S.

A surface coating layer or the like may be further provided on the outside of the resin layer 2 (on a side opposite to the heat-sealable resin layer 1 side) if necessary (not shown).

The thickness of the laminate forming the packaging film 10 for electrical storage devices is not particularly limited, and is, for example, 190 μm or less, preferably about 180 μm or less, or about 170 μm or less, from the viewpoint of cost reduction, energy density improvement, and the like. The thickness of the laminate forming the packaging film 10 for electrical storage devices is preferably about 35 μm or more, about 45 μm or more, or about 60 μm or more, from the viewpoint of maintaining the function of a packaging film for electrical storage devices to protect of an electrical storage device element. The laminate forming the packaging film 10 for electrical storage devices is preferably in the range of, for example, about 35 to 190 μm, about 35 to 180 μm, about 35 to 170 μm, about 45 to 190 μm, about 45 to 180 μm, about 45 to 170 μm, about 60 to 190 μm, about 60 to 180 μm, and about 60 to 170 μm, particularly preferably about 45 to 170 μm.

In the packaging film 10 for electrical storage devices, the ratio of the total thickness of the resin layer 2, the adhesive agent layer 4, the base material 3, the adhesive agent layer 5 and the heat-sealable resin layer 1 to the thickness (total thickness) of the laminate forming the packaging film 10 for electrical storage devices is preferably 90% or more, more preferably 95% or more, still more preferably 98% or more. As a specific example, when the packaging film 10 for electrical storage devices according to the fifth aspect includes the resin layer 2, the adhesive agent layer 4, the base material 3, the adhesive agent layer 5 and the heat-sealable resin layer 1, the ratio of the total thickness of these layers to the thickness (total thickness) of the laminate forming the packaging film 10 for electrical storage devices is preferably 90% or more, more preferably 95% or more, still more preferably 98% or more. In addition, when the packaging film 10 for electrical storage devices according to the fifth aspect is a laminate including the resin layer 2, the adhesive agent layer 4 and the heat-sealable resin layer 1, the ratio of the total thickness of these layers to the thickness (total thickness) of the laminate forming the packaging film 10 for electrical storage devices may be, for example, 80% or more, preferably 90% or more, more preferably 95% or more, still more preferably 98% or more.

The laminate forming the packaging film 10 for electrical storage devices according to the fifth aspect can have a total light transmittance of, for example, 20% or less, 15% or less, 10% or less, 8% or less as measured in accordance with the provisions of JIS K7361-1: 1997. The laminate forming the packaging film 10 for electrical storage devices according to the fifth aspect can also have a total light transmittance of, for example, 80% or more, 85% or more, or 90% or more as measured in accordance with the provisions of JIS K7361-1: 1997. The shielding property that can be exhibited by the packaging film 10 for electrical storage devices is enhanced as the total light transmittance decreases. On the other hand, the light permeability that can be exhibited by the packaging film 10 for electrical storage devices is enhanced as the total light transmittance increases. The lower limit value of the total light transmittance is 0%, and the upper limit of the total light transmittance is 100%. For the total light transmittance of the packaging film for electrical storage devices, the transmittance in a visible light region (400 to 700 nm) is measured with a commercially available spectrophotometer (for example, Ultraviolet-Visible-Near Infrared Spectrophotometer V-670 manufactured by JASCO Corporation) by a measurement method specified in JIS K7361-1: 1997, and the average value thereof is taken as a total light transmittance. For measurement conditions, a halogen lamp is used as a light source, the UV/Vis bandwidth is 5.0 nm, the scanning rate is 1,000 nm/min, the response is set to Medium, and the data capture interval is 1.0 nm.

The packaging film 10 for electrical storage devices can be colored black. When the packaging film 10 for electrical storage devices is colored black, the packaging film 10 for electrical storage devices has a high shielding property and a high forge-proof effect. In addition, in a manufacturing process of the electrical storage device, it is possible to identify a location by a sensor with higher accuracy, and it is possible to more accurately convey the packaging film 10 for electrical storage devices and seal the electrical storage device element, and the like. Further, the electrical storage device and other electrical components can be all colored black to impart a high-grade feeling as a product.

### <Layers Forming Packaging Film for Electrical Storage Devices According to Fifth Aspect>

The layers forming the packaging film for electrical storage devices according to the fifth aspect are the same as those of the packaging film for electrical storage devices according to the first aspect and the packaging film for electrical storage devices according to the second aspect, and therefore are not described.

### [Method for Manufacturing Packaging Film for Electrical Storage Devices]

The method for manufacturing a packaging film for electrical storage devices is not particularly limited as long as a packaging film for electrical storage devices according to the fifth aspect is obtained. For example, when the packaging film for electrical storage devices according to the fifth aspect includes the resin layer 2 and the heat-sealable resin layer 1, it is preferable that the method includes a step of preparing a laminate in which at least a resin layer and a heat-sealable resin layer are laminated in this order from the outside, and the laminate has a CO₂ transmission rate of 100 cc·100 μm/m²/24 hr/atm or more in an environment at a temperature of 30° C.

An example of the manufacturing method when the packaging film for electrical storage devices according to the fifth exemplary embodiment includes a laminate including the resin layer 2, the adhesive agent layer 4, the base material 3, the adhesive agent layer 5 and the heat-sealable resin layer 1 in this order is as follows. First, materials for forming the layers are provided. Subsequently, the resin layer 2 and the base material 3 are laminated with the adhesive agent layer 4 interposed therebetween, and the base material 3 and the heat-sealable resin layer 1 are laminated with the adhesive agent layer 5 interposed therebetween. Specifically, using an adhesive for forming the adhesive agent layer 4, the resin layer 2 and the base material 3 are laminated by a dry lamination method or the like to laminate the resin layer 2, the adhesive agent layer 4 and the base material 3, and further, using an adhesive for forming the adhesive agent layer 5, the base material 3 and the heat-sealable resin layer 1 are laminated by a dry lamination method or the like to manufacture the packaging film 10 for electrical storage devices. When the resin layer 2, the base material 3 and the heat-sealable resin layer 1 are laminated without the adhesive agent layers 4 and 5, the packaging film 10 for electrical storage devices can be manufactured by, for example, a method in which a resin for forming the resin layer 2 is melted and extruded to one side of the base material 3, and a resin for forming the heat-sealable resin layer 1 is melted and extruded to the other side of the base material 3. When the colored layer is provided, the colored layer may be formed on the surface of the resin layer 2, and then laminated to the base material 3 and the heat-sealable resin layer 1. When a surface coating layer is provided, for example, the resin composition for forming the surface coating layer is applied to the surface of the resin layer 2, and cured to form the surface coating layer.

The packaging film 10 for electrical storage devices may be further subjected to heat treatment for enhancing the bondability of the adhesive agent layers 4 and 5.

The shape of the inner packaging 210 is not particularly limited, and can be, for example, a bag shape (pouch shape). The bag shape mentioned here may be of three-way seal type, four-way seal type, pillow type, gusset type or the like. The inner packaging 210 in Embodiment 1 is manufactured by heat-sealing the packaging film 212 for electrical storage devices which has a shape shown in FIG. 22 and is molded in a tray shape and the packaging film 211 for electrical storage devices which is also molded in a tray shape and is superposed on the packaging film 212 for electrical storage devices, along an outer peripheral portion in plan view. The packaging film 212 for electrical storage devices includes an angular ring-shaped flange portion 212A corresponding to the outer peripheral portion in plan view, and a molded part 212B which is continuous with the inner edge of the flange portion 212A and extends downward therefrom. Similarly, the packaging film 211 for electrical storage devices includes an angular ring-shaped flange portion 211A corresponding to the outer peripheral portion in plan view, and a part 211B which is continuous with the inner edge of the flange portion 211A and extends upward therefrom. The packaging films 211 and 212 for electrical storage devices are superposed such that the molded parts 211B and 212B extend in opposite directions. In this state, the flange portion 211A of the packaging film 211 for electrical storage devices and the flange portion 212A of the packaging film 212 for electrical storage devices are heat-sealed so as to be integrated with each other, resulting in formation of a part of the peripheral edge seal portion 150. One of the packaging films 211 and 212 for electrical storage devices may have a sheet shape.

The exterior films 221 and 222 for forming the outer packaging 220 are formed from, for example, a resin molded article or film. The resin molded article mentioned here can be manufactured by a method such as injection molding, compressed-air molding, vacuum molding or blow molding, where in-mold molding may be performed for imparting a design property, and functionality. The type of the resin may be polyolefin, polyester, nylon, ABS, or the like. The film mentioned here is, for example, a resin film that can be manufactured by a method such as an inflation method or a T-die method, or a film obtained by laminating such a resin film on a metal foil or a metal sheet. The film mentioned here may be a stretched film, and may be a single layer film or multiple layer film. The multiple layer film mentioned here may be manufactured by a coating method, may be obtained by bonding a plurality of films with an adhesive or the like, or may be manufactured by a multilayer extrusion method.

The exterior films 221 and 222 can be formed in various ways as described above, and include a laminate film in Embodiment 1. The laminate film can be a laminate obtained by laminating a base material layer, a barrier layer and a heat-sealable resin layer. The base material layer functions as a base material of the exterior films 221 and 222, and is typically a resin layer forming an outer layer of the outer packaging 220 and having insulation quality. The barrier layer has functions of improving the strength of the exterior films 221 and 222 and preventing at least ingress of moisture, among others, into the electrical storage device 100. The barrier layer is typically a metal layer made of an aluminum alloy foil or the like. The heat-sealable resin layer is typically made of a heat-sealable resin such as polyolefin, and forms the innermost layer of the outer packaging 220.

The shape of the outer packaging 220 is not particularly limited, and can be, for example, a bag shape (pouch shape). The bag shape mentioned here may be of three-way seal type, four-way seal type, pillow type, gusset type or the like. However, the case 110A according to Embodiment 1 has a shape as in FIG. 22, and is manufactured by heat-sealing the exterior film 222 molded in a tray shape and the exterior film 221 also molded in a tray shape and superposed on the exterior film 222, along the outer peripheral portion in plan view. The exterior film 222 includes an angular ring-shaped flange portion 222A corresponding to an outer peripheral portion in plan view, and a molded part 222B which is continuous with the inner edge of the flange portion 222A and extends downward therefrom. Similarly, the exterior film 221 includes an angular ring-shaped flange portion 221A corresponding to the outer peripheral portion in plan view, and a part 221B which is continuous with the inner edge of the flange portion 221A and extends upward therefrom. The exterior films 221 and 222 are superposed such that the molded parts 221B and 222B extend in opposite directions. In this state, the flange portion 221A of the exterior film 221 and the flange portion 222A of the exterior film 222 are heat-sealed so as to be integrated with each other, resulting in formation of a part of the peripheral edge seal portion 150. One of the exterior films 221 and 222 may have a sheet shape.

As shown in FIG. 22, in the terminal seal portion 151A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to the flange portion 211A of the packaging film 211 for electrical storage devices. The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

The electrical storage device element 120 includes at least a positive electrode, a negative electrode and an electrolyte, and is, for example, a power storage member of a lithium ion battery (secondary battery), a capacitor, or the like.

The metal terminal 130 is a metal terminal used for inputting and outputting electric power to and from the electrical storage device element 120. The metal terminals 130 are disposed on the top seal portion 151 of the case 110A, with one metal terminal forming a terminal on the positive electrode side and the other forming a terminal on the negative electrode side. One end part of each metal terminal 130 in the horizontal direction is electrically connected to an electrode (positive electrode or negative electrode) of the electrical storage device element 120 in the internal space S1 of the case 110A, and the other end part protrudes outward from the peripheral edge seal portion 150. The above form of the electrical storage device 100 is particularly preferable uses in, for example, an electrically driven vehicle such as an electric vehicle or a hybrid vehicle in which a large number of electrical storage devices 100 are connected in series and used at a high voltage. The locations of attachment of the two metal terminals 130 forming the terminals of the positive electrode and the negative electrode are not particularly limited, and for example, the metal terminals 130 may be disposed on the side seal portions 152 and 153 or the bottom seal portion 154 of the peripheral edge seal portion 150.

The metal material forming the metal terminal 130 is, for example, aluminum, nickel, or copper. When the electrical storage device element 120 is a lithium ion battery, the metal terminal 130 connected to the positive electrode is typically made of aluminum or the like, and the metal terminal 130 connected to the negative electrode is typically made of copper, nickel or the like.

The tab film 140 is a so-called adhesive film, and is configured to be bonded to both the packaging films 211 and 212 for electrical storage devices and the metal terminal 130. By interposing the tab film 140, the metal terminal 130 and the innermost layer (heat-sealable resin layer) of the packaging films 211 and 212 for electrical storage devices can be fixed even if the former and the latter are made of different materials. The tab film 140 is sealed and fixed to the metal terminal 130 to integrate the tab film and the metal terminal in advance, and the packaging films 211 and 212 for electrical storage devices are sealed to the metal terminal 130 to which the tab film 140 is fixed.

The electrical storage device 100 according to Embodiment 1 of exemplary embodiment 5 includes functional body 230 so as to have a high value-added function in addition to functions of a common electrical storage device. The functional body 230 has at least one of shock absorbency, flame retardancy, a cooling property and a fire-extinguishing property. The functional body 230 is disposed between the inner packaging 210 and the outer packaging 220. A specific form of the functional body 230 can be arbitrarily selected. The functional body 230 may be in the form of a sheet such as a film, may be a liquid that can be applied to a film, or may be in the form of particles or a liquid having predetermined fluidity (viscosity).

When the functional body 230 is in the form of a sheet such as a film, for example, the functional body 230 is wound around the inner packaging 210 and joined to the inner packaging 210. The functional body 230 may be joined to the inner packaging 210 so as to cover at least a part of the surface of the inner packaging 210, but is preferably joined to the inner packaging 210 so as to cover substantially the whole of the surface of the inner packaging 210.

When the functional body 230 is a liquid that can be applied to a film or the like, the functional body 230 is applied to the surface of the inner packaging 210 or the inner surface of the outer packaging 220. The functional body 230 may be applied to at least a part of the inner packaging 210, but is preferably applied to substantially the whole of the surface of the inner packaging 210. The phrase “the functional body 230 is a liquid that can be applied to a film or the like” includes a state in which the functional body can be sprayed to the inner packaging 210 and the outer packaging 220 by a spray or the like.

When the functional body 230 is in the form of particles or a liquid having predetermined fluidity (viscosity), the functional body 230 is filled in a space between the inner packaging 210 and the outer packaging 220. The functional body 230 may be filled in at least a part of the space between the inner packaging 210 and the outer packaging 220, but is preferably filled in substantially the whole of the space between the inner packaging 210 and the outer packaging 220.

The functional body 230 having impact absorbency is, for example, a highly foamed non-crosslinked polyethylene sheet, a highly foamed electron-beam-crosslinked polyethylene sheet, a highly foamed polyethylene heat-welded sheet, or nitrile rubber.

The functional body 230 having flame retardancy is, for example, a flame-retardant polycarbonate film, or a flame-retardant polyethylene terephthalate.

The functional body 230 having a cooling property is, for example, a high thermal conductivity film, a high thermal conductivity sheet, or a high thermal conductivity graphite sheet.

The functional body 230 having a fire-extinguishing property is, for example, a fire extinguishing agent, or a film containing a fire extinguishing agent (hereinafter, referred to as a “fireproof film”). The fire extinguishing agent is, for example, a common powder-based fire extinguishing agent such as a potassium salt, sodium hydrogen carbonate or a phosphoric acid salt, an ABC fire extinguishing agent, a BC fire extinguishing agent, or sand. When a fire extinguishing agent is used as the functional body 230, a fire extinguishing agent free of water is preferable from the viewpoint of suppressing deterioration of the functions of the electrical storage device 100.

As the fireproof film, a known fireproof film can be used. The fireproof film is, for example, a laminated film including a base material (base material layer) and a fire extinguishing agent-containing layer in this order. The fire extinguishing agent-containing layer may be provided on at least a part of one surface of the base material, but is preferably provided on the whole of the surface of the base material. The base material has a support region for a fire extinguishing agent component and a binder resin in the base material and on the extinguishing agent-containing layer side.

The fireproof film can be used such that the fire extinguishing agent-containing layer faces an object that may ignite. In Embodiment 1, the fireproof film is joined to the inner surface of the outer packaging 220 such that the fire extinguishing agent-containing layer faces the surface of the inner packaging 210. For example, when the electrical storage device element 120 ignites, initial fire-fighting is performed by aerosol generated from the fire extinguishing agent-containing layer.

The base material has voids, and in the form of, for example, a nonwoven fabric formed by entangling incombustible or flame-retardant fibers or a woven fabric formed by interweaving incombustible or flame-retardant fibers. Examples of the incombustible or flame-retardant fiber include glass fiber, ceramic fiber, metal fiber, cellulose fiber, polyester fiber, carbon fiber, graphite fiber, and thermosetting resin fiber. From the viewpoint of having excellent incombustibility, glass fiber and ceramic fiber can be used. Examples of the base material include glass cloth and incombustible paper. As the base material, an incombustible base material corresponding to Flame Retardation Grade 1 defined in JIS Z 2150-1966 can also be used.

In formation of a coating film on a surface of the base material by applying a coating liquid containing a fire extinguishing agent component and a binder resin, a part of the coating liquid enters into the base material to form the support region in the base material. It can be said that the base material includes a support region for the fire extinguishing agent component and the binder resin, and a region that does not support the fire extinguishing agent component and the binder resin.

The fire extinguishing agent-containing layer contains a fire extinguishing agent component and a binder resin. The fire extinguishing agent component generates aerosol by combustion. The fire extinguishing agent component contains, for example, at least an inorganic oxidizing agent and a radical generator. The radical generator has an action of stabilizing combustion radicals to suppress a chain reaction of combustion (negative catalytic action).

### [Method for Manufacturing Electrical Storage Device]

FIG. 23 is a flowchart showing an example of a method for manufacturing the electrical storage device 100. The method for manufacturing the electrical storage device 100 includes a plurality of steps.

In inner side packaging step S11, the electrical storage device element 120 is wrapped by the molded packaging films 211 and 212 for electrical storage devices as shown in FIG. 11. In the electrical storage device 100 according to the present Embodiment 1, formation of an auxiliary chamber for temporarily storing gas generated from the electrical storage device element 120 in the later-described initial filling step and the like is not necessary because the packaging films 211 and 212 for electrical storage devices have gas permeability. Therefore, in the inner side packaging step, the electrical storage device element 120 is wrapped by packaging films 211 and 212 for electrical storage devices, which are substantially identical in size to packaging films 211 and 212 for electrical storage devices in the inner packaging 210 of a finished product of the electrical storage device 100. Therefore, the manufacturing process of the electrical storage device 100 can be simplified. In addition, the amount of materials used for the electrical storage device 100 can be reduced. The term “substantially identical in size” includes being larger in size than the packaging films 211 and 212 for electrical storage devices in the inner packaging 210 of a finished product of the electrical storage device 100 to the extent that an auxiliary chamber cannot be formed. The metal terminal 130 is connected to the electrical storage device element 120 in advance, and the tab film 140 is joined to the metal terminal 130.

First inner side sealing step S12 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed as shown in FIG. 12. When the first inner side sealing step is completed, an opening 213 is formed in a portion of the peripheral edge of the packaging films 211 and 212 for electrical storage devices on which the side seal portion 153 is to be formed. Vacuum drying step S13 is carried out after the first inner side sealing step.

Electrolytic solution injection step S14 is carried out after the vacuum drying step. In the electrolytic solution injection step, an electrolytic solution is injected through the opening 213 (see FIG. 12).

Second inner side sealing step S15 is carried out after the electrolytic solution injection step. In the second inner side sealing step, the opening 213 is closed by sealing a portion of the peripheral edge of the packaging films 211 and 212 for electrical storage devices on which the side seal portion 153 is to be formed as shown in FIG. 18. In the electrical storage device 100, whether or not the packaging film 211 for electrical storage devices and the packaging film 212 for electrical storage devices are appropriately sealed can be easily confirmed after completion of the first inner side sealing step or the second inner side sealing step because the packaging films 211 and 212 for electrical storage devices are transparent. Therefore, the electrical storage device 100 can be suitably manufactured. The state in which the packaging film 211 for electrical storage devices and the packaging film 212 for electrical storage devices are not appropriately sealed includes, for example, a first state, a second state or a third state. The first state is a state in which the packaging film 211 for electrical storage devices and the packaging film 212 for electrical storage devices are sealed with contaminants caught therebetween. The second state is a state in which a part of a portion to be sealed is not sealed. The third state is a state in which a portion that should not be sealed is sealed. After the second inner side sealing step, initial charge-discharge step S16 and aging step S17 are performed in this order.

Degassing step S18 is carried out in parallel to the initial charge-discharge step and the aging step. In Embodiment 1, since the packaging films 211 and 212 for electrical storage devices has gas permeability, gas such as carbon dioxide generated from the electrical storage device element 120 is discharged to the outside through the packaging films 211 and 212 for electrical storage devices when the initial charge-discharge step and the aging step are carried out. Primary charge step S19 is carried out after the degassing step.

Disposition step S20 is carried out after the primary filling step. In the disposition step, the functional body 230 is disposed between the inner packaging 210 and the outer packaging 230 in a manner appropriate to a specific form of the functional body 230. When the functional body 230 is in the form of a sheet such as a film, for example, the functional body 230 is wound around the inner packaging 210 and joined to the inner packaging 210. When the functional body 230 is a liquid that can be applied to a film or the like, the functional body 230 is applied to the surface of the inner packaging 210 or the inner surface of the outer packaging 220.

Outer side packaging step S21 is carried out after the disposition step. In the outer side packaging step, the inner packaging 210 in which the electrical storage device element 120 is housed is wrapped by the exterior films 221 and 222.

Outer side sealing step S22 is carried out after the outer side packaging step. In the outer side sealing step, the peripheral edges of the exterior films 221 and 222 are sealed to form the peripheral edge seal portion 150. When the functional body 230 is in the form of particles or a liquid having predetermined fluidity (viscosity), the disposition step may be carried out by filling the functional body from an opening of a portion in which the bottom seal portion 154 is formed after formation of, for example, the top seal portion 151 and the side seal portions 152 and 153 of the peripheral edge seal portion 150 in the outer side sealing step.

### [Characteristics of Electrical Storage Device]

The electrical storage device 100 has a high added value because it includes the functional body 230.

### Embodiment 2 of Fifth Exemplary Embodiment

An electrical storage device 100 according to Embodiment 2 has the same configuration as in Embodiment 1 except that the packaging films 211 and 212 for electrical storage devices do not have gas permeability, or do not have such high gas permeability that the degassing step S18 is carried out as in Embodiment 1. Hereinafter, the electrical storage device 100 according to Embodiment 2 will be described mainly for portions different from those in Embodiment 2.

### [Method for Manufacturing Electrical Storage Device]

FIG. 24 is a flowchart showing an example of a method for manufacturing the electrical storage device 100 according to Embodiment 2. The method for manufacturing the electrical storage device 100 includes a plurality of steps.

In inner side packaging step S31, the electrical storage device element 120 is wrapped by the molded packaging films 211 and 212 for electrical storage devices as shown in FIG. 15. In the electrical storage device 100 according to the present Embodiment 2, formation of the auxiliary chamber 214 for temporarily storing gas generated from the electrical storage device element 120 in the initial filling step and the like is preferable because the packaging films 211 and 212 for electrical storage devices do not have gas permeability. Therefore, in the inner side packaging step, the electrical storage device element 120 is wrapped by packaging films 211 and 212 for electrical storage devices, which are larger in size than packaging films 211 and 212 for electrical storage devices in the inner packaging 210 of a finished product of the electrical storage device 100. In the auxiliary chamber 214 of the packaging films 211 and 212 for electrical storage devices, a housing chamber 215 for storing a larger amount of gas generated from the electrical storage device element 120 is formed.

First inner side sealing step S32 is carried out after the inner side packaging step. In the first inner side sealing step, portions of the peripheral edge of the packaging films 211 and 212 for electrical storage devices, which correspond to the top seal portion 151, the side seal portion 152 and the bottom seal portion 154, are sealed so as to extend to the auxiliary chamber 214 as shown in FIG. 16. When the first inner side sealing step is completed, an opening 213 is formed in a portion 216 of the peripheral edge of the packaging films 211 and 212 for electrical storage devices which faces a portion on which the side seal portion 153 is to be formed, with the auxiliary chamber 214 being interposed between the former and latter portions. Vacuum drying step S33 is carried out after the first inner side sealing step.

Electrolytic solution injection step S34 is carried out after the vacuum drying step. In the electrolytic solution injection step, an electrolytic solution is injected through the opening 213 (see FIG. 16).

Second inner side sealing step S35 is carried out after the electrolytic solution injection step. In the second inner side sealing step, as shown in FIG. 17, the opening 213 is closed by sealing a portion 216 of the peripheral edge of the packaging films 211 and 212 for electrical storage devices which faces a portion on which the side seal portion 153 is to be formed, with the auxiliary chamber 214 being interposed between the former and latter portions. After the second inner side sealing step, initial charge-discharge step S36 and aging step S37 are performed in this order.

Degassing step S38 is carried out after the aging step. In the degassing step, gas such as carbon dioxide generated from the electrical storage device element 120 is temporarily stored in the auxiliary chamber 214 of the packaging films 211 and 212 for electrical storage devices.

Auxiliary chamber removing step S39 is carried out after the degassing step. In the auxiliary chamber removing step, the auxiliary chamber 214 is removed by cutting the packaging films 211 and 212 for electrical storage devices along the one dot chain line XA shown in FIG. 17 such that the film is identical in size to the inner packaging 210 of a finished product of the electrical storage device 100.

Inner side sealing step S40 is carried out after the auxiliary chamber removing step. In the inner side sealing step, a portion of the peripheral edge of the packaging films 211 and 212 for electrical storage devices which corresponds to the side seal portion 153 is sealed as shown in FIG. 18. Primary charge step S41 is carried out after the inner side sealing step.

Disposition step S42 is carried out after the primary filling step. In the disposition step, the functional body 230 is disposed between the inner packaging 210 and the outer packaging 230 in a manner appropriate to a specific form of the functional body 230. When the functional body 230 is in the form of a sheet such as a film, for example, the functional body 230 is wound around the inner packaging 210 and joined to the inner packaging 210. When the functional body 230 is a liquid that can be applied to a film or the like, the functional body 230 is applied to the surface of the inner packaging 210 or the inner surface of the outer packaging 220.

Outer side packaging step S43 is carried out after the disposition step. In the outer side packaging step, the inner packaging 210 in which the electrical storage device element 120 is housed is wrapped by the exterior films 221 and 222.

Outer side sealing step S44 is carried out after the outer side packaging step. In the outer side sealing step, the peripheral edges of the exterior films 221 and 222 are sealed to form the peripheral edge seal portion 150. When the functional body 230 is in the form of particles or a liquid having predetermined fluidity (viscosity), the disposition step may be carried out by filling the functional body from an opening of a portion in which the bottom seal portion 154 is formed after formation of, for example, the top seal portion 151 and the side seal portions 152 and 153 of the peripheral edge seal portion 150 in the outer side sealing step.

### [Characteristics of Electrical Storage Device]

The electrical storage device 100 according to Embodiment 3 has the same effect as the electrical storage device 100 according to Embodiment 1 because the electrical storage device 100 according to Embodiment 3 includes the functional body 230.

### Embodiment 3 of Fifth Exemplary Embodiment

An electrical storage device 300 according to Embodiment 3 has the same configuration as in Embodiment 1 except that the configuration of the terminal seal portion 151A is different from that in Embodiment 1. Hereinafter, the electrical storage device 300 according to Embodiment 3 will be described mainly for portions different from those in Embodiment 1.

FIG. 25 is a sectional view of a terminal seal portion 351A of the electrical storage device 300 according to Embodiment 3. In the terminal seal portion 351A, a part of the flange portion 211A of the packaging film 211 for electrical storage devices is joined to one tab film 140. A part of the flange portion 212A of the packaging film 212 for electrical storage devices is joined to the other tab film 140.

The flange portion 221A of the exterior film 221 is joined to one tab film 140. The flange portion 222A of the exterior film 222 is joined to the other tab film 140. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 300, ingress of moisture and the like into the internal space S1 of the inner packaging 210 from the outside is suppressed because the inner packaging 210 is covered with the outer packaging 220.

### Embodiment 4 of Fifth Exemplary Embodiment

An electrical storage device 400 according to Embodiment 4 has the same configuration as in Embodiment 1 except that the configuration of the terminal seal portion 151A is different from that in Embodiment 1. Hereinafter, the electrical storage device 400 according to Embodiment 4 will be described mainly for portions different from those in Embodiment 1.

FIG. 26 is a sectional view of a terminal seal portion 451A of the electrical storage device 400 according to Embodiment 4. The electrical storage device 400 does not include the tab film 140. In a terminal seal portion 451A of the electrical storage device 400, the exterior film 221, the packaging film 211 for electrical storage devices, the metal terminal 130, the packaging film 212 for electrical storage devices, and the exterior film 222 are laminated in this order from the top, and integrated.

The end part 221X of the flange portion 221A is located closer to the electrical storage device element 120 than the end part 211X of the packaging film 211 for electrical storage devices. Therefore, at least a part of the outer edge of the inner packaging 210 is exposed from the outer packaging 220. In the horizontal direction, the end part 221X of the flange portion 221A may be located at the same position as the end part 211X of the packaging film 211 for electrical storage devices or located farther from the electrical storage device element 120 than the end part 211X of the packaging film 211 for electrical storage devices.

The flange portion 221A of the exterior film 221 is joined to the flange portion 211A of the packaging film 211 for electrical storage devices. The flange portion 222A of the exterior film 222 is joined to the flange portion 212A of the packaging film 212 for electrical storage devices. The end part 222X of the flange portion 222A is located closer to the electrical storage device element 120 than the end part 212X of the packaging film 212 for electrical storage devices. Therefore, at least a part of the outer edge of the inner packaging 210 is exposed from the outer packaging 220. In the horizontal direction, the end part 222X of the flange portion 222A may be located at the same position as the end part 212X of the packaging film 212 for electrical storage devices or located farther from the electrical storage device element 120 than the end part 212X of the packaging film 212 for electrical storage devices.

### [Characteristics of Electrical Storage Device]

In the electrical storage device 400, the number of members is small because the packaging films 211 and 212 for electrical storage devices and the metal terminal 130 are joined without interposing the tab film 140 therebetween. In addition, the method for manufacturing the electrical storage device 400 can be simplified.

### Embodiment 5 of Fifth Exemplary Embodiment

An electrical storage device 500 according to Embodiment 5 has the same configuration as in Embodiment 4 except that the configuration of the terminal seal portion 451A is different from that in Embodiment 4. Hereinafter, the electrical storage device 500 according to Embodiment 5 will be described mainly for portions different from those in Embodiment 4.

FIG. 27 is a sectional view of a terminal seal portion 551A of the electrical storage device 500 according to Embodiment 5. In the terminal seal portion 551A, a part of the flange portion 211A of the packaging film 211 for electrical storage devices is joined to the metal terminal 130. A part of the flange portion 212A of the packaging film 212 for electrical storage devices is joined to the metal terminal 130.

The flange portion 221A of the exterior film 221 is joined to the metal terminal 130. The flange portion 222A of the exterior film 222 is joined to the metal terminal 130. The end part 221X of the flange portion 221A is located farther from the electrical storage device element 120 than the end part 211X of the packaging film 211 for electrical storage devices. The end part 222X of the flange portion 222A is located farther from the electrical storage device element 120 than the end part 212X of the packaging film 212 for electrical storage devices. Therefore, the whole of the inner packaging 210 is covered with the outer packaging 220.

### [Characteristics of Electrical Storage Device]

In the electrical storage device 500, ingress of moisture and the like into the internal space S1 of the inner packaging 210 from the outside is suppressed because the inner packaging 210 is covered with the outer packaging 220. In the electrical storage device 500, the number of members is small because the packaging films 211 and 212 for electrical storage devices and the metal terminal 130 are joined without interposing the tab film 140 therebetween. In addition, the method for manufacturing the electrical storage device 500 can be simplified.

### Modifications of Fifth Exemplary Embodiment

The embodiments are examples of possible forms of an electrical storage device and a method for manufacturing an electrical storage device according to the fifth exemplary embodiment, and are not intended to limit the forms thereof. The electrical storage device and the method for manufacturing an electrical storage device according to the present disclosure may have a form different from that exemplified in the embodiments. An example thereof is a form in which a part of the configuration of the embodiments is replaced, changed or omitted, or a form in which a new configuration is added to the embodiments. Some examples of modifications of the embodiments will be described below. The following modifications can be combined as long as there is no technical contradiction.

In electrical storage device 100 according to Embodiment 1, the functional body 230 may be contained in the packaging films 211 and 212 for electrical storage devices and/or the exterior films 221 and 222. That is, in the electrical storage device 100 of this modification, at least one of the inner packaging 210 and the outer packaging 220 is configured to have at least one of shock absorbability, flame retardancy, a cooling property, and a fire-extinguishing property.

In the electrical storage device 100 according to Embodiment 1, one outer packaging 220 may be configured to house a plurality of inner packagings 210 in which the electrical storage device element 120 is housed. In this modification, the sizes of a plurality of inner packagings 210 may be different or the same. According to this modification, the voltage can be easily adjusted because a plurality of electrical storage device elements 120 can be connected in series or in parallel.

In the electrical storage device 100 according to Embodiment 1, the packaging films 211 and 212 for electrical storage devices are not required to have transparency and gas permeability.

In the electrical storage device 100 according to Embodiment 1, the inner packaging 210 may be formed by folding one packaging film 211 for electrical storage devices, and heat-sealing the peripheral edge portion. Similarly, the outer packaging 220 may be formed by folding one exterior film 221, and heat-sealing the peripheral edge portion.

### EXAMPLES

Hereinafter, the present disclosure will be described in detail by way of examples and comparative examples. However, the present disclosure is not limited to examples.

### Manufacture of Packaging Film for Electrical Storage Devices According to First Aspect

### Example 1A

For a resin layer, a polyethylene terephthalate (PET) film (thickness: 12 μm) was provided. As a heat-sealable resin layer, an unstretched polypropylene film (CPP, thickness: 50 μm) was provided. Using a two-liquid urethane adhesive containing carbon black (the average particle size of carbon black is within the range of 0.161 to 0.221 μm), the resin layer and the heat-sealable resin layer were bonded to each other with a black adhesive agent layer interposed therebetween by a dry lamination method such that the adhesive agent layer had a thickness of 3 μm after curing. The black adhesive agent layer was used as a shielding layer. By the above procedure, a packaging film for electrical storage devices was obtained in which a resin layer, an adhesive agent layer (shielding layer) and a heat-sealable resin layer were laminated in this order. PP of the heat-sealable resin layer in Example 1A contains only erucic acid amide as a slipping agent.

### Example 2A

For a resin layer, a maleic anhydride-modified polypropylene (PPa) film (thickness: 20 μm) was provided. As a base material, a polyethylene naphthalate (PEN) film (thickness: 12 μm) was provided. For a heat-sealable resin layer, maleic anhydride-modified polypropylene (PPa) film (thickness: 20 μm) was provided. Using a two-liquid urethane adhesive, the resin layer and the base material were bonded to each other with an adhesive agent layer interposed therebetween by a dry lamination method such that the adhesive agent layer had a thickness of 1 μm or less after curing. Further, the base material of the obtained laminate and the heat-sealable resin layer were bonded to each other with the adhesive agent layer interposed therebetween. By the above procedure, a packaging film for electrical storage devices was obtained in which a resin layer, an adhesive agent layer, a base material, an adhesive agent layer and a heat-sealable resin layer were laminated in this order. PPa of each of the resin layer and the heat-sealable resin layer in Example 2A contains two slipping agents which are erucic acid amide and behenic acid amide.

### Example 3A

Except that a polyethylene terephthalate (PET) film (thickness: 9 μm) was used as a base material, the same procedure as in Example 2A was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 3A contains two slipping agents which are erucic acid amide and behenic acid amide.

### Example 4A

Except that a polyethylene terephthalate (PET) film (thickness: 12 μm) was used as a base material, the same procedure as in Example 3A was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 4A contains two slipping agents which are erucic acid amide and behenic acid amide.

### Example 5A

Except that a polyethylene terephthalate (PET) film (thickness: 25 μm) was used as a base material, the same procedure as in Example 3A was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 5A contains two slipping agents which are erucic acid amide and behenic acid amide.

### Example 6A

Except that a maleic anhydride-modified polypropylene (PPa) film (thickness: 30 μm) was used for a resin layer, and a maleic anhydride-modified polypropylene (PPa) film (thickness: 30 μm) was used for a heat-sealable resin layer, the same procedure as in Example 4A was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 6A contains two slipping agents which are erucic acid amide and behenic acid amide.

### Example 7A

Except that a maleic anhydride-modified polypropylene (PPa) film (thickness: 15 μm) was used for a resin layer, and a maleic anhydride-modified polypropylene (PPa) film (thickness: 15 μm) was used for a heat-sealable resin layer, the same procedure as in Example 4A was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 7A contains two slipping agents which are erucic acid amide and behenic acid amide.

### Example 8A

For a resin layer, a polypropylene (PP) film (thickness: 20 μm) was provided. As a base material, a polyethylene terephthalate (PET) film (thickness: 12 μm) was provided. For a heat-sealable resin layer, a polypropylene (PP) film (thickness: 20 μm) was provided. Using a two-liquid urethane adhesive, the resin layer and the base material were bonded to each other with an adhesive agent layer interposed therebetween by a dry lamination method such that the adhesive agent layer had a thickness of 1 μm or less after curing. Further, using a two-liquid urethane adhesive, the base material of the obtained laminate and the heat-sealable resin layer were bonded to each other with an adhesive agent layer interposed therebetween by a dry lamination method such that the adhesive agent layer had a thickness of 1 μm or less after curing. By the above procedure, a packaging film for electrical storage devices was obtained in which a resin layer, an adhesive agent layer, a base material, an adhesive agent layer and a heat-sealable resin layer were laminated in this order. PP of each of the resin layer and the heat-sealable resin layer in Example 8A contains only erucic acid amide as a slipping agent.

### Example 9A

Example 9A is the same as Example 4A except that PPa of each of the resin layer and the heat-sealable resin layer contains only erucic acid amide as a slipping agent.

### Example 10A

Except that a polypropylene (PP) film (thickness: 20 μm) was used for a resin layer, the same procedure as in Example 4A was carried out to obtain a packaging film for electrical storage devices in which a resin layer, an adhesive agent layer, a base material, an adhesive agent layer and a heat-sealable resin layer were laminated in this order. Each of PP and PPa of the resin layer and the heat-sealable resin layer, respectively, in Example 10A contains two slipping agents which are erucic acid amide and behenic acid amide.

### Example 11A

Except that a maleic anhydride-modified polypropylene (PPa) film (thickness: 20 μm) was used for a resin layer, and a maleic anhydride-modified polyethylene (PEa) film (thickness: 20 μm) was used for a heat-sealable resin layer, the same procedure as in Example 9A was carried out to obtain a packaging film for electrical storage devices in which a resin layer, an adhesive agent layer, a base material, an adhesive agent layer and a heat-sealable resin layer were laminated in this order. Each of PPa and PEa of the resin layer and the heat-sealable resin layer, respectively, in Example 11A contains only erucic acid amide as a slipping agent.

### Example 12A

A maleic anhydride-modified polypropylene (PPa) film (thickness: 100 μm) was used as a packaging film for electrical storage devices which includes only a heat-sealable resin layer. PPa of the heat-sealable resin layer in Example 12A contains only erucic acid amide as a slipping agent.

### Example 13A

A polypropylene (PP) film (thickness: 20 μm) was applied to one surface of an unstretched polypropylene (CPP) film (thickness: 60 μm) as a base material by melt extrusion, and a maleic anhydride-modified polypropylene (PPa) film (thickness: 20 μm) was applied to the other surface of the CPP film by melt extrusion to obtain a packaging film for electrical storage devices in which a resin layer, a base material and a heat-sealable resin layer were laminated in this order. Each of PP and PPa of the resin layer and the heat-sealable resin layer, respectively, in Example 13A contains only erucic acid amide as a slipping agent.

### Example 14A

To PET (12 μm) as a base material, which had been subjected to both-side corona discharge treatment, a triphenylmethane-4,4′,4″-triisocyanate adhesion promoter (hereinafter, referred to as T1) was applied at 50 mg/m² on a solid content basis, and dried, and a maleic anhydride-modified polypropylene (PPa) film (thickness: 30 μm) containing 0.15 parts by weight of carbon black was then applied by melt extrusion. Thereafter, to the other surface of the PET (12 μm), T1 was applied at 50 mg/m² on a solid content basis, and dried, and a maleic anhydride-modified polypropylene (PPa) film (thickness: 30 μm) containing 0.15 parts by weight of carbon black was then applied by melt extrusion to obtain a packaging film for electrical storage devices.

### Example 15A

To PET (12 μm) as a base material, which had been subjected to both-side corona discharge treatment, an adhesion promoter (hereinafter, referred to as T2) was applied at 50 mg/m² on a solid content basis, and dried, and a polypropylene (PP) film (thickness: 30 μm) was then applied by melt extrusion. Thereafter, to the other surface of the PET (12 μm), T2 was applied at 50 mg/m² on a solid content basis, and dried, and a polypropylene (PP) film ((thickness: 30 μm) was then applied by melt extrusion to obtain a packaging film for electrical storage devices.

### Example 16A

For a resin layer, a polypropylene (PP) film (thickness: 30 μm) was provided. As a base material, a polyethylene terephthalate (PET) film (thickness: 12 μm) was provided. For a heat-sealable resin layer, a polypropylene (PP) film (thickness: 30 μm) was provided. Using a main component composed of acid-modified polypropylene (PPa) and a two-liquid adhesive with a curing agent composed of isocyanurate, the resin layer and the base material were bonded to each other with an adhesive agent layer interposed therebetween by a dry lamination method such that the adhesive agent layer had a thickness of 3 μm after curing. Further, using a main component composed of acid-modified polypropylene (PPa) and a two-liquid adhesive with a curing agent composed of isocyanurate, the base material of the obtained laminate and the heat-sealable resin layer were bonded to each other with an adhesive agent layer interposed therebetween by a dry lamination method such that the adhesive agent layer had a thickness of 3 μm after curing. By the above procedure, a packaging film for electrical storage devices was obtained in which a resin layer, an adhesive agent layer, a base material, an adhesive agent layer and a heat-sealable resin layer were laminated in this order. PP of each of the resin layer and the heat-sealable resin layer in Example 16A contains only erucic acid amide as a slipping agent.

### Comparative Example 1A

For a base material layer, a stretched nylon (ONy) film (thickness: 25 μm) was provided. For a barrier layer, an aluminum (ALM) foil (thickness: 40 μm) was provided. For an adhesive layer, maleic anhydride-modified polypropylene (PPa) was provided. For a heat-sealable resin layer, polypropylene (PP) was provided. Using a two-liquid urethane adhesive, the base material layer and the barrier layer were bonded to each other with an adhesive agent layer interposed therebetween by a dry lamination method such that the adhesive agent layer had a thickness of 3 μm after curing. Further, the adhesive layer (thickness: 23 μm) and the heat-sealable resin layer (thickness: 23 μm) were applied to the surface of the barrier layer of the obtained laminate by melt extrusion to obtain an exterior material for electrical storage devices in which a base material layer, an adhesive agent layer, a barrier layer, an adhesive layer and a heat-sealable resin layer were laminated in this order. PP of the heat-sealable resin layer in Comparative Example 1A contains two slipping agents which are erucic acid amide and behenic acid amide. The exterior material for electrical storage devices in Comparative Example 1A can be suitably used as an outer packaging.

### Comparative Example 2A

For a resin layer, a maleic anhydride-modified polypropylene (PPa) film (thickness: 20 μm) was provided. For a barrier layer, an aluminum (ALM) foil (thickness: 35 μm) was provided. As a resin for forming a heat-sealable resin layer, maleic anhydride-modified polypropylene was provided. Using a two-liquid urethane adhesive, the resin layer and the barrier layer were bonded to each other with an adhesive agent layer interposed therebetween by a dry lamination method such that the adhesive agent layer had a thickness of 1 μm or less after curing. Further, the heat-sealable resin layer (thickness: 20 μm) was applied to the surface of the barrier layer of the obtained laminate by melt extrusion to obtain, as an example of an outer packaging, a packaging film for electrical storage devices in which a resin layer, an adhesive agent layer, a barrier layer and a heat-sealable resin layer were laminated in this order.

### Comparative Example 3A

For a resin layer, a polypropylene (PP) film (thickness: 20 μm) was provided. For a barrier layer, an aluminum (ALM) foil (thickness: 35 μm) was provided. For a heat-sealable resin layer, a polypropylene (PP) film (thickness: 20 μm) was provided. Using a two-liquid urethane adhesive, the resin layer and the barrier layer were bonded to each other with an adhesive agent layer interposed therebetween by a dry lamination method such that the adhesive agent layer had a thickness of 1 μm or less after curing. Further, the base material of the obtained laminate and the heat-sealable resin layer were bonded to each other with the adhesive agent layer interposed therebetween. By the above procedure, a packaging film for electrical storage devices in which a resin layer, an adhesive agent layer, a barrier layer, an adhesive agent layer and a heat-sealable resin layer were laminated in this order was obtained as an example of an outer packaging.

### Comparative Example 4A

Except that a polypropylene (PP) film (thickness: 10 μm) was used for a resin layer, and a polypropylene (PP) film (thickness: 10 μm) was used for a heat-sealable resin layer, the same procedure as in Comparative Example 3A was carried out to obtain, as an example of an outer packaging, a packaging film for electrical storage devices in which a resin layer, an adhesive agent layer, a barrier layer, an adhesive agent layer and a heat-sealable resin layer were laminated in this order. PP of each of the resin layer and the heat-sealable resin layer in Comparative Example 4A contains two slipping agents which are erucic acid amide and behenic acid amide.

### Comparative Example 5A

Comparative Example 5A is the same as Comparative Example 4A except that PP of each of the resin layer and the heat-sealable resin layer contains only erucic acid amide as a slipping agent.

### <Measurement of CO₂ Transmission Rate>

The CO₂ transmission rate (cc·100 μm/m²/24 hr/atm) of the packaging film for electrical storage devices in an environment at a temperature of 30° C. was measured by the following method. From the obtained CO₂ transmission rate, the CO₂ permeability was evaluated on the basis of the following criteria. CO₂ passing through a φ60 mm part of the packaging film 10 for electrical storage devices was quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate. The results are shown in Table 1A. The packaging films for electrical storage devices in Comparative Examples 1A to 5A included the ALM layer, and therefore had a CO₂ transmission rate of 0 cc·100 μm/m²/24 hr/atm in an environment at a temperature of 30° C.

A+: The CO₂ transmission rate in an environment at a temperature of 30° C. is 2,000 cc·100 μm/m²/24 hr/atm or more.

A: The CO₂ transmission rate in an environment at a temperature of 30° C. is 400 cc·100 μm/m²/24 hr/atm or more and less than 2,000 cc·100 μm/m²/24 hr/atm.

B: The CO₂ transmission rate in an environment at a temperature of 30° C. is 200 cc·100 μm/m²/24 hr/atm or more and less than 400 cc·100 cc·100 μm/m²/24 hr/atm.

C: The CO₂ transmission rate in an environment at a temperature of 30° C. is 100 cc·100 μm/m²/24 hr/atm or more and less than 200 cc·100 μm/m²/24 hr/atm.

D: The CO₂ transmission rate in an environment at a temperature of 30° C. is 0 cc·100 μm/m²/24 hr/atm or more and less than 100 cc·100 μm/m²/24 hr/atm.

TABLE 1A

| | | | CO2 permeability | Ease of |
|---|---|---|---|---|
| | | | in environment at | continuous |
| | Exterior material for electrical storage devices | Bondability | temperature of | production of |
| | Configuration | to metal | 30° C. | batteries |
| Example 1A | Resin layer (PET 12 μm)/adhesive agent layer (3 μm shielding layer)/ | Not | A | B |
| | heat-sealable resin layer (CPP 50 μm) | bondable | | |
| Example 2A | Resin layer (PPa 20 μm)/adhesive agent layer (≤1 μm)/base material | Bondable | B | A |
| | (PEN 12 μm)/adhesive agent layer (≤1 μm)/heat-sealable resin layer | | | |
| | (PPa 20 μm) | | | |
| Example 3A | Resin layer (PPa 20 μm)/adhesive agent layer (≤1 μm)/base material | Bondable | A | A |
| | (PET 9 μm)/adhesive agent layer (≤1 μm)/heat-sealable resin layer | | | |
| | (PPa 20 μm) | | | |
| Example 4A | Resin layer (PPa 20 μm)/adhesive agent layer (≤1 μm)/base material | Bondable | A | A |
| | (PET 12 μm)/adhesive agent layer (≤1 μm)/heat-sealable resin layer | | | |
| | (PPa 20 μm) | | | |
| Example 5A | Resin layer (PPa 20 μm)/adhesive agent layer (≤1 μm)/base material | Bondable | A | A |
| | (PET 25 μm)/adhesive agent layer (≤1 μm)/heat-sealable resin layer | | | |
| | (PPa 20 μm) | | | |
| Example 6A | Resin layer (PPa 30 μm)/adhesive agent layer (≤1 μm)/base material | Bondable | A | A |
| | (PET 12 μm)/adhesive agent layer (≤1 μm)/heat-sealable resin layer | | | |
| | (PPa 30 μm) | | | |
| Example 7A | Resin layer (PPa 15 μm)/adhesive agent layer (≤1 μm)/base material | Bondable | A | A |
| | (PET 12 μm)/adhesive agent layer (≤1 μm)/heat-sealable resin layer | | | |
| | (PPa 15 μm) | | | |
| Example 8A | Resin layer (PP 20 μm)/adhesive agent layer (≤1 μm)/base material | Not | A | B |
| | (PET 12 μm)/adhesive agent layer (≤1 μm)/heat-sealable resin layer | bondable | | |
| | (PP 20 μm) | | | |
| Example 9A | Resin layer (PP 20 μm)/adhesive agent layer (≤1 μm)/base material | Bondable | A | B |
| | (PET 12 μm)/adhesive agent layer (≤1 μm)/heat-sealable resin layer | | | |
| | (PPa 20 μm) | | | |
| Example 10A | Resin layer (PP 20 μm)/adhesive agent layer (≤1 μm)/base material | Bondable | A | A |
| | (PET 12 μm)/adhesive agent layer (≤1 μm)/heat-sealable resin layer | | | |
| | (PPa 20 μm) | | | |
| Example 11A | Resin layer (PPa 20 μm)/adhesive agent layer (≤1 μm)/base material | Bondable | A | B |
| | (PET 12 μm)/adhesive agent layer (≤1 μm)/heat-sealable resin layer | | | |
| | (PEa 20 μm) | | | |
| Example 12A | Base material layer (PPa 100 μm) | Bondable | A+ | B |
| Example 13A | Resin layer (PP 20 μm)/base material (CPP 60 μm)/heat-sealable resin | Bondable | A+ | B |
| | layer (PPa 20 μm) | | | |
| Example 14A | Heat-sealable resin layer (PPa 30 μm shielding layer)/adhesive agent | Bondable | A | A |
| | layer (≤1 μm)/base material (PET 12 μm)/adhesive agent layer | | | |
| | (≤1 μm)/heat-sealable resin layer (PPa 30 μm shielding layer) | | | |
| Example 15A | Resin layer (PP 30 μm)/adhesive agent layer (≤1 μm)/base material | Bondable | A | A |
| | (PET 12 μm)/adhesive agent layer (≤1 μm)/resin layer (PP 30 μm) | | | |
| Example 16A | Resin layer (PP 30 μm)/adhesive agent layer (3 μm)/base material | Bondable | A | B |
| | (PET 12 μm)/adhesive agent layer (3 μm)/resin layer (PP 30 μm) | | | |
| Comparative | Base material layer (ONy 25 μm)/adhesive agent layer (3 μm)/ALM | Not | D | A |
| Example 1A | layer (40 μm)/adhesive layer (PPa 23 μm)/heat-sealable resin layer | bondable | | |
| | (PP 23 μm) | | | |
| Comparative | Resin layer (PPa 20 μm)/adhesive agent layer (≤1 μm)/ALM layer | Bondable | D | B |
| Example 2A | (35 μm)/heat-sealable resin layer (PPa 20 μm) | | | |
| Comparative | Base material layer (PP 20 μm)/adhesive agent layer (≤1 μm)/ALM | Not | D | B |
| Example 3A | layer (35 μm)/adhesive agent layer (≤1 μm)/heat-sealable resin layer | bondable | | |
| | (PP 20 μm) | | | |
| Comparative | Base material layer (PP 10 μm)/adhesive agent layer (≤1 μm)/ALM | Not | D | A |
| Example 4A | layer (35 μm)/adhesive agent layer (≤1 μm)/heat-sealable resin layer | bondable | | |
| | (PP 10 μm) | | | |
| Comparative | Base material layer (PP 10 μm)/adhesive agent layer (≤1 μm)/ALM | Not | D | B |
| Example 5A | layer (35 μm)/adhesive agent layer (≤1 μm)/heat-sealable resin layer | bondable | | |
| | (PP 10 μm) | | | |

“≤1 μm” described in Table 1A indicates 1 μm or less. “/” of the laminated configuration shown in Table 1A indicates a partition between layers. The parenthesized numerical value (μm) indicates a thickness of a layer.

The packaging film for electrical storage devices in each of Examples 1A to 13A includes at least a heat-sealable resin layer, has a CO₂ transmission rate of 100 cc·100 μm/m²/24 hr/atm or more in an environment at a temperature of 30° C., and thus is capable of suitably releasing gas (in particular, CO₂) generated from an electrical storage device to the outside when an electrical storage device element is sealed using a packaging formed from the packaging film for electrical storage devices. In addition, the packaging film for electrical storage devices in each of Examples 1A to 13A can be suitably used as a packaging film for directly packaging an electrical storage device element. For example, in the electrical storage device 30 with the electrical storage device element 32 housed in a double-structured packaging including the inner packaging 10a and the outer packaging 20 as shown in FIG. 7, the packaging film 10 for electrical storage devices according to the present disclosure can be suitably used for formation of the inner packaging 10a. For example, when a packaging film 10 for electrical storage devices according to the present disclosure is provided as an inner packaging 10a, and housed in an outer packaging 20 after the electrical storage device element is sealed in the inner packaging 10a and an initial charge-discharge step and an aging step are carried out, gas (in particular, CO₂) generated from the electrical storage device element can be suitably released to the outside during these steps. Therefore, it is not necessary that as in the case of use of a conventional exterior material for electrical storage devices which includes a barrier layer, a space for holding gas be provided inside a temporarily sealed packaging film for electrical storage devices, and a packaging film for electrical storage devices, whose size is larger than that needed for an electrical storage device obtained as an end product (for example, equal to or larger than twice a size needed for sealing the electrical storage device element) be used for releasing the gas by removing the space together with the gas held therein.

It is considered that in the packaging film for electrical storage devices in Example 1A, since a shielding layer is provided although there is not a metal layer formed of metal, an electrical storage device element having a complicated shape can be made hardly visible, and inhibited from being forged.

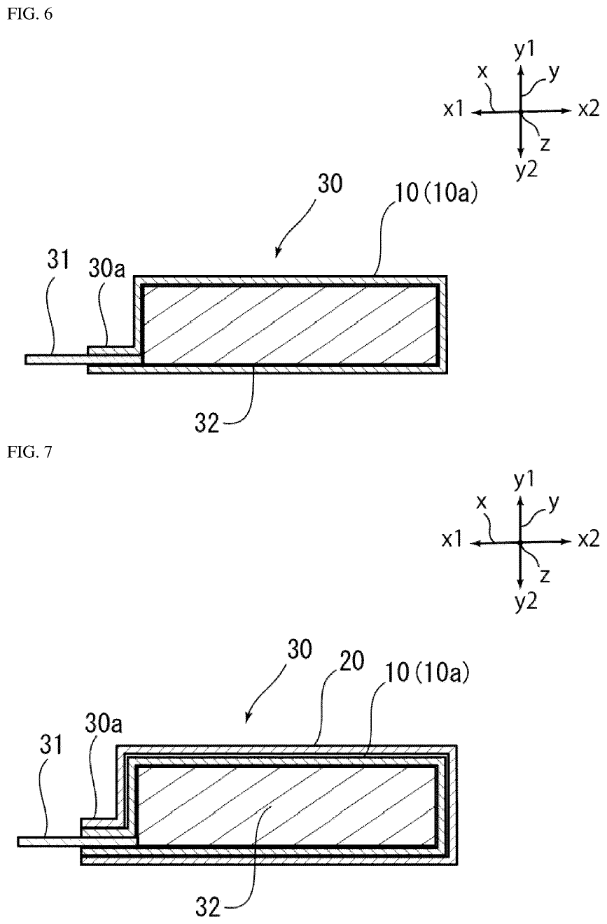

The packaging film for electrical storage devices in each of Examples 2A to 7A and 9A to 13A is bondable to metal and does not include a metal layer formed of metal. The packaging film for electrical storage devices in each of Examples 2A to 7A and 9A to 13A is bondable to metal, and thus can be suitably bonded to, for example, a metal terminal. That is, the packaging film for electrical storage devices in each of Examples 2A to 7A and 9A to 13A can be suitably used as a packaging film for directly packaging an electrical storage device element such that the packaging film is bonded to a metal terminal. For example, in the electrical storage device 30 with the electrical storage device element 32 housed in a double-structured packaging including the inner packaging 10a and the outer packaging 20 as shown in FIGS. 6 and 7, the packaging film 10 for electrical storage devices according to the present disclosure can be suitably used for formation of the inner packaging 10a. Since the metal terminal and the heat-sealable resin layer of the packaging film are formed of different materials, adhesion is likely to decrease at an interface between the metal terminal and the heat-sealable resin layer in general. Thus, an adhesive film is typically disposed between the metal terminal and the heat-sealable resin layer of the packaging film, but the packaging film for electrical storage devices of the present disclosure is bondable to metal, and therefore is capable of sealing the electrical storage device element while being bonded to the metal terminal, so that it is not necessary to use an adhesive film between the metal terminal and the packaging film. Comparative Examples 1 to 5 can be each suitably used as the outer packaging 20.

### <Ease of Continuous Production of Batteries>

For the packaging films for electrical storage devices which had been obtained in Examples 1A to 13A and Comparative Examples 1A to 5A, cold molding using a die was performed. As compared to Examples 1A, 8A, 11A to 13A and Comparative Examples 2A, 3A and 5A in which only erucic acid amide was used as the slipping agent for the resin layer and/or the heat-sealable resin layer, the packaging films for electrical storage devices in Examples 2A to 7A and 10A and Comparative Examples 1A and 4A in which two types of slipping agents which are erucic acid amide and behenic acid amide were used as the slipping agent for the resin layer and/or the heat-sealable resin layer was superior in ease of continuous production of the packaging film for electrical storage devices with the die cleaning frequency reduced by suppressing deposition of the slipping agent on the die. In Table 1A, examples and comparative examples superior in ease of continuous production of batteries were rated “A”, and examples and comparative examples inferior to those rated “A” were rated “B”.

### Manufacture of Packaging Film for Electrical Storage Devices According to Second Aspect

### Example 1B

For a resin layer, a maleic anhydride-modified polypropylene (PPa) film (thickness: 20 μm) was provided. As a base material, a polyethylene naphthalate (PEN) film (thickness: 12 μm) was provided. For a heat-sealable resin layer, maleic anhydride-modified polypropylene (PPa) film (thickness: 20 μm) was provided. Using a two-liquid urethane adhesive, the resin layer and the base material were bonded to each other with an adhesive agent layer interposed therebetween by a dry lamination method such that the adhesive agent layer had a thickness of 1 μm or less after curing. Further, the base material of the obtained laminate and the heat-sealable resin layer were bonded to each other with the adhesive agent layer interposed therebetween. By the above procedure, a packaging film for electrical storage devices was obtained in which a resin layer, an adhesive agent layer, a base material, an adhesive agent layer and a heat-sealable resin layer were laminated in this order. PPa of each of the resin layer and the heat-sealable resin layer in Example 1B contains two slipping agents which are erucic acid amide and behenic acid amide.

### Example 2B

Except that a polyethylene terephthalate (PET) film (thickness: 9 μm) was used as a base material, the same procedure as in Example 1B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 2B contains two slipping agents which are erucic acid amide and behenic acid amide.

### Example 3B

Except that a polyethylene terephthalate (PET) film (thickness: 12 μm) was used as a base material, the same procedure as in Example 1B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 3B contains two slipping agents which are erucic acid amide and behenic acid amide.

### Example 4B

Except that a polyethylene terephthalate (PET) film (thickness: 25 μm) was used as a base material, the same procedure as in Example 1B was carried out to obtain a packaging film for electrical storage devices in which a resin layer, an adhesive agent layer, a base material, an adhesive agent layer and a heat-sealable resin layer were laminated in this order. PPa of each of the resin layer B and the heat-sealable resin layer in Example 4B contains two slipping agents which are erucic acid amide and behenic acid amide.

### Example 5B

Except that a maleic anhydride-modified polypropylene (PPa) film (thickness: 30 μm) was used for a resin layer, and a maleic anhydride-modified polypropylene (PPa) film (thickness: 30 μm) was used for a heat-sealable resin layer, the same procedure as in Example 3B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 5B contains two slipping agents which are erucic acid amide and behenic acid amide.

### Example 6B

Except that a maleic anhydride-modified polypropylene (PPa) film (thickness: 15 μm) was used for a resin layer, and a maleic anhydride-modified polypropylene (PPa) film (thickness: 15 μm) was used for a heat-sealable resin layer, the same procedure as in Example 3B was carried out to obtain a packaging film for electrical storage devices in which a resin layer (shielding layer), an adhesive agent layer, a base material, an adhesive agent layer and a heat-sealable resin layer were laminated in this order. PPa of each of the resin layer and the heat-sealable resin layer in Example 6B contains two slipping agents which are erucic acid amide and behenic acid amide.

### Example 7B

Example 7B is the same as Example 3B except that PPa of each of the resin layer and the heat-sealable resin layer contains only erucic acid amide as a slipping agent.

### Example 8B

For a resin layer, a maleic anhydride-modified polypropylene (PPa) film (thickness: 20 μm) was provided. As a base material, a polyethylene terephthalate (PET) film (thickness: 12 μm) was provided. For a heat-sealable resin layer, maleic anhydride-modified polypropylene (PPa) film (thickness: 20 μm) was provided. Using a two-liquid urethane adhesive containing carbon black (the average particle size of carbon black is within the range of 0.161 to 0.221 μm), the resin layer and the base material were bonded to each other with an adhesive agent layer interposed therebetween by a dry lamination method such that the adhesive agent layer had a thickness of 3 μm after curing. Further, using a two-liquid urethane adhesive, the base material of the obtained laminate and the heat-sealable resin layer were bonded to each other with an adhesive agent layer interposed therebetween by a dry lamination method such that the adhesive agent layer had a thickness of 1 μm or less after curing. The black adhesive agent layer between the resin layer and the base material was used as a shielding layer. By the above procedure, a packaging film for electrical storage devices was obtained in which a resin layer, an adhesive agent layer (shielding layer), a base material, an adhesive agent layer and a heat-sealable resin layer were laminated in this order. PPa of each of the resin layer and the heat-sealable resin layer in Example 8B contains only erucic acid amide as a slipping agent.

### Example 9B

Except that a polypropylene (PP) film (thickness: 20 μm) containing carbon black (the average particle size of carbon black is within the range of 0.161 to 0.221 μm) was used for a resin layer, and a maleic anhydride-modified polypropylene (PPa) film (thickness: 20 μm) was used for a heat-sealable resin layer, the same procedure as in Example 3B was carried out to obtain a packaging film for electrical storage devices in which a resin layer (shielding layer), an adhesive agent layer, a base material, an adhesive agent layer and a heat-sealable resin layer were laminated in this order. Each of PP and PPa of the resin layer and the heat-sealable resin layer, respectively, in Example 9B contains two slipping agents which are erucic acid amide and behenic acid amide.

### Example 10B

Except that a maleic anhydride-modified polypropylene (PPa) film (thickness: 20 μm) containing carbon black (the average particle size of carbon black is within the range of 0.161 to 0.221 μm) was used for a resin layer, and a maleic anhydride-modified polyethylene (PEa) film (thickness: 20 μm) was used for a heat-sealable resin layer, the same procedure as in Example 9B was carried out to obtain a packaging film for electrical storage devices in which a resin layer (shielding layer), an adhesive agent layer, a base material, an adhesive agent layer and a heat-sealable resin layer were laminated in this order. Each of PPa and PEa of the resin layer and the heat-sealable resin layer, respectively, in Example 10B contains only erucic acid amide as a slipping agent.

### Example 11B

A maleic anhydride-modified polypropylene (PPa) film (thickness: 100 μm) containing carbon black (the average particle size of carbon black is within the range of 0.161 to 0.221 μm) was used as a packaging film for electrical storage devices which includes only a heat-sealable resin layer. PPa of the heat-sealable resin layer in Example 11B contains only erucic acid amide as a slipping agent.

### Example 12B

A polypropylene (PP) film (thickness: 20 μm) containing carbon black (the average particle size of carbon black is within the range of 0.161 to 0.221 μm) was applied to one surface of an unstretched polypropylene (CPP) film (thickness: 60 μm) as a base material by melt extrusion, and a maleic anhydride-modified polypropylene (PPa) film (thickness: 20 μm) was applied to the other surface of the CPP film by melt extrusion to obtain a packaging film for electrical storage devices in which a resin layer (shielding layer), a base material and a heat-sealable resin layer were laminated in this order. Each of PP and PPa of the resin layer and the heat-sealable resin layer, respectively, in Example 12B contains only erucic acid amide as a slipping agent.

### Comparative Example 1B

For a resin layer, a polyethylene terephthalate (PET) film (thickness: 12 μm) was provided. As a heat-sealable resin layer, an unstretched polypropylene film (CPP, thickness: 50 μm) was provided. Using a two-liquid urethane adhesive containing carbon black (the average particle size of carbon black is within the range of 0.161 to 0.221 μm), the resin layer and the heat-sealable resin layer were bonded to each other with a black adhesive agent layer interposed therebetween by a dry lamination method such that the adhesive agent layer had a thickness of 3 μm after curing. The black adhesive agent layer was used as a shielding layer. By the above procedure, a packaging film for electrical storage devices was obtained in which a resin layer, an adhesive agent layer (shielding layer) and a heat-sealable resin layer were laminated in this order. PP of the heat-sealable resin layer in Comparative Example 1B contains only erucic acid amide as a slipping agent.

### Comparative Example 2B

Except that a polypropylene (PP) film (thickness: 20 μm) was used for a resin layer, and a polypropylene (PP) film (thickness: 20 μm) was used for a heat-sealable resin layer, the same procedure as in Example 8B was carried out to obtain a packaging film for electrical storage devices in which a resin layer, an adhesive agent layer (shielding layer), a base material, an adhesive agent layer and a heat-sealable resin layer were laminated in this order. PP of each of the resin layer and the heat-sealable resin layer in Comparative Example 2B contains two slipping agents which are erucic acid amide and behenic acid amide.

### Comparative Example 3B

For a resin layer, a polypropylene (PP) film (thickness: 20 μm) was provided. As a base material, a polyethylene terephthalate (PET) film (thickness: 12 μm) was provided. For a heat-sealable resin layer, a polypropylene (PP) film (thickness: 20 μm) was provided. Using a two-liquid urethane adhesive, the resin layer and the base material were bonded to each other with an adhesive agent layer interposed therebetween by a dry lamination method such that the adhesive agent layer had a thickness of 1 μm or less after curing. Further, the heat-sealable resin layer was applied to the surface of the base material of the obtained laminate by melt extrusion to obtain a packaging film for electrical storage devices in which a resin layer, an adhesive agent layer, a base material and a heat-sealable resin layer were laminated in this order. PP of each of the resin layer and the heat-sealable resin layer in Comparative Example 3B contains two slipping agents which are erucic acid amide and behenic acid amide.

### Comparative Example 4B

For a resin layer, a polypropylene (PP) film (thickness: 20 μm) was provided. For a barrier layer, an aluminum (ALM) foil (thickness: 35 μm) was provided. For a heat-sealable resin layer, a polypropylene (PP) film (thickness: 20 μm) was provided. Using a two-liquid urethane adhesive, the resin layer and the barrier layer were bonded to each other with an adhesive agent layer interposed therebetween by a dry lamination method such that the adhesive agent layer had a thickness of 1 μm or less after curing. Further, using a two-liquid urethane adhesive, the barrier layer of the obtained laminate and the heat-sealable resin layer were bonded to each other with an adhesive agent layer interposed therebetween by a dry lamination method such that the adhesive agent layer had a thickness of 1 μm or less after curing. By the above procedure, a packaging film for electrical storage devices in which a resin layer, an adhesive agent layer, a barrier layer, an adhesive agent layer and a heat-sealable resin layer were laminated in this order was obtained as an example of an outer packaging. PP of each of the resin layer and the heat-sealable resin layer in Comparative Example 4B contains two slipping agents which are erucic acid amide and behenic acid amide.

### Comparative Example 5B

Except that a polypropylene (PP) film (thickness: 10 μm) was used for a resin layer, and a polypropylene (PP) film (thickness: 10 μm) was used for a heat-sealable resin layer, the same procedure as in Comparative Example 4 was carried out to obtain, as an example of an outer packaging, a packaging film for electrical storage devices in which a resin layer, an adhesive agent layer, a barrier layer, an adhesive agent layer and a heat-sealable resin layer were laminated in this order. PP of each of the resin layer and the heat-sealable resin layer in Comparative Example 5B contains two slipping agents which are erucic acid amide and behenic acid amide.

### Comparative Example 6B

Comparative Example 6 is the same as Comparative Example 5B except that PP of each of the resin layer and the heat-sealable resin layer contains only erucic acid amide as a slipping agent.

### <Total Light Transmittance>

For the total light transmittance of the packaging film for electrical storage devices, the transmittance in a visible light region (400 to 700 nm) was measured with Ultraviolet-Visible-Near Infrared Spectrophotometer V-670 from JASCO Corporation by a measurement method specified in JIS K7361-1: 1997, and the average value thereof was taken as a total light transmittance. For measurement conditions, a halogen lamp was used as a light source, the UV/Vis bandwidth was 5.0 nm, the scanning rate was 1,000 nm/min, the response was set to Medium, and the data capture interval was 1.0 nm. The results are shown in Table 1B.

### <Evaluation of Shielding Property>

Paper was provided on which an alphabet character “A” with a font type of Arial, a font size of 36 and a line thickness of about 1 mm was printed in black by a laser printer. In an illuminated indoor environment (300 to 500 lux), the paper printed with the character “A” was placed under the packaging film for electrical storage devices. The character “A” was visually observed through the packaging film for electrical storage devices from a distance of 30 cm from the front surface of the packaging film for electrical storage devices. The shielding property was evaluated in terms of visibility of the character on the basis of the criteria of levels 1 to 5 below. The results are shown in Table 1B.

Level 1: Easily visible.

Level 2: The character is slightly hardly visible, but can be recognized.

Level 3: The character is hardly visible, but can be recognized.

Level 4: The character is very hardly visible, but can be faintly recognized.

Level 5: The character is invisible.

TABLE 1B

| | | | | | Type of | Evaluation |
|---|---|---|---|---|---|---|
| | Exterior material for electrical storage devices | | | Evaluation | slipping | of ease of |
| | | Total light | Bond- | of | agent | continuous |
| | | transmit- | ability | shielding | contained in | production |
| | Configuration | tance (%) | to metal | property | PP and PPa | of batteries |
| Example 1B | Resin layer (PPa 20 μm)/ | 90.3 | Bondable | 1 | Two types | A |
| | adhesive agent layer (≤1 μm)/ | | | | | |
| | base material (PEN 12 μm)/ | | | | | |
| | adhesive agent layer (≤1 μm)/ | | | | | |
| | heat-sealable resin layer (PPa 20 μm) | | | | | |
| Example 2B | Resin layer (PPa 20 μm)/ | 90.1 | Bondable | 1 | Two types | A |
| | adhesive agent layer (≤1 μm)/ | | | | | |
| | base material (PET 9 μm)/ | | | | | |
| | adhesive agent layer (≤1 μm)/ | | | | | |
| | heat-sealable resin layer (PPa 20 μm) | | | | | |
| Example 3B | Resin layer (PPa 20 μm)/ | 90.6 | Bondable | 1 | Two types | A |
| | adhesive agent layer (≤1 μm)/ | | | | | |
| | base material (PET 12 μm)/ | | | | | |
| | adhesive agent layer (≤1 μm)/ | | | | | |
| | heat-sealable resin layer (PPa 20 μm) | | | | | |
| Example 4B | Resin layer (PPa 20 μm)/ | 89.8 | Bondable | 1 | Two types | A |
| | adhesive agent layer (≤1 μm)/ | | | | | |
| | base material (PET 25 μm)/ | | | | | |
| | adhesive agent layer (≤1 μm)/ | | | | | |
| | heat-sealable resin layer (PPa 20 μm) | | | | | |
| Example 5B | Resin layer (PPa 30 μm)/ | 88.9 | Bondable | 1 | Two types | A |
| | adhesive agent layer (≤1 μm)/ | | | | | |
| | base material (PET 12 μm)/ | | | | | |
| | adhesive agent layer (≤1 μm)/ | | | | | |
| | heat-sealable resin layer (PPa 30 μm) | | | | | |
| Example 6B | Resin layer (PPa 15 μm)/ | 90.4 | Bondable | 1 | Two types | A |
| | adhesive agent layer (≤1 μm)/ | | | | | |
| | base material (PET 12 μm)/ | | | | | |
| | adhesive agent layer (≤1 μm)/ | | | | | |
| | heat-sealable resin layer (PPa 15 μm) | | | | | |
| Example 7B | Resin layer (PPa 20 μm)/ | 90.5 | Bondable | 1 | One type | B |
| | adhesive agent layer (≤1 μm)/ | | | | | |
| | base material (PET 12 μm)/ | | | | | |
| | adhesive agent layer (≤1 μm)/ | | | | | |
| | heat-sealable resin layer (PPa 20 μm) | | | | | |
| Example 8B | Resin layer (PPa 20 μm)/ | 1.6 | Bondable | 5 | One type | B |
| | adhesive agent layer | | | | | |
| | (3 μm shielding layer)/ | | | | | |
| | base material (PET 12 μm)/ | | | | | |
| | adhesive agent layer (≤1 μm)/ | | | | | |
| | heat-sealable resin layer (PPa 20 μm) | | | | | |
| Example 9B | Resin layer | 1.5 | Bondable | 5 | Two types | A |
| | (PP 20 μm, shielding layer)/ | | | | | |
| | adhesive agent layer (≤1 μm)/ | | | | | |
| | base material (PET 12 μm)/ | | | | | |
| | adhesive agent layer (≤1 μm)/ | | | | | |
| | heat-sealable resin layer (PPa 20 μm) | | | | | |
| Example 10B | Resin layer | 1.5 | Bondable | 5 | One type | B |
| | (PPa 20 μm, shielding layer)/ | | | | | |
| | adhesive agent layer (≤1 μm)/ | | | | | |
| | base material (PET 12 μm)/ | | | | | |
| | adhesive agent layer (≤1 μm)/ | | | | | |
| | heat-sealable resin layer (PEa 20 μm) | | | | | |
| Example 11B | Base material layer | 1.7 | Bondable | 5 | One type | B |
| | (PPa 100 μm shielding layer) | | | | | |
| Example 12B | Resin layer | 1.8 | Bondable | 5 | One type | B |
| | (PP 20 μm shielding layer)/ | | | | | |
| | base material (CPP 60 μm)/ | | | | | |
| | heat-sealable resin layer (PPa 20 μm) | | | | | |
| Comparative | Resin layer (PET 12 μm)/ | 1.4 | Not | 5 | One type | B |
| Example 1B | adhesive agent layer | | bondable | | | |
| | (3 μm shielding layer)/ | | | | | |
| | heat-sealable resin layer (CPP 50 μm) | | | | | |
| Comparative | Resin layer (PP 20 μm)/ | 1.5 | Not | 5 | Two types | A |
| Example 2B | adhesive agent layer | | bondable | | | |
| | (3 μm shielding layer)/ | | | | | |
| | base material (PET 12 μm)/ | | | | | |
| | adhesive agent layer (≤1 μm)/ | | | | | |
| | heat-sealable resin layer (PP 20 μm) | | | | | |
| Comparative | Resin layer (PP 20 μm)/ | 90.4 | Not | 1 | Two types | A |
| Example 3B | adhesive agent layer (≤1 μm)/ | | bondable | | | |
| | base material (PET 12 μm)/ | | | | | |
| | heat-sealable resin layer (PP 20 μm) | | | | | |
| Comparative | Base material layer (PP 20 μm)/ | Not | Not | 5 | Two types | A |
| Example 4B | adhesive agent layer (≤1 μm)/ | transmitted | bondable | | | |
| | ALM layer (35 μm)/ | | | | | |
| | adhesive agent layer (≤1 μm)/ | | | | | |
| | heat-sealable resin layer (PP 20 μm) | | | | | |
| Comparative | Base material layer (PP 10 μm)/ | Not | Not | 5 | Two types | A |
| Example 5B | adhesive agent layer (≤1 μm)/ | transmitted | bondable | | | |
| | ALM layer (35 μm)/ | | | | | |
| | adhesive agent layer (≤1 μm)/ | | | | | |
| | heat-sealable resin layer (PP 10 μm) | | | | | |
| Comparative | Base material layer (PP 10 μm)/ | Not | Not | 5 | One type | B |
| Example 6B | adhesive agent layer (≤1 μm)/ | transmitted | bondable | | | |
| | ALM layer (35 μm)/ | | | | | |
| | adhesive agent layer (≤1 μm)/ | | | | | |
| | heat-sealable resin layer (PP 10 μm) | | | | | |

“≤1 μm” described in Table 1B indicates 1 μm or less. “/” of the laminated configuration shown in Table 1B indicates a partition between layers. The parenthesized nμmerical value (μm) indicates a thickness of a layer.

The packaging film for electrical storage devices in each of Examples 1B to 12B is bondable to metal and does not include a metal layer formed of metal. The packaging film for electrical storage devices in each of Examples 1B to 12B is bondable to metal, and thus can be suitably bonded to, for example, a metal terminal. That is, the packaging film for electrical storage devices in each of Examples 1B to 12B can be suitably used as a packaging film for directly packaging an electrical storage device element such that the packaging film is bonded to a metal terminal. For example, in the electrical storage device 30 with the electrical storage device element 32 housed in a double-structured packaging including the inner packaging 10a and the outer packaging 20 as shown in FIG. 7, the packaging film 10 for electrical storage devices according to the present disclosure can be suitably used for formation of the inner packaging 10a. Since the metal terminal and the heat-sealable resin layer of the packaging film are formed of different materials, adhesion is likely to decrease at an interface between the metal terminal and the heat-sealable resin layer in general. Thus, an adhesive film is typically disposed between the metal terminal and the heat-sealable resin layer of the packaging film, but the packaging film for electrical storage devices of the present disclosure is bondable to metal, and therefore is capable of sealing the electrical storage device element while being bonded to the metal terminal, so that it is not necessary to use an adhesive film between the metal terminal and the packaging film. Comparative Examples 4B to 6B can be each suitably used as the outer packaging 20.

The packaging film for electrical storage devices in each of Examples 8B to 12B did not include a metal layer formed of metal, but included a shielding layer, and thus had an effect such that even the very simple character “A” was shielded, and made hardly visible. Therefore, it is considered that when a shielding layer is provided, an electrical storage device element having a complicated shape can be made hardly visible, and inhibited from being forged.

### <Ease of Continuous Production of Batteries>

For the packaging films for electrical storage devices which had been obtained in Examples 1B to 12B and Comparative Examples 1B to 6B, cold molding using a die was performed. As compared to Examples 7B, 8B, and 10B to 12B and Comparative Examples 1B and 6B in which only erucic acid amide was used as the slipping agent for the resin layer and/or the heat-sealable resin layer, the packaging films for electrical storage devices in Examples 1B to 6B and 9B and Comparative Examples 2B to 5B in which two types of slipping agents which are erucic acid amide and behenic acid amide were used as the slipping agent for the resin layer and/or the heat-sealable resin layer was superior in ease of continuous production of the packaging film for electrical storage devices with the die cleaning frequency reduced by suppressing deposition of the slipping agent on the die. In Table 1B, examples and comparative examples superior in ease of continuous production of batteries were rated “A”, and examples and comparative examples inferior to those rated “A” were rated “B”.

### <Manufacture of Packaging Film for Electrical Storage Devices According to Second Aspect>

### Example 13B

For a resin layer, a maleic anhydride-modified polypropylene (PPa) film (thickness: 20 μm) was provided. As a base material, a polyethylene naphthalate (PEN) film (thickness: 12 μm) was provided. For a heat-sealable resin layer, maleic anhydride-modified polypropylene (PPa) film (thickness: 20 μm) was provided. Using a two-liquid urethane adhesive, the resin layer and the base material were bonded to each other with an adhesive agent layer interposed therebetween by a dry lamination method such that the adhesive agent layer had a thickness of 1 μm or less after curing. Further, the base material of the obtained laminate and the heat-sealable resin layer were bonded to each other with the adhesive agent layer interposed therebetween. By the above procedure, a packaging film for electrical storage devices was obtained in which a resin layer, an adhesive agent layer, a base material, an adhesive agent layer and a heat-sealable resin layer were laminated in this order. PPa of each of the resin layer and the heat-sealable resin layer in Example 13B contains two slipping agents which are erucic acid amide and behenic acid amide.

### Example 14B

Except that a polyethylene terephthalate (PET) film (thickness: 9 μm) was used as a base material, the same procedure as in Example 13B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 14B contains two slipping agents which are erucic acid amide and behenic acid amide.

### Example 15B

Except that a polyethylene terephthalate (PET) film (thickness: 12 μm) was used as a base material, the same procedure as in Example 14B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 15B contains two slipping agents which are erucic acid amide and behenic acid amide.

### Example 16B

Except that a polyethylene terephthalate (PET) film (thickness: 25 μm) was used as a base material, the same procedure as in Example 14B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 16B contains two slipping agents which are erucic acid amide and behenic acid amide.

### Example 17B

Except that a maleic anhydride-modified polypropylene (PPa) film (thickness: 30 μm) was used for a resin layer, and a maleic anhydride-modified polypropylene (PPa) film (thickness: 30 μm) was used for a heat-sealable resin layer, the same procedure as in Example 15B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 17B contains two slipping agents which are erucic acid amide and behenic acid amide.

### Example 18B

Except that a maleic anhydride-modified polypropylene (PPa) film (thickness: 15 μm) was used for a resin layer, and a maleic anhydride-modified polypropylene (PPa) film (thickness: 15 μm) was used for a heat-sealable resin layer, the same procedure as in Example 15B was carried out to obtain a packaging film for electrical storage devices in which a resin layer, an adhesive agent layer, a base material, an adhesive agent layer and a heat-sealable resin layer were laminated in this order. PPa of each of the resin layer and the heat-sealable resin layer in Example 18B contains two slipping agents which are erucic acid amide and behenic acid amide.

### Example 19B

Example 19B is the same as Example 15B except that PPa of each of the resin layer and the heat-sealable resin layer contains only erucic acid amide as a slipping agent.

### Example 20B

Except that a polypropylene (PP) film (thickness: 20 μm) was used for a resin layer, the same procedure as in Example 15B was carried out to obtain a packaging film for electrical storage devices in which a resin layer, an adhesive agent layer, a base material, an adhesive agent layer and a heat-sealable resin layer were laminated in this order. Each of PP and PPa of the resin layer and the heat-sealable resin layer, respectively, in Example 20B contains two slipping agents which are erucic acid amide and behenic acid amide.

### Example 21B

Except that a maleic anhydride-modified polypropylene (PPa) film (thickness: 20 μm) was used for a resin layer, and a maleic anhydride-modified polyethylene (PEa) film (thickness: 20 μm) was used for a heat-sealable resin layer, the same procedure as in Example 19B was carried out to obtain a packaging film for electrical storage devices in which a resin layer, an adhesive agent layer, a base material, an adhesive agent layer and a heat-sealable resin layer were laminated in this order. Each of PPa and PEa of the resin layer and the heat-sealable resin layer, respectively, in Example 21B contains only erucic acid amide as a slipping agent.

### Example 22B

A maleic anhydride-modified polypropylene (PPa) film (thickness: 100 μm) was used as a packaging film for electrical storage devices which includes only a heat-sealable resin layer. PPa of the heat-sealable resin layer in Example 22B contains only erucic acid amide as a slipping agent.

### Example 23B

A polypropylene (PP) film (thickness: 20 μm) was applied to one surface of an unstretched polypropylene (CPP) film (thickness: 60 μm) as a base material by melt extrusion, and a maleic anhydride-modified polypropylene (PPa) film (thickness: 20 μm) was applied to the other surface of the CPP film by melt extrusion to obtain a packaging film for electrical storage devices in which a resin layer, a base material and a heat-sealable resin layer were laminated in this order. Each of PP and PPa of the resin layer and the heat-sealable resin layer, respectively, in Example 23B contains only erucic acid amide as a slipping agent.

### Comparative Example 7B

For a base material layer, a stretched nylon (ONy) film (thickness: 25 μm) was provided. For a barrier layer, an aluminum (ALM) foil (thickness: 40 μm) was provided. For an adhesive layer, maleic anhydride-modified polypropylene (PPa) was provided. For a heat-sealable resin layer, polypropylene (PP) was provided. Using a two-liquid urethane adhesive, the base material layer and the barrier layer were bonded to each other with an adhesive agent layer interposed therebetween by a dry lamination method such that the adhesive agent layer had a thickness of 3 μm after curing. Further, the adhesive layer (thickness: 23 μm) and the heat-sealable resin layer (thickness: 23 μm) were applied to the surface of the barrier layer of the obtained laminate by melt extrusion to obtain an exterior material for electrical storage devices in which a base material layer, an adhesive agent layer, a barrier layer, an adhesive layer and a heat-sealable resin layer were laminated in this order. PP of the heat-sealable resin layer in Comparative Example 7 contains two slipping agents which are erucic acid amide and behenic acid amide. The exterior material for electrical storage devices in Comparative Example 7B can be suitably used as an outer packaging.

### Comparative Example 8B

For a resin layer, a maleic anhydride-modified polypropylene (PPa) film (thickness: 20 μm) was provided. For a barrier layer, an aluminum (ALM) foil (thickness: 35 μm) was provided. As a resin for forming a heat-sealable resin layer, maleic anhydride-modified polypropylene was provided. Using a two-liquid urethane adhesive, the resin layer and the barrier layer were bonded to each other with an adhesive agent layer interposed therebetween by a dry lamination method such that the adhesive agent layer had a thickness of 1 μm or less after curing. Further, the heat-sealable resin layer (thickness: 20 μm) was applied to the surface of the barrier layer of the obtained laminate by melt extrusion to obtain, as an example of an outer packaging, a packaging film for electrical storage devices in which a resin layer, an adhesive agent layer, a barrier layer and a heat-sealable resin layer were laminated in this order.

### Comparative Example 9B

For a resin layer, a polypropylene (PP) film (thickness: 20 μm) was provided. For a barrier layer, an aluminum (ALM) foil (thickness: 35 μm) was provided. For a heat-sealable resin layer, a polypropylene (PP) film (thickness: 20 μm) was provided. Using a two-liquid urethane adhesive, the resin layer and the barrier layer were bonded to each other with an adhesive agent layer interposed therebetween by a dry lamination method such that the adhesive agent layer had a thickness of 1 μm or less after curing. Further, the base material of the obtained laminate and the heat-sealable resin layer were bonded to each other with the adhesive agent layer interposed therebetween. By the above procedure, a packaging film for electrical storage devices in which a resin layer, an adhesive agent layer, a barrier layer, an adhesive agent layer and a heat-sealable resin layer were laminated in this order was obtained as an example of an outer packaging.

### Comparative Example 10B

Except that a polypropylene (PP) film (thickness: 10 μm) was used for a resin layer, and a polypropylene (PP) film (thickness: 10 μm) was used for a heat-sealable resin layer, the same procedure as in Comparative Example 3B was carried out to obtain, as an example of an outer packaging, a packaging film for electrical storage devices in which a resin layer, an adhesive agent layer, a barrier layer, an adhesive agent layer and a heat-sealable resin layer were laminated in this order. PP of each of the resin layer and the heat-sealable resin layer in Comparative Example 10B contains two slipping agents which are erucic acid amide and behenic acid amide.

### Comparative Example 11B

Comparative Example 11B is the same as Comparative Example 10B except that PP of each of the resin layer and the heat-sealable resin layer contains only erucic acid amide as a slipping agent.

### <Measurement of CO₂ Transmission Rate>

The CO₂ transmission rate (cc·100 μm/m²/24 hr/atm) of the packaging film for electrical storage devices in an environment at a temperature of 30° C. was measured by the following method. From the obtained CO₂ transmission rate, the CO₂ permeability was evaluated on the basis of the following criteria. CO₂ passing through a φ60 mm part of the packaging film 10 for electrical storage devices was quantitatively analyzed in an atmosphere at 30° C. by gas chromatography according to JIS K 7126-1 (Plastic-Film and Sheet-Test Methods for Gas Permeability-Part 1: Differential Pressure Method) to measure the transmission rate. The results are shown in Table 2B. The packaging films for electrical storage devices in Comparative Examples 7 to 11 included the ALM layer, and therefore had a CO₂ transmission rate of 0 cc·100 μm/m²/24 hr/atm in an environment at a temperature of 30° C.

A+: The CO₂ transmission rate in an environment at a temperature of 30° C. is 2,000 cc·100 μm/m²/24 hr/atm or more.

A: The CO₂ transmission rate in an environment at a temperature of 30° C. is 400 cc·100 μm/m²/24 hr/atm or more and less than 2,000 cc·100 μm/m²/24 hr/atm.

B: The CO₂ transmission rate in an environment at a temperature of 30° C. is 200 cc·100 μm/m²/24 hr/atm or more and less than 400 cc·100 cc·100 μm/m²/24 hr/atm.

C: The CO₂ transmission rate in an environment at a temperature of 30° C. is 100 cc·100 μm/m²/24 hr/atm or more and less than 200 cc·100 μm/m²/24 hr/atm.

D: The CO₂ transmission rate in an environment at a temperature of 30° C. is 0 cc·100 μm/m²/24 hr/atm or more and less than 100 cc·100 μm/m²/24 hr/atm.

TABLE 2B

| | | | CO2 permeability | Ease of |
|---|---|---|---|---|
| | | | in environment at | continuous |
| | Exterior material for electrical storage devices | Bondability | temperature of | production of |
| | Configuration | to metal | 30° C. | batteries |
| Example 13B | Resin layer (PPa 20 μm)/adhesive agent layer (≤1 μm)/base material | Bondable | B | A |
| | (PEN 12 μm)/adhesive agent layer (≤1 μm)/heat-sealable resin layer | | | |
| | (PPa 20 μm) | | | |
| Example 14B | Resin layer (PPa 20 μm)/adhesive agent layer (≤1 μm)/base material | Bondable | A | A |
| | (PET 9 μm)/adhesive agent layer (≤1 μm)/heat-sealable resin layer | | | |
| | (PPa 20 μm) | | | |
| Example 15B | Resin layer (PPa 20 μm)/adhesive agent layer (≤1 μm)/base material | Bondable | A | A |
| | (PET 12 μm)/adhesive agent layer (≤1 μm)/heat-sealable resin layer | | | |
| | (PPa 20 μm) | | | |
| Example 16B | Resin layer (PPa 20 μm)/adhesive agent layer (≤1 μm)/base material | Bondable | A | A |
| | (PET 25 μm)/adhesive agent layer (≤1 μm)/heat-sealable resin layer | | | |
| | (PPa 20 μm) | | | |
| Example 17B | Resin layer (PPa 30 μm)/adhesive agent layer (≤1 μm)/base material | Bondable | A | A |
| | (PET 12 μm)/adhesive agent layer (≤1 μm)/heat-sealable resin layer | | | |
| | (PPa 30 μm) | | | |
| Example 18B | Resin layer (PPa 15 μm)/adhesive agent layer (≤1 μm)/base material | Bondable | A | A |
| | (PET 12 μm)/adhesive agent layer (≤1 μm)/heat-sealable resin layer | | | |
| | (PPa 15 μm) | | | |
| Example 19B | Resin layer (PP 20 μm)/adhesive agent layer (≤1 μm)/base material | Bondable | A | B |
| | (PET 12 μm)/adhesive agent layer (≤1 μm)/heat-sealable resin layer | | | |
| | (PPa 20 μm) | | | |
| Example 20B | Resin layer (PP 20 μm)/adhesive agent layer (≤1 μm)/base material | Bondable | A | A |
| | (PET 12 μm)/adhesive agent layer (≤1 μm)/heat-sealable resin layer | | | |
| | (PPa 20 μm) | | | |
| Example 21B | Resin layer (PPa 20 μm)/adhesive agent layer (≤1 μm)/base material | Bondable | A | B |
| | (PET 12 μm)/adhesive agent layer (≤1 μm)/heat-sealable resin layer | | | |
| | (PEa 20 μm) | | | |
| Example 22B | Base material layer (PPa 100 μm) | Bondable | A+ | B |
| Example 23B | Resin layer (PP 20 μm)/base material (CPP 60 μm)/heat-sealable resin | Bondable | A+ | B |
| | layer (PPa 20 μm) | | | |
| Comparative | Base material layer (ONy 25 μm)/adhesive agent layer (3 μm)/ALM | Not | D | A |
| Example 7B | layer (40 μm)/adhesive layer (PPa 23 μm)/heat-sealable resin layer | bondable | | |
| | (PP 23 μm) | | | |
| Comparative | Resin layer (PPa 20 μm)/adhesive agent layer (≤1 μm)/ALM layer (35 | Bondable | D | B |
| Example 8B | μm)/heat-sealable resin layer (PPa 20 μm) | | | |
| Comparative | Base material layer (PP 20 μm)/adhesive agent layer (≤1 μm)/ALM | Not | D | B |
| Example 9B | layer (35 μm)/adhesive agent layer (≤1 μm)/heat-sealable resin layer | bondable | | |
| | (PP 20 μm) | | | |
| Comparative | Base material layer (PP 10 μm)/adhesive agent layer (≤1 μm)/ALM | Not | D | A |
| Example 10B | layer (35 μm)/adhesive agent layer (≤1 μm)/heat-sealable resin layer | bondable | | |
| | (PP 10 μm) | | | |
| Comparative | Base material layer (PP 10 μm)/adhesive agent layer (≤1 μm)/ALM | Not | D | B |
| Example 11B | layer (35 μm)/adhesive agent layer (≤1 μm)/heat-sealable resin layer | bondable | | |
| | (PP 10 μm) | | | |

“≤1 μm” described in Table 2B indicates 1 μm or less. “/” of the laminated configuration shown in Table 2B indicates a partition between layers. The parenthesized numerical value (μm) indicates a thickness of a layer.

The packaging film for electrical storage devices in each of Examples 13B to 23B includes at least a heat-sealable resin layer, has a CO₂ transmission rate of 100 cc·100 μm/m²/24 hr/atm or more in an environment at a temperature of 30° C., and thus is capable of suitably releasing gas (in particular, CO₂) generated from an electrical storage device to the outside when an electrical storage device element is sealed using a packaging formed from the packaging film for electrical storage devices. In addition, the packaging film for electrical storage devices in each of Examples 13B to 23B can be suitably used as a packaging film for directly packaging an electrical storage device element. For example, in the electrical storage device 30 with the electrical storage device element 32 housed in a double-structured packaging including the inner packaging 10a and the outer packaging 20 as shown in FIG. 7, the packaging film 10 for electrical storage devices according to the present disclosure can be suitably used for formation of the inner packaging 10a. For example, when a packaging film 10 for electrical storage devices according to the present disclosure is provided as an inner packaging 10a, and housed in an outer packaging 20 after the electrical storage device element is sealed in the inner packaging 10a and an initial charge-discharge step and an aging step are carried out, gas (in particular, CO₂) generated from the electrical storage device element can be suitably released to the outside during these steps. Therefore, it is not necessary that as in the case of use of a conventional exterior material for electrical storage devices which includes a barrier layer, a space for holding gas be provided inside a temporarily sealed packaging film for electrical storage devices, and a packaging film for electrical storage devices, whose size is larger than that needed for an electrical storage device obtained as an end product (for example, equal to or larger than twice a size needed for sealing the electrical storage device element) be used for releasing the gas by removing the space together with the gas held therein.

The packaging film for electrical storage devices in each of Examples 13B to 23B is bondable to metal and does not include a metal layer formed of metal. The packaging film for electrical storage devices in each of Examples 13B to 23B is bondable to metal, and thus can be suitably bonded to, for example, a metal terminal. That is, the packaging film for electrical storage devices in each of Examples 13B to 23B can be suitably used as a packaging film for directly packaging an electrical storage device element such that the packaging film is bonded to a metal terminal. For example, in the electrical storage device 30 with the electrical storage device element 32 housed in a double-structured packaging including the inner packaging 10a and the outer packaging 20 as shown in FIGS. 6 and 7, the packaging film 10 for electrical storage devices according to the present disclosure can be suitably used for formation of the inner packaging 10a. Since the metal terminal and the heat-sealable resin layer of the packaging film are formed of different materials, adhesion is likely to decrease at an interface between the metal terminal and the heat-sealable resin layer in general. Thus, an adhesive film is typically disposed between the metal terminal and the heat-sealable resin layer of the packaging film, but the packaging film for electrical storage devices of the present disclosure is bondable to metal, and therefore is capable of sealing the electrical storage device element while being bonded to the metal terminal, so that it is not necessary to use an adhesive film between the metal terminal and the packaging film. Comparative Examples 7B to 11B can be each suitably used as the outer packaging 20.

As described above, the first aspect of the present disclosure provides the invention of aspects shown below.

Item 1A. A packaging film for electrical storage devices, including at least a heat-sealable resin layer, in which
a CO₂ transmission rate in an environment at a temperature of 30° C. is 100 cc·100 μm/m²/24 hr/atm or more.

Item 2A. The packaging film for electrical storage devices according to item 1A, including a laminate including at least a resin layer and the heat-sealable resin layer in this order from the outside.

Item 3A. The packaging film for electrical storage devices according to item 2A, including a laminate including at least the resin layer, a base material and the heat-sealable resin layer in this order from the outside.

Item 4A. The packaging film for electrical storage devices according to item 3A, including a laminate including at least the resin layer, an adhesive agent layer, the base material and the heat-sealable resin layer in this order from the outside.

Item 5A. The packaging film for electrical storage devices according to item 4A, including a laminate including at least the resin layer, the adhesive agent layer, the base material, an adhesive agent layer and the heat-sealable resin layer in this order from the outside.

Item 6A. The packaging film for electrical storage devices according to any one of items 2A to 5A, in which an outer surface of the resin layer is bondable to metal.

Item 7A. The packaging film for electrical storage devices according to any one of items 1A to 6A, in which an inner surface of the heat-sealable resin layer is bondable to metal.

Item 8A. An electrical storage device in which an electrical storage device element including at least a positive electrode, a negative electrode and an electrolyte is housed in a packaging formed of the packaging film for electrical storage devices according to any one of items 1A to 7A.

Item 9A. An electrical storage device in which an electrical storage device element including at least a positive electrode, a negative electrode and an electrolyte is housed in an inner packaging formed of the packaging film for electrical storage devices according to any one of items 1A to 7A, and
the inner packaging is further housed in an outer packaging.

Item 10A. The electrical storage device according to item 9A, in which the outer packaging includes a metal layer formed of metal.

Item 11A. The electrical storage device according to any one of items 8A to 10A, in which the packaging film for electrical storage devices is in contact with a metal terminal electrically connected to the positive electrode or the negative electrode.

Item 12A. A method for manufacturing a packaging film for electrical storage devices, including at least a step of providing a heat-sealable resin layer, in which
the packaging film for electrical storage devices has a CO₂ transmission rate of 100 cc·100 μm/m²/24 hr/atm or more in an environment at a temperature of 30° C.

As described above, the second aspect of the present disclosure provides the invention of aspects shown below.

Item 1B. A packaging film for electrical storage devices, including at least a heat-sealable resin layer, in which
the packaging film for electrical storage devices is bondable to metal, and
the packaging film for electrical storage devices does not include a metal layer formed of metal.

Item 2B. The packaging film for electrical storage devices according to item 1B, including a laminate including at least a resin layer and the heat-sealable resin layer in this order from the outside.

Item 3B. The packaging film for electrical storage devices according to item 2B, including a laminate including at least the resin layer, a base material and the heat-sealable resin layer in this order from the outside.

Item 4B. The packaging film for electrical storage devices according to item 3B, including a laminate including at least the resin layer, an adhesive agent layer, the base material and the heat-sealable resin layer in this order from the outside.

Item 5B. The packaging film for electrical storage devices according to item 4B, including a laminate including at least the resin layer, the adhesive agent layer, the base material, an adhesive agent layer and the heat-sealable resin layer in this order from the outside.

Item 6B. The packaging film for electrical storage devices according to any one of items 2B to 5B, in which an outer surface of the resin layer is bondable to metal.

Item 7B. The packaging film for electrical storage devices according to any one of items 1B to 6B, in which an inner surface of the heat-sealable resin layer is bondable to metal.

Item 8B. The packaging films for electrical storage devices according to any one of items 1B to 7B, in which a CO₂ transmission rate in an environment at a temperature of 30° C. is 100 cc·100 μm/m²/24 hr/atm or more.

Item 9B. An electrical storage device in which an electrical storage device element including at least a positive electrode, a negative electrode and an electrolyte is housed in a packaging formed of the packaging film for electrical storage devices according to any one of items 1B to 8B.

Item 10B. An electrical storage device in which an electrical storage device element including at least a positive electrode, a negative electrode and an electrolyte is housed in an inner packaging formed of the packaging film for electrical storage devices according to any one of items 1B to 8B, and
the inner packaging is further housed in an outer packaging.

Item 11B. The electrical storage device according to item 10B, in which the outer packaging includes a metal layer formed of metal.

Item 12B. The electrical storage device according to any one of items 9B to 10B, in which the packaging film for electrical storage devices is in contact with a metal terminal electrically connected to the positive electrode or the negative electrode.

Item 13B. A method for manufacturing a packaging film for electrical storage devices, including at least a step of providing a heat-sealable resin layer, in which
the packaging film for electrical storage devices is bondable to metal, and
the packaging film for electrical storage devices does not include a metal layer formed of metal.

As described above, the third aspect of the present disclosure provides the invention of aspects shown below.

Item 1C. A method for manufacturing an electrical storage device, the electrical storage device including an electrical storage device element, and an inner packaging housing the electrical storage device element,
the inner packaging including a transparent packaging film for electrical storage devices,
the method including an inner side packaging step of wrapping the electrical storage device element with the packaging film for electrical storage devices, and an inner side sealing step of sealing the packaging film for electrical storage devices so as to seal the electrical storage device element with packaging film for electrical storage devices after the inner side packaging step.

Item 2C. The method for manufacturing the electrical storage device according to item 1C, in which the packaging film for electrical storage devices further has gas permeability,
the method further including a degassing step of releasing gas generated from the electrical storage device element through the packaging film for electrical storage devices after the inner side sealing step.

Item 3C. The method for manufacturing an electrical storage device according to item 2C, in which in the inner side packaging step, the electrical storage device element is wrapped by the packaging film for electrical storage devices which is substantially identical in size to the inner packaging of a finished product of the electrical storage device.

Item 4C. An electrical storage device including an electrical storage device element,
an inner packaging housing the electrical storage device element, and
an outer packaging housing the inner packaging in which the electrical storage device element is housed,
the inner packaging including a transparent packaging film for electrical storage devices.

Item 5C. The electrical storage device according to item 4C, further including a metal terminal electrically connected to the electrical storage device element, and a tab film disposed between the inner packaging and the metal terminal, in which
the outer packaging is joined to the inner packaging, the inner packaging and the metal terminal are joined to each other with the tab film interposed therebetween, and
at least a part of an outer edge of the inner packaging is exposed from the outer packaging.

Item 6C. The electrical storage device according to item 4C, further including a metal terminal electrically connected to the electrical storage device element, and tab films disposed between the inner packaging and outer packaging and the metal terminal, in which
the inner packaging and the outer packaging are joined to the metal terminal with the tab film interposed therebetween, and
a whole of the inner packaging is covered with the outer packaging.

Item 7C. The electrical storage device according to item 4C, further including a metal terminal electrically connected to the electrical storage device element, in which
the inner packaging and the metal terminal are joined to each other, and
at least a part of an outer edge of the inner packaging is exposed from the outer packaging.

Item 8C. The electrical storage device according to item 4C, further including a metal terminal electrically connected to the electrical storage device element, in which
the inner packaging and the outer packaging are joined to the metal terminal, and
a whole of the inner packaging is covered with the outer packaging.

Item 9C. The electrical storage device according to any one of items 3C to 8C, in which the packaging film for electrical storage devices further has gas permeability.

As described above, the fourth aspect of the present disclosure provides the invention of aspects shown below.

Item 1D. A method for manufacturing an electrical storage device, the electrical storage device including an electrical storage device element, and an inner packaging housing the electrical storage device element,
the inner packaging including a gas-permeable packaging film for electrical storage devices,
the method including an inner side packaging step of wrapping the electrical storage device element with the packaging film for electrical storage devices,
an inner side sealing step of sealing the packaging film for electrical storage devices so as to seal the electrical storage device element with packaging film for electrical storage devices after the inner side packaging step, and
a degassing step of releasing gas generated from the electrical storage device element through the packaging film for electrical storage devices after the inner side sealing step.

Item 2D. The method for manufacturing an electrical storage device according to item 1D, in which in the inner side packaging step, the electrical storage device element is wrapped by the packaging film for electrical storage devices which is substantially identical in size to the inner packaging of a finished product of the electrical storage device.

Item 3D. An electrical storage device including an electrical storage device element,
an inner packaging housing the electrical storage device element, and
an outer packaging housing the inner packaging in which the electrical storage device element is housed,
the inner packaging including a gas-permeable packaging film for electrical storage devices.

Item 4D. The electrical storage device according to item 3D, further including a metal terminal electrically connected to the electrical storage device element, and a tab film disposed between the inner packaging and the metal terminal, in which
the outer packaging is joined to the inner packaging, the inner packaging and the metal terminal are joined to each other with the tab film interposed therebetween, and
at least a part of an outer edge of the inner packaging is exposed from the outer packaging.

Item 5D. The electrical storage device according to item 3D, further including a metal terminal electrically connected to the electrical storage device element, and tab films disposed between the inner packaging and outer packaging and the metal terminal, in which
the inner packaging and the outer packaging are joined to the metal terminal with the tab film interposed therebetween, and
a whole of the inner packaging is covered with the outer packaging.

Item 6D. The electrical storage device according to item 3D, further including a metal terminal electrically connected to the electrical storage device element, in which
the inner packaging and the metal terminal are joined to each other, and
at least a part of an outer edge of the inner packaging is exposed from the outer packaging.

Item 7D. The electrical storage device according to item 3D, further including a metal terminal electrically connected to the electrical storage device element, in which
the inner packaging and the outer packaging are joined to the metal terminal, and
a whole of the inner packaging is covered with the outer packaging.

Item 8D. The electrical storage device according to any one of items 3D to 7D, in which the packaging film for electrical storage devices further has transparency.

As described above, the fifth aspect of the present disclosure provides the invention of aspects shown below.

Item 1E. An electrical storage device including:
an electrical storage device element;
an inner packaging housing the electrical storage device element;
an outer packaging housing the inner packaging in which the electrical storage device element is housed; and
a functional body disposed between the inner packaging and the outer packaging,
the functional body having shock absorbency.

Item 2E. An electrical storage device including:
an electrical storage device element;
an inner packaging housing the electrical storage device element;
an outer packaging housing the inner packaging in which the electrical storage device element is housed; and
a functional body disposed between the inner packaging and the outer packaging,
the functional body having flame retardancy.

Item 3E. An electrical storage device including:
an electrical storage device element;
an inner packaging housing the electrical storage device element;
an outer packaging housing the inner packaging in which the electrical storage device element is housed; and
a functional body disposed between the inner packaging and the outer packaging,
the functional body having a cooling property.

Item 4E. An electrical storage device including:
an electrical storage device element;
an inner packaging housing the electrical storage device element;
an outer packaging housing the inner packaging in which the electrical storage device element is housed; and
a functional body disposed between the inner packaging and the outer packaging,
the functional body having a fire-extinguishing property.

Item 5E. An electrical storage device including:
an electrical storage device element;
an inner packaging housing the electrical storage device element;
an outer packaging housing the inner packaging in which the electrical storage device element is housed, in which
at least one of the inner packaging and the outer packaging has at least one of impact absorbency, flame retardancy, a cooling property and a fire-extinguishing property.

Item 6E. The electrical storage device according to any one of items 1E to 5E, in which the inner packaging has at least one of transparency and gas permeability.

Item 7E. The electrical storage device according to any one of items 1E to 6E, further including a metal terminal electrically connected to the electrical storage device element, and a tab film disposed between the inner packaging and the metal terminal, in which
the outer packaging is joined to the inner packaging, the inner packaging and the metal terminal are joined to each other with the tab film interposed therebetween, and
at least a part of an outer edge of the inner packaging is exposed from the outer packaging.

Item 8E. The electrical storage device according to any one of items 1E to 6E, further including a metal terminal electrically connected to the electrical storage device element, and tab films disposed between the inner packaging and outer packaging and the metal terminal, in which
the inner packaging and the outer packaging are joined to the metal terminal with the tab film interposed therebetween, and
a whole of the inner packaging is covered with the outer packaging.

Item 9E. The electrical storage device according to any one of items 1E to 6E, further including a metal terminal electrically connected to the electrical storage device element, in which
the inner packaging and the metal terminal are joined to each other, and
at least a part of an outer edge of the inner packaging is exposed from the outer packaging.

Item 10E. The electrical storage device according to any one of items 1E to 6E, further including a metal terminal electrically connected to the electrical storage device element, in which
the inner packaging and the outer packaging are joined to the metal terminal, and
a whole of the inner packaging is covered with the outer packaging.

### REFERENCE SIGNS LIST

1 Heat-sealable resin layer
2 Resin layer
3 Base material
4 Adhesive agent layer
5 Adhesive agent layer
10 Packaging film for electrical storage devices
10a Inner packaging
20 Outer packaging
30 Electrical storage device
30a Peripheral edge portion
31 Metal terminal
32 Electrical storage device element
S Shielding layer
100 Electrical storage device
130 Metal terminal
140 Tab film
210 Inner packaging
211 Packaging film for electrical storage devices
212 Packaging film for electrical storage devices
220 Outer packaging
230 Functional body

1. A packaging film for electrical storage devices, comprising at least a heat-sealable resin layer, in which
a CO₂ transmission rate in an environment at a temperature of 30° C. is 100 cc·100 μm/m²/24 hr/atm or more.

2. The packaging film for electrical storage devices according to claim 1, comprising a laminate including at least a resin layer and the heat-sealable resin layer in this order from the outside.

3. The packaging film for electrical storage devices according to claim 2, comprising a laminate including at least the resin layer, a base material and the heat-sealable resin layer in this order from the outside.

4. The packaging film for electrical storage devices according to claim 3, comprising a laminate including at least the resin layer, an adhesive agent layer, the base material and the heat-sealable resin layer in this order from the outside.

5. The packaging film for electrical storage devices according to claim 4, comprising a laminate including at least the resin layer, the adhesive agent layer, the base material, an adhesive agent layer and the heat-sealable resin layer in this order from the outside.

6. The packaging film for electrical storage devices according to claim 2, wherein an outer surface of the resin layer is bondable to metal.

7. The packaging film for electrical storage devices according to claim 1, wherein an inner surface of the heat-sealable resin layer is bondable to metal.

8. An electrical storage device in which an electrical storage device element including at least a positive electrode, a negative electrode and an electrolyte is housed in a packaging formed of the packaging film for electrical storage devices according to claim 1.

9. An electrical storage device in which an electrical storage device element including at least a positive electrode, a negative electrode and an electrolyte is housed in an inner packaging formed of the packaging film for electrical storage devices according to claim 1, and
the inner packaging is further housed in an outer packaging.

10. The electrical storage device according to item claim 9, in which the outer packaging includes a metal layer formed of metal.

11. The electrical storage device according to claim 8, in which the packaging film for electrical storage devices is in contact with a metal terminal electrically connected to the positive electrode or the negative electrode.

12. A method for manufacturing a packaging film for electrical storage devices, comprising at least a step of providing a heat-sealable resin layer, in which
the packaging film for electrical storage devices has a CO₂ transmission rate of 100 cc·100 μm/m²/24 hr/atm or more in an environment at a temperature of 30° C.
